(19) United States
(12) Patent Application Publication
(10) Pub. No.: US 2025/0360907 A1
(43) Pub. Date: Nov. 27, 2025

(54) INTELLIGENT ENERGY MANAGEMENT SYSTEM FOR NEW ENERGY VEHICLE, CONTROL METHOD, AND RELATED DEVICES

(71) Applicant: BYD COMPANY LIMITED, SHENZHEN (CN)

(72) Inventors: Dongsheng YANG, Shenzhen (CN); Futang ZHU, Shenzhen (CN); Jinlong WU, Shenzhen (CN); Chunsheng WANG, Shenzhen (CN); Boliang XU, Shenzhen (CN); Zhaoyu LEI, Shenzhen (CN)

(21) Appl. No.: 19/051,804

(22) Filed: Feb. 12, 2025

Related U.S. Application Data
(63) Continuation of application No. PCT/CN2024/134866, filed on Nov. 27, 2024.

(30) Foreign Application Priority Data
May 27, 2024 (CN) 202410658157.7

(51) Int. Cl. B60W 20/12; B60W 20/13

(52) U.S. Cl. CPC B60W 20/12; B60W 20/13; B60W 2556/35

(57) ABSTRACT

An intelligent energy management system, includes: a drive device including an engine configured to output power to a wheel of the vehicle, a drive motor configured to output power to the wheel, and an electric generator connected to the engine and driven by the engine to generate electricity; a power battery configured to supply electricity to the drive motor and charged with an alternating current outputted from the electric generator or the drive motor; and a control device configured to acquire multi-domain data fusion information, predict, according to the multi-domain data fusion information, a route-specific vehicle energy consumption corresponding to a preset travel route, plan, according to a road section-specific vehicle energy consumption corresponding to each road section, a target SOC corresponding to each road section, and control, according to the target SOC and an actual vehicle demand corresponding to each road section, the drive device.

### CROSS-REFERENCE TO RELATED APPLICATIONS

This application is a continuation application of International Patent Application No. PCT/CN2024/134866, filed on Nov. 27, 2024, which is based on and claims priority to and benefits of Chinese Patent Application No. 202410658157.7 filed on May 27, 2024. The entire content of all of the above-referenced applications is incorporated herein by reference.

### FIELD

The present disclosure relates to the technical field of intelligent control of vehicles, and particularly, to an intelligent energy management system for a new energy vehicle, a control method, a control device, a vehicle, and a storage medium.

### BACKGROUND

At present, the control principles in the energy management strategy for hybrid electric vehicles are mainly to meet the power demand and maintain the state of charge (SOC) of the battery. When the vehicle travels, the energy management strategy is combined with the efficiency characteristics of power sources to reasonably distribute the power of each power source, thereby improving the drive efficiency of the power system.

### SUMMARY

Some embodiments of the present disclosure provide an intelligent energy management system for a new energy vehicle, a control method, a control device, a vehicle, and a storage medium. By the present disclosure, the fuel consumption during traveling is reduced and the driving and riding experience of the users is improved.

In a first aspect, some embodiments of the present disclosure provide an intelligent energy management system for a new energy vehicle. The system includes a drive device, a power battery, and a control device. The drive device includes an engine, a drive motor, and an electric generator. The engine is configured to output power to a wheel of the vehicle. The drive motor is configured to output power to the wheel. The electric generator is connected to the engine and driven by the engine to generate electricity. The power battery is configured to supply electricity to the drive motor and be charged with an alternating current outputted from one of the electric generator or the drive motor. The control device is configured to: acquire multi-domain data fusion information, where the multi-domain data fusion information at least includes cockpit domain information and power domain information, the cockpit domain information at least includes user behavior information and road condition information of a preset travel route, and the power domain information at least includes vehicle state information; predict, according to the multi-domain data fusion information, a route-specific vehicle energy consumption corresponding to the preset travel route, where the preset travel route includes multiple road sections, and the route-specific vehicle energy consumption includes road section-specific vehicle energy consumption corresponding to the multiple road sections; plan, according to the road section-specific vehicle energy consumption corresponding to each road section in the multiple road sections, a target SOC corresponding to each road section, to obtain a minimum fuel consumption corresponding to the preset travel route; and control, according to the target SOC and an actual vehicle demand corresponding to each road section, the drive device and the power battery, to enable the engine to operate in an efficient operating interval during operation.

In a second aspect, some embodiments of the present disclosure provide a control method for an intelligent energy management system for a new energy vehicle. The method includes the following steps. Multi-domain fusion information is acquired, where the multi-domain fusion information at least includes cockpit domain information and power domain information, the cockpit domain information at least includes user behavior information and road condition information of a preset travel route, and the power domain information at least includes vehicle state information. A route-specific vehicle energy consumption corresponding to a preset travel route is predicted according to the multi-domain fusion information, where the preset travel route includes multiple road sections, and the route-specific vehicle energy consumption includes road section-specific vehicle energy consumptions respectively corresponding to the multiple road sections. A target SOC corresponding to each road section is planned according to the road section-specific vehicle energy consumption corresponding to each road section, to obtain a minimum fuel consumption corresponding to the preset travel route. The engine, the drive motor, the electric generator, and the power battery of the new energy vehicle are controlled according to the target SOC and an actual vehicle demand corresponding to each road section, to enable the engine to operate in an efficient operating interval during operation.

In a third aspect, some embodiments of the present disclosure provide a control device, which includes a multi-source data fusion unit, an energy consumption prediction unit, a dynamic planning unit, and an intelligent control unit. The multi-source data fusion unit is configured to acquire multi-domain data fusion information, where the multi-domain data fusion information at least includes cockpit domain information and power domain information, the cockpit domain information at least includes user behavior information and road condition information of a preset travel route, and the power domain information at least includes vehicle state information. The energy consumption prediction unit is configured to predict, according to the multi-domain data fusion information, a route-specific vehicle energy consumption corresponding to the preset travel route, where the preset travel route includes multiple road sections, and the route-specific vehicle energy consumption includes road section-specific vehicle energy consumptions corresponding to the multiple road sections. The dynamic planning unit is configured to plan, according to the road section-specific vehicle energy consumption corresponding to each road section in the multiple road sections, a target SOC corresponding to each road section, to obtain a minimum fuel consumption corresponding to the preset travel route. The intelligent control unit is configured to control, according to the target SOC and an actual vehicle demand corresponding to each road section, the engine, the drive motor, the electric generator, and the power battery of the new energy vehicle, to enable the engine to operate in an efficient operating interval during operation.

In a fourth aspect, some embodiments of the present disclosure provide a control device, which includes a memory, a communication interface, and a processor. The memory, the communication interface, and the processor are connected to one another. The memory stores a computer program thereon, and the processor calls the computer program stored on the memory, to implement the method according to the second aspect.

In a fifth aspect, some embodiments of the present disclosure provide a vehicle, which includes an intelligent energy management system for a new energy vehicle according to the first aspect.

In a sixth aspect, some embodiments of the present disclosure provide a computer-readable storage medium. The computer-readable storage medium stores a computer program, where the computer program, when executed by a processor, implements the method according to the second aspect.

In a seventh aspect, some embodiments of the present disclosure provide an intelligent energy management system for a new energy vehicle, which includes an engine, a drive motor, an electric generator, a power battery, and a control device. The engine is configured to selectively output power to a wheel of the vehicle. The drive motor is configured to output power to the wheel. The electric generator is connected to the engine and driven by the engine to generate electricity. The power battery is configured to supply electricity to the drive motor and be charged with an alternating current outputted from the electric generator or the drive motor. The control device includes a multi-source data fusion module, an energy consumption prediction module, a dynamic planning module, and an intelligent control module. The multi-source data fusion module is configured to acquire multi-domain data fusion information, where the multi-domain data fusion information at least includes cockpit domain information and power domain information, the cockpit domain information at least includes user behavior information and road condition information of a preset travel route, and the power domain information at least includes vehicle state information. The energy consumption prediction module is configured to predict, according to the multi-domain data fusion information, a route-specific vehicle energy consumption corresponding to the preset travel route, where the preset travel route includes multiple road sections, and the route-specific vehicle energy consumption includes road section-specific vehicle energy consumptions corresponding to the multiple road sections. The dynamic planning module is configured to plan, according to the road section-specific vehicle energy consumption corresponding to each road section, a target SOC corresponding to each road section, to obtain a minimum fuel consumption corresponding to the preset travel route. The intelligent control module is configured to control, according to the target SOC and an actual vehicle demand corresponding to each road section, the engine, the drive motor, the electric generator, and the power battery, to enable the engine to operate in an efficient operating interval during operation.

In some embodiments of the present disclosure, the target SOC corresponding to each road section is planned to obtain a minimum fuel consumption corresponding to the travel route, and the vehicle is controlled according to the target SOC corresponding to each road section and the actual vehicle demand, to realize the reasonable allocation of fuel and electricity in a hybrid electric vehicle, and reduce the fuel consumption and vehicle usage cost of the vehicle.

The engine, the drive motor, the electric generator, and the power battery are controlled, to enable the engine to operate in an efficient operating interval during operation, improve the NVH performance of the engine, avoid the frequent start and stop of the engine, and improve the driving and riding comfort.

In addition, the route-specific vehicle energy consumption corresponding to the preset travel route is predicted according to the multi-domain fusion information, that is, the route-specific vehicle energy consumption is predicted by fusing the cockpit domain and power domain information, to improve the accuracy of energy consumption prediction, and further improve the fuel saving performance.

### BRIEF DESCRIPTION OF THE DRAWINGS

To describe the technical solutions in some embodiments of the present disclosure or in related art more clearly, the drawings needed to be used in some embodiments of the present disclosure or in related art will be described below.

FIG. 1 is a schematic of an architecture of an intelligent energy management system for a new energy vehicle according to some embodiments of the present disclosure;

FIG. 2 is a schematic of an architecture of an intelligent energy management system for a new energy vehicle according to some embodiments of the present disclosure;

FIG. 3 is a flow chart of determining a candidate energy-saving route according to some embodiments of the present disclosure;

FIG. 4 is a flow chart of an energy-supplementing strategy according to some embodiments of the present disclosure;

FIG. 5 schematically shows the energy consumption prediction according to some embodiments of the present disclosure;

FIG. 6 is a flow chart of an energy consumption prediction method according to some embodiments of the present disclosure;

FIG. 7 schematically shows a division of road sections according to some embodiments of the present disclosure;

FIG. 8 schematically shows an SOC prediction according to some embodiments of the present disclosure;

FIG. 9 schematically shows an SOC prediction according to some embodiments of the present disclosure;

FIG. 10 is a flow chart of an energy management based on historical traveling data according to some embodiments of the present disclosure;

FIG. 11 is a flow chart of partial correction based on traffic light information fusion according to some embodiments of the present disclosure;

FIG. 12 is a flow chart of updating automatic navigation initial moment according to some embodiments of the present disclosure;

FIG. 13 is a flowchart of a control method for an intelligent energy management system for a new energy vehicle according to some embodiments of the present disclosure;

FIG. 14A is a first flowchart of a control method for an intelligent energy management system for a new energy vehicle according to some embodiments of the present disclosure;

FIG. 14B is a second flowchart of a control method for an intelligent energy management system for a new energy vehicle according to some embodiments of the present disclosure;

FIG. 15 is a block diagram of a vehicle according to some embodiments of the present disclosure;

FIG. 16 schematically shows an energy-saving route according to some embodiments of the present disclosure;

FIG. 17 schematically shows an energy-supplementing plan according to some embodiments of the present disclosure;

FIG. 18 is a block diagram of a control device for an intelligent energy management system for a new energy vehicle according to some embodiments of the present disclosure; and

FIG. 19 is a block diagram of a control device according to some embodiments of the present disclosure.

### DETAILED DESCRIPTION

Examples of embodiments are described in detail herein, and examples thereof are shown in the accompanying drawings. When the following descriptions are made with reference to the accompanying drawings, unless otherwise indicated, the same numbers in different accompanying drawings represent the same or similar elements. The implementations described in the following embodiments do not represent all embodiments in accordance with the present disclosure. Instead, they are only examples of devices and methods in accordance with some aspects of the present disclosure as detailed in the appended claims.

It is to be understood that herein, the term “including”, “containing” or any other variants thereof are to cover non-exclusive inclusion, so that a process, method, article or device including a series of elements includes not only those elements, but also other elements not explicitly listed, or elements inherent to such a process, method, article or device. Without more restrictions, an element defined by the phrase “including one” does not exclude the existence of other identical elements in the process, method, article or device including the element, Additionally, a part, a feature, and an element with the same name in different embodiments of the present disclosure may have the same meaning or different meanings, and their meanings need to be determined by their interpretations in the embodiments or according to the context in the embodiments.

It is to be understood that although the terms first, second, and third, etc. may be used herein to describe various information, such information should not be limited by these terms. These terms are only used to distinguish the same type of information from one another. For example, without departing from the scope herein, the first information may also be called the second information, and similarly, the second information may also be called the first information. Depending on the context, the word “if” as used here can be interpreted as “at the time”, “when”, or “in response to the determination of”. Furthermore, as used herein, the singular forms “a”, “an” and “the” are to also include the plural forms, unless the context indicates otherwise.

It should be further understood that the terms “including” and “comprising” indicate the existence of features, steps, operations, elements, components, items, categories, and/or groups, but do not exclude the existence, appearance or addition of one or more other features, steps, operations, elements, components, items, categories, and/or groups. The terms “or”, “and/or”, “including at least one of” and so on used in the present disclosure can be interpreted as inclusive or mean any one or any combination. For example, “including at least one of A, B, and C” means “any one of A; B; C; A and B; A and C; B and C; and A, B, and C”. For example, “A, B, or C” or “A, B and/or C” means “any one of A; B; C; A and B; A and C; B and C; and A, B, and C”. An exception to this definition occurs only when a combination of elements, functions, steps or operations are inherently mutually exclusive in some way.

It is to be understood that although the steps in the flowcharts of some embodiments are displayed sequentially according to instructions of arrows, these steps are not necessarily performed sequentially according to a sequence instructed by the arrows. Unless otherwise clearly specified in this specification, the steps are performed without any strict sequence limit, and may be performed in other sequences. In addition, at least some of the steps in the flowchart may include multiple sub-steps or multiple stages, which may not necessarily be completed at the same time, but may be performed at different times. These sub-steps or stages may not necessarily be performed sequentially, and may be performed alternately with other sub-steps or at least some of other steps or stages.

Depending on the context, the word “if” used here can be interpreted as “at the time”, “when”, or “in response to the determination of”, or “in response to the detection of”. Similarly, depending on the context, the phrases “if . . . is determined” or “if (a condition or event stated) . . . is detected” can be interpreted as “when . . . is determined”, “in response to the determination of”, “when (a condition or event stated) . . . is detected”, or in response to the determination of (a condition or event stated)”.

In related art, the energy management strategy for hybrid electric vehicles is only to control the energy based on the vehicle's own operating conditions, which often leads to the increase of fuel consumption. Therefore, the energy consumption is high.

To this end, some embodiments of the present disclosure provide an intelligent energy management system for a new energy vehicle.

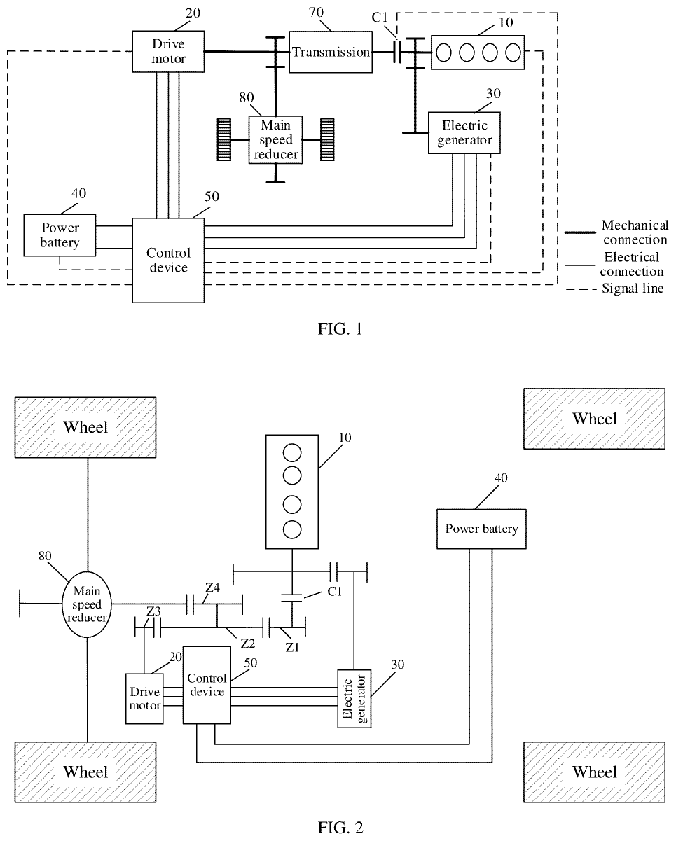

FIG. 1 schematically shows an architecture of an intelligent energy management system for a new energy vehicle according to some embodiments of the present disclosure. As shown in FIG. 1, the intelligent energy management system for a new energy vehicle may include: a drive device (not shown), where the drive device includes an engine 10, a drive motor 20, and an electric generator 30; a power battery 40; and a control device 50. The drive device is configured to provide drive force for the vehicle.

The control device 50 may include at least one of a power domain control module, a cockpit domain module and a cloud control module. For example, the control device can be implemented in the power domain control module (such as VCU of the power domain control module) in the cockpit domain module (such as a host of the cockpit domain), or in a cloud server, or through the cooperation of the above modules, in this disclosure, which is not limited in the present disclosure.

For example, the engine 10 is configured to selectively output power to a wheel of the vehicle. The drive motor 20 is configured to output power to the wheel. The electric generator 30 is connected to the engine 10 and driven by the engine 10 to generate electricity. The power battery 40 is configured to supply electricity to the drive motor 20 and be charged with an alternating current outputted from the electric generator 30 or the drive motor 20.

The control device 50 is configured to acquire multi-domain fusion information, where the multi-domain fusion information at least includes cockpit domain information and power domain information, for example, the cockpit domain information at least includes user behavior information and road condition information of a preset travel route, and the power domain information at least includes vehicle state information; predict, according to the multi-domain fusion information, a route-specific vehicle energy consumption corresponding to the preset travel route, where the preset travel route includes multiple road sections, and the route-specific vehicle energy consumption includes road section-specific vehicle energy consumptions corresponding to the multiple road sections; plan, according to the road section-specific vehicle energy consumption corresponding to each road section, a target SOC corresponding to each road section, to achieve a minimum fuel consumption corresponding to the preset travel route; and control, according to the target SOC and an actual vehicle demand corresponding to each road section, the engine 10, the drive motor 20, the electric generator 30, and the power battery 40, to enable the engine 10 to operate in an efficient operating interval during operation. The user behavior information includes driving style, vehicle usage habit, and electricity consumption habit.

For example, the engine 10 may be an Atkinson cycle engine, and a clutch C1 is arranged between the engine 10 and the wheel. The control device 50 controls the connection and disconnection of the engine 10 to and from the wheel by controlling the disengagement and engagement of the clutch C1, such that the engine 10 can selectively output power to the wheel. In this way, direct drive by the engine 10 can be achieved, that is, the wheel can be directly driven by the engine 10.

For example, when the control device 50 controls the clutch C1 to be disengaged, the engine 10 is disconnected from the wheel, and the engine 10 will not directly output power to the wheel. When the control device 50 controls the clutch C1 to be engaged, the engine 10 is connected to the wheel, and the engine 10 directly outputs power to the wheel, to achieve the direct drive by the engine 10.

Compared with the traditional pure-range extended hybrid electric vehicles, this architecture has an engine direct drive route. In this way, the energy conversion loss caused in the traditional pure-range extended hybrid electric vehicle is avoided, where due to the lack of an engine direct drive path, even if the engine is very efficient (the rotational speed and torque of the engine are both efficient), drive can only be performed by generating electricity by the electric generator and supplying the electricity to the drive motor, and the further energy conversion loss caused by the power battery operating frequently in the charging and discharging state is avoided, thus effectively improving the economy of the vehicle.

The drive motor 20 may be a flat wire motor, and rectangular coils are used in a stator winding of the flat wire motor, to improve the slot fill factor of a stator slot, reduce the motor volume, and greatly improve the power density of the motor. The drive motor 20 is directly connected to the wheel through a gear, and the control device 50 controls the drive motor 20 to operate to output power to the wheel.

For example, the drive motor 20 and the electric generator 30 are arranged in parallel. Compared with other arrangement modes, such as a coaxial arrangement of the drive motor 20 and the electric generator 30, the parallel arrangement mode in this embodiment has less design requirements for the motor, such that a high-power electric generator can be easily arranged and have a low cost.

The electric generator 30 may be a flat wire motor. The electric generator 30 is arranged between the clutch C1 and the engine 10 and the electric generator 30 is connected to the engine 10 through a gear. The control device 50 controls the engine 10 to operate, which in turn drives the electric generator 30 to generate electricity. The generated electricity is controlled by the control device 50 to charge the power battery 40 or supply electricity to the drive motor 20.

In some embodiments, when the control device 50 includes a power domain control module, the power domain control module is respectively connected to the drive motor 20 and the electric generator 30, and the power domain control module supplies electricity to the drive motor 20 with an alternating current outputted from the electric generator 30. The power battery 40 is connected to the power domain control module. The power battery 40 supplies electricity to the drive motor 20 through the power domain control module, is charged by the power domain control module with an alternating current outputted from the electric generator 30 or the drive motor 20. The power domain control module controls the engine 10 to operate efficiently or stop according to a target state of charge (SOC, which is used to reflect the remaining capacity of the battery) and a current SOC of the power battery 40, and the engine is configured to selectively output power to the wheel of the vehicle.

For example, if the target SOC is greater than an initial SOC by a certain threshold, and the actual vehicle demand is less than a vehicle demand enabling the engine to operate in a high-efficiency and economic zone, the engine 10 is controlled to drive the electric generator efficiently to generate electricity. The excess electricity is stored in the power battery 40, and the engine 10 outputs power to the wheel of the vehicle. If the target SOC is greater than the initial SOC by a certain threshold, and the actual vehicle demand is greater than or equal to a vehicle demand enabling the engine 10 to operate in a high-efficiency and economic zone, the engine 10 is controlled to operate in a high-efficiency operating interval, and supply energy to the power battery 40. The drive motor outputs power to the wheel of the vehicle, or outputs power to the wheel of the vehicle together with the engine 10. If the target SOC is less than the initial SOC by a certain threshold, the engine 10 is controlled to stop.

In some embodiments, the intelligent energy management system for a new energy vehicle may further include a speed transmission 70 and a main speed reducer 80. Referring to FIG. 2, FIG. 2 schematically shows an architecture of another intelligent energy management system for a new energy vehicle according to some embodiments of the present disclosure. As shown in FIG. 2, the speed transmission 70 may further include a gear Z1, a gear Z2, a gear Z3, and a gear Z4. For example, a central shaft of the gear Z1 is connected to one end of the clutch C1, the gear Z1 meshes with the gear Z2, the gear Z2 meshes with the gear Z3, a central shaft of the Z3 is connected to the drive motor 20, a central shaft of the gear Z2 is connected to a central shaft of the gear Z4, and the gear Z4 meshes with a main reducer gear of the main speed reducer 80. Definitely, the speed transmission 70 can also have other structures, which is not limited herein.

In some embodiments, the control device 50 is respectively connected to the engine 10, the drive motor 20, the electric generator 30, the power battery 40, and the clutch C1. The control device 50 can send a control signal to the engine 10, the drive motor 20, the electric generator 30, the power battery 40, and the clutch C1 to realize control.

The control device 50 acquires traveling parameters of the hybrid electric vehicle. For example, the traveling parameters include at least one of a wheel torque demand, an SOC of the power battery 40, and a vehicle speed of the hybrid electric vehicle. For example, the wheel torque demand is a vehicle torque demand.

The control device 50 controls the engine 10, the drive motor 20, and the electric generator 30 according to the traveling parameters, so that the engine 10 can operate in an economic zone by controlling the charging and discharging of the power battery 40.

For example, by comparing the equivalent fuel consumptions when the hybrid electric vehicle is in series mode, parallel mode and EV mode, the control device 50 can select an operation mode corresponding to the minimum equivalent fuel consumption as a current operation mode of the hybrid electric vehicle.

It is to be understood that the comparison of equivalent fuel consumptions is based on the comparison when the engine 10 operates in an economic zone. For example, the engine 10 operates in an economic zone of 25 kW. However, considering the traveling parameters such as wheel torque demand, the fuel consumption in parallel mode may be lower than that in series mode and EV mode. At this time, the hybrid electric vehicle is controlled to operate in parallel mode. If the fuel consumption in EV mode is lower than that in parallel mode and series mode, the hybrid electric vehicle is controlled to operate in EV mode.

In addition, it should be noted that the equivalent fuel consumption refers to the sum of the fuel consumed by the engine 10 itself and the fuel equivalent to the electricity consumed by the power battery 40. For example, the electricity consumed by the power battery 40 can be converted into the fuel according to an empirical value to obtain the fuel equivalent to the electricity consumed by the power battery 40. When the power battery 40 is charged, the fuel equivalent to the electricity consumed by the power battery 40 is a negative value. When the power battery 40 is discharged, the fuel equivalent to the electricity consumed by the power battery 40 is a positive value.

That is, the control device 50 can make a comprehensive determination on the traveling parameters of the hybrid electric vehicle, such as the wheel torque demand, SOC of the power battery 40, and vehicle speed of the hybrid electric vehicle, and the equivalent fuel consumptions of the hybrid electric vehicle in different operating modes, to enable the hybrid electric vehicle to operate in an operation mode corresponding to the minimum equivalent fuel consumption while the power demand and noise, vibration and harshness (NVH) are met. In this way, the equivalent fuel consumption of the hybrid electric vehicle is the lowest under all operating conditions, and the hybrid electric vehicle has a higher economy.

For example, the series mode means that the power output between the engine 10 and the wheel is cut off (that is, the clutch C1 is in a disengaged state), and the engine 10 drives the electric generator 30 to generate electricity and provide the electricity to the drive motor 20. In some cases, the engine 10 also charges the power battery 40 through the drive motor 20 with the excess energy. The parallel mode means the power coupling between the engine 10 and the wheel (that is, the clutch C1 is in an engaged state). In some cases, the engine 10 also charges the power battery 40 through the drive motor 20 with the excess energy. The EV mode means that neither the engine 10 nor the electric generator 30 operates, and the power battery 40 supplies electricity to the drive motor 20.

In addition, when the hybrid electric vehicle operates in series mode, parallel mode, or EV mode, the engine 10 is enabled to constantly operate in an economic zone by controlling the charging and discharging of the power battery 40. Moreover, the comparison of equivalent fuel consumptions is also based on the comparison when the engine 10 operates in the economic zone. In this way, the engine 10 can always operate in a high-efficiency zone under all operating conditions, and the equivalent fuel consumption of the hybrid electric vehicle is the lowest, thus effectively improving the economy of the hybrid electric vehicle. In this embodiment, through the comprehensive control and cooperation of the large-capacity power battery, the engine, the drive motor, and the electric generator, the hybrid electric vehicle is ensured to operate in an energy-saving mode.

In some embodiments of the present disclosure, after a user selects a travel route, when the vehicle moves into a current road section during the travel process, the vehicle interacts with vehicles using the speed planning function present in a certain range of the current road section for data of traveling information, and traveling information such as the vehicle speed and road type is sent to nearby vehicles using this function by using the wireless communication technology in vehicle networking, to improve the dimension and accuracy of input information through the traveling information transmitted by nearby vehicles.

When the navigation system and pathfinding are started, the navigation information is corrected/adjusted by collecting the interaction data of nearby vehicles. The interaction data of nearby vehicles is vehicle-to-vehicle (V2V) data. The most commonly used V2V data is the vehicle speed. The information such as vehicle speed and distance can be transmitted to nearby vehicles by short-distance wireless communication to form a queue in travel for short-distance predictive control. Communication through “vehicle-cloud-vehicle”, that is, through wireless cloud service, can also be used, which is not limited by the distance and can supplement the vehicle speed prediction and energy consumption prediction to the map navigation.

By identifying the special road conditions in a coming road section, such as traffic light intersections, long uphill, traffic jam and vehicle-following, the vehicle speed and SOC planning are updated in time, and the vehicle is adjusted to be in an efficient operating state. When the navigation and pathfinding are not started, the interaction data of nearby vehicles are collected and combined with the historical data of the vehicle, such as the peripheral information collected by sensors such as laser radar, millimeter wave radar, and camera, to predict the future travel of the vehicle in a short time, and perform an optimization calculation for the minimum energy consumption according to the predicted operating condition in a short time, thus reducing the fuel consumption of the user.

During the traveling process, when the vehicle moves away from the current road section, the historical traveling information is uploaded through the “vehicle-cloud” communication mode, which is used for statistical analysis of relevant data, and provides a support for other vehicles that will use the speed planning function in the near future in optimizing the travel planning through the “vehicle-cloud-vehicle” mode.

In some embodiments of the present disclosure, multi-source information that can be obtained from four levels including persons, vehicles, roads, and networks are collected, and the main factors affecting the energy consumption are analyzed, including the vehicle usage habit (route selection, driving style, charging habit, and vehicle settings etc.), vehicle state (vehicle parameters and load, vehicle speed, power consumption of accessories, intelligent driving state, and other state parameters), road information (slope, speed limit, and road adhesion, etc.), and networked information (traffic flow, traffic light, global positioning system (GPS) positioning information, and vehicle-to-everything (V2X) information, etc.). Through the division of road types, discrimination and identification of driving styles, rolling updating and other ways, the multi-source information is subjected to alignment of spatial-temporal sequences, and subjected to variable weight superposition based on a theoretical model and a data model, to predict the route-specific vehicle energy consumption corresponding to the route preset by the user.

For example, the alignment of spatial-temporal sequences means to unify the coordinates of the multi-source information by taking the preset travel route (distance or time) as the coordinate axis to generate sequences for prediction and control, where some factors mainly differ in temporal sequence, the road information is based on the distance information on map navigation, and the networked information is also the case.

When the user determines a travel route, the vehicle receives navigation information. Multiple road sections are divided according to the information attributes in the following formats, such as road type, road length, average traveling speed, congestion degree, and the like. The road section information is uniformly converted according to the data format of the vehicle calculation module. The same type of road sections are merged according to the constraints such as average traveling speed, road type, congestion degree, and the like, the road section distribution on the travel route is updated, and the energy consumption corresponding to a corresponding road section is calculated by substituting the road section type into an energy consumption prediction model.

During the traveling process, a location of the vehicle on the travel route is calculated by a GPS module on the vehicle, a current nth road section is determined according to a relative distance between a current location and a travel destination, and an update operation of excluding the information of the preceding n−1 road sections is performed, to realize the unification of the data in spatial and temporal dimensions.

In some embodiments of the present disclosure, the engine 10 is configured to selectively output power to a wheel of the vehicle. The drive motor 20 is configured to output power to the wheel. The electric generator 30 is connected to the engine 10 and driven by the engine 10 to generate electricity. The power battery 40 is configured to supply electricity to the drive motor 20 and be charged with an alternating current outputted from the electric generator 30 or the drive motor 20.

The control device 50 is configured to acquire multi-domain fusion information, where the multi-domain fusion information at least includes cockpit domain information and power domain information, for example, the cockpit domain information at least includes user behavior information and road condition information of a preset travel route, and the power domain information at least includes vehicle state information; predict, according to the multi-domain fusion information, a route-specific vehicle energy consumption corresponding to the preset travel route, where the preset travel route includes multiple road sections, and the route-specific vehicle energy consumption includes road section-specific vehicle energy consumptions corresponding to the multiple road sections; plan, according to the road section-specific vehicle energy consumption corresponding to each road section, a target SOC corresponding to each road section, to achieve a minimum fuel consumption corresponding to the preset travel route; and control, according to the target SOC and an actual vehicle demand corresponding to each road section, the engine 10, the drive motor 20, the electric generator 30, and the power battery 40, to enable the engine 10 to operate in an efficient operating interval during operation.

I. Multi-domain fusion information is acquired, where the multi-domain fusion information at least includes cockpit domain information and power domain information. For example, the cockpit domain information at least includes user behavior information and road condition information of a preset travel route, and the power domain information at least includes vehicle state information.

In some embodiments, the user behavior information is identified by artificial intelligence (AI) algorithm, and the electricity consuming habit and driving style of the user are learned through the user behavior information. The driving style includes: aggressive driving, ordinary driving, and mild driving. The road condition information of the preset travel route and the vehicle state information are fused. For example, the road condition information may include road type or road traffic flow speed, and the vehicle state information may include wind resistance, rolling resistance, acceleration resistance, and slope resistance, etc.

II. A route-specific vehicle energy consumption corresponding to the preset travel route is predicted, according to the multi-domain fusion information, where the preset travel route includes multiple road sections, and the route-specific vehicle energy consumption includes road section-specific vehicle energy consumptions corresponding to the multiple road sections.

For example, the preset travel route can be determined as follows.

In some embodiments, if a self-start function of the navigation system is enabled and a current system time is within a preset vehicle usage time period, the navigation system is automatically started, and the preset travel route is determined according to the current location information of the vehicle.

In some embodiments, when the self-start function of the navigation system is enabled and the vehicle usage time period set by the user, that is, the owner, is met, such as 9:00 am to 10:00 am and 5:00 μm to 6:00 μm, the navigation system will be automatically started when the vehicle is driven in these two time periods, and the preset travel route is determined according to the current location information of the vehicle.

In some embodiments, if the self-start function of the navigation system is disabled the preset travel route is determined in response to an end point inputted by the user.

In some embodiments, the preset travel route includes multiple road sections, and the multiple road sections are divided according to road condition information of each road section. The route-specific vehicle energy consumption includes road section-specific vehicle energy consumptions corresponding to the multiple road sections. Each road section-specific vehicle energy consumption is related to the road condition information of each road section.

In some embodiments, the division of each road section is related to the road condition information of the preset travel route.

In some embodiments, the road condition information may include road type and congestion degree, and the preset travel route is divided into multiple road sections according to the road type and congestion degree.

In some embodiments, each road section is divided according to at least one of the road type and the congestion level of the preset travel route.

In some embodiments, the preset travel route can be divided into urban road section and rural road section according to the road type, and into fast road section or congested road section according to the congestion level.

In some embodiments, the preset travel route is determined in response to an end point inputted by the user. At least one candidate energy-saving route can be determined according to a start point and an end point of the vehicle. The predicted route-specific vehicle energy consumption corresponding to the at least one candidate energy-saving route is less than the predicted route-specific vehicle energy consumptions corresponding to other routes. The route-specific vehicle energy consumption is predicted according to the multi-domain fusion information of each route. The preset travel route is determined in response to an operation of selecting at least one candidate energy-saving route. The preset travel route refers to the selected candidate energy-saving route. The preset travel route includes multiple road sections, and the route-specific vehicle energy consumption includes road section-specific vehicle energy consumptions corresponding to the multiple road sections.

In some embodiments, at least one candidate energy-saving route is determined according to a start point and an end point of the vehicle. A start point of any candidate travel route is the start point of the vehicle, and an end point of any candidate travel route is the end point. According to the multi-domain fusion information of each candidate travel route, the route-specific vehicle energy consumption of the vehicle corresponding to each candidate travel route is predicted. According to the route-specific vehicle energy consumption of the vehicle corresponding to each candidate travel route, at least one candidate energy-saving route is determined from the at least one candidate travel route. The route-specific vehicle energy consumption of the vehicle corresponding to any candidate energy-saving route is less than the route-specific vehicle energy consumptions of the vehicle corresponding to other candidate travel routes than the at least one candidate energy-saving route in the at least one candidate travel route.

In some embodiments, according to the user behavior information, the road condition information of each candidate travel route, and energy consumption affecting information, for example, the aggressive driving style of the user, the slope of the candidate travel route, and the vehicle speed, the route-specific vehicle energy consumption of the vehicle corresponding to each candidate travel route is predicted. According to the route-specific vehicle energy consumption of the vehicle corresponding to each candidate travel route, at least one candidate energy-saving route is determined from the at least one candidate travel route.

In some embodiments, at least one candidate travel route is determined according to a start point and an end point of the vehicle. This process is as follows. At least one travel route from the start point to the end point of the vehicle is acquired. Based on a first travel dimension index of each travel route, m travel routes are determined from the at least one travel route, where m is a positive integer, and the first travel dimension index of any travel route of the m travel routes is less than the first travel dimension index of other travel routes than the m travel routes in the at least one travel route. Based on a second travel dimension index of the m travel routes, at least one candidate travel route is determined from the m travel routes, where the second travel dimension index of any candidate travel route is less than the second travel dimension index of other travel routes than the at least one candidate travel route in the m travel routes.

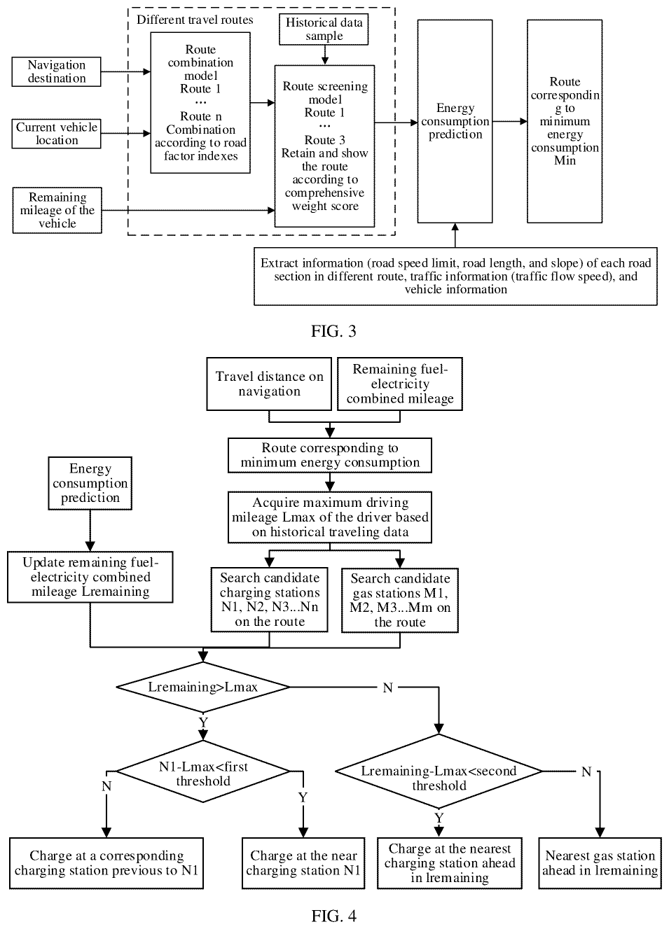

Referring to FIG. 3, FIG. 3 schematically shows the logic of determining a candidate energy-saving route according to some embodiments of the present disclosure. In some embodiments, different candidate travel routes are mainly selected according to the current location of the vehicle and the end point of navigation of the user. With reference to the influence of travel factors from the start location to the end location, including the estimated driving distance, estimated energy consumption, and estimated traffic smoothness, big data analysis is performed according to the user's travel experience, the actual traffic flow influence and other information.

The factor having the highest influence is selected as the first travel dimension index, and the first travel dimension index is selected to accomplish the travel. For example, the travel distance is selected and used as the first travel dimension index according to the principle of shortest travel distance. The travel routes are arranged and combined according to the first travel dimension index based on the road connectivity in the road network, and m travel routes are determined. Moreover, to meet the second travel dimension index, such as shortest time, a route corresponding to the least time is selected from the current combination. At least one candidate travel route is accordingly determined from the m travel routes.

In some embodiments, the first travel dimension index includes a travel distance, and the second travel dimension index includes a travel time.

In some embodiments, based on the second travel dimension index of the m travel routes, at least one candidate travel route is determined from the m travel routes. This process is as follows. A target travel route with the minimum second travel dimension index is determined from the m travel routes. A travel route with a second travel dimension index that differs from the second travel dimension index of the target travel route by a value that is less than a preset index threshold is screened out from the m travel routes. The screened travel route is taken as the at least one candidate travel route.

In some embodiments, according to the travel time constraint, m candidate travel routes corresponding to the least time are selected from the current combination. According to a screening principle of the shortest time plus the preset index threshold, such as a preset index threshold that is 30 min, for example, a time change range of 30 min can be updated by self-learning, and finally n alternative routes are retained, where n is a positive integer.

In some embodiments, at least one candidate travel route is determined according to a start point and an end point of the vehicle. This process is as follows. At least one travel route from the start point to the end point of the vehicle is acquired. Travel dimension indexes of each travel route are acquired, where the weight of each travel dimension index corresponds to a current travel scenario of the vehicle. Each travel dimension index is weighted according to each weight, to obtain a comprehensive travel index of each travel route. According to the comprehensive travel index of each travel route, at least one candidate travel route is selected from at least one travel route, where the comprehensive travel index of the at least one candidate travel route is less than the comprehensive travel indexes of other travel routes than the at least one candidate travel route in the at least one travel route.

In some embodiments, as shown in FIG. 3, different travel dimension indexes such as time, distance, and energy consumption, are allocated according to the importance of completing the travel in different travel scenarios, and different weights (21, 222 . . . . Qn, are allocated. For example, a short travel time is given priority in a short-distance travel. In this case, the time weight is greater, and the distance and energy consumption weights are smaller. Comprehensive scores of the alternative routes are obtained through weighted calculation, and a certain number of candidate travel routes are reserved according to the scores.

For example, when the preset travel route is determined, the remaining drivable mileage of the vehicle and the driving mileage to the end point need to be considered. If the remaining drivable mileage of the vehicle is less than the driving mileage to the end point, an energy-supplementing strategy in the driving process on the preset travel route is determined. That is, when the driving mileage to the end point is greater than the remaining drivable mileage based on the predicted energy consumption L_{remaining}, the energy-supplementing strategy in the driving process on the preset travel route is determined.

In some embodiments, the energy-supplementing strategy in the driving process on the preset travel route can be determined as follows. The prior-fatigue drivable mileage of the driver is acquired. The prior-fatigue drivable mileage represents the drivable mileage before the driver reaches a fatigue driving state. Based on the prior-fatigue drivable mileage and the remaining drivable mileage of the vehicle, the vehicle is controlled to drive to a target charging address for charging or to a target refueling address for refueling.

In some embodiments, referring to FIG. 4, FIG. 4 schematically shows the logic of an energy-supplementing strategy according to some embodiments of the present disclosure. When the driving mileage to the end point is greater than the remaining fuel-electricity combined mileage L_{remaining} of the vehicle based on the predicted energy consumption, the travel time is used as a constraint. In a preferred energy-saving route, the networked distributions of gas stations (M1, M2, M3, M4 . . . ), and charging stations (N1, N2, and N3 . . . ), the prior-fatigue drivable mileage Lmax of the driver, and other information are presented by the navigation.

For example, M1, M2, M3, M4 . . . , and N1, N2, N3 . . . are plans for refueling and charging made based on the distance from a location where the driver is fatigue and needs to take a rest, by determining the prior-fatigue drivable mileage of the driver, the distribution mileage of the charging station, and the remaining fuel-electricity combined mileage. The recommended charging and refueling options are displayed on a navigation interface of an on-board display screen. For example, the fatigue driving range of the driver, that is, the maximum driving mileage of the driver, is acquired based on the historical driving data, and the maximum driving mileage of the driver is updated. The remaining fuel-electricity combined mileage is updated by an energy consumption prediction method.

In some embodiments, based on the prior-fatigue drivable mileage and the remaining drivable mileage of the vehicle, the vehicle is controlled to drive to a target charging address for charging or to a target refueling address for refueling. This process is as follows. If the remaining drivable mileage of the vehicle is greater than or equal to the prior-fatigue drivable mileage and the distance between a first charging address and an end point of the prior-fatigue drivable mileage is less than a first preset distance threshold, the vehicle is controlled to drive to the first charging address for charging. The distance between the first charging address and the end point of the prior-fatigue drivable mileage is less than the distance between other charging addresses and the end point of the prior-fatigue drivable mileage.

In some embodiments, as shown in FIG. 4, the first preset distance threshold is a first threshold, and the first charging address is N1. When the remaining fuel-electricity drivable mileage L_{remaining} is greater than or equal to Lmax, whether N1−Lmax is less than the first threshold is further determined, the vehicle is controlled to drive to the nearest charging address N1 for charging if yes. When the value is less than the first threshold, the prior-fatigue drivable mileage of the driver is ignored, and the vehicle is controlled to drive to the nearest charging address N1 for charging.

In some embodiments, based on the prior-fatigue drivable mileage and the remaining drivable mileage of the vehicle, the vehicle is controlled to drive to a target charging address for charging or to a target refueling address for refueling. This process is as follows. If the remaining drivable mileage of the vehicle is greater than or equal to the prior-fatigue drivable mileage and the distance between a first charging address and an end point of the prior-fatigue drivable mileage is greater than or equal to a first preset distance threshold, the vehicle is controlled to drive to a second charging address for charging.

For example, the distance between the first charging address and the end point of the prior-fatigue drivable mileage is less than the distance between other charging addresses and the end point of the prior-fatigue drivable mileage. The second charging address features a charging address previous to the first charging address on the preset travel route.

In some embodiments, as shown in FIG. 4, when the remaining fuel-electricity drivable mileage L_{remaining} is greater than or equal to Lmax, and N1−Lmax is greater than or equal to the first threshold, the vehicle is controlled to drive to a corresponding charging address previous to N1 for charging, that is, drive to the second charging address for charging. When N1−Lmax is greater than the first threshold, the prior-fatigue drivable mileage cannot be ignored, and the vehicle is controlled to drive to a corresponding charging station previous to N1 for charging, to ensure the driving safety.

In some embodiments, based on the prior-fatigue drivable mileage and the remaining drivable mileage of the vehicle, the vehicle is controlled to drive to a target charging address for charging or to a target refueling address for refueling. This process is as follows. If the remaining drivable mileage of the vehicle is less than the prior-fatigue drivable mileage and the difference between the prior-fatigue drivable mileage and the remaining drivable mileage is less than a second preset distance threshold, the vehicle is controlled to drive to a third charging address for charging. The third charging address is located before the end point of the remaining drivable mileage, and the distance between the third charging address and the end point of the remaining drivable mileage is less than the distance between other charging addresses and the end point of the prior-fatigue drivable mileage. Other charging addresses feature the remaining charging addresses than the third charging address in the charging addresses located before the end of the remaining removable mileage.

In some embodiments, as shown in FIG. 4, the second preset distance threshold is a second threshold. When the remaining fuel-electricity drivable mileage L_{remaining} is less than the Lmax, whether L_{remaining}−Lmax is less than the second threshold is further determined, and The vehicle is controlled to drive to the nearest charging address before the end point of L_{remaining} for charging if yes. If the value is less than the second threshold, the vehicle is preferentially charged, to ensure the driving safety.

In some embodiments, based on the prior-fatigue drivable mileage and the remaining drivable mileage of the vehicle, the vehicle is controlled to drive to a target charging address for charging or to a target refueling address for refueling. This process is as follows. If the remaining drivable mileage of the vehicle is less than the prior-fatigue drivable mileage and the difference between the prior-fatigue drivable mileage and the remaining drivable mileage is greater than or equal to a second preset distance threshold, the vehicle is controlled to drive to a target refueling address for refueling.

For example, the target refueling address is located before the end point of the remaining drivable mileage, and the distance between the target refueling address and the end point of the remaining drivable mileage is less than the distance between other target refueling addresses and the end point of the prior-fatigue drivable mileage. Other refueling addresses feature the remaining charging addresses other than the target refueling address in the refueling addresses located before the end of the remaining removable mileage.

In some embodiments, as shown in FIG. 4, when the remaining fuel-electricity drivable mileage L_{remaining} is less than the Lmax, and L_{remaining}−Lmax is greater than or equal to the second threshold, the vehicle is controlled to drive to the nearest refueling address before the end point of L_{remaining} for refueling. When the value is greater than or equal to the second threshold, the vehicle is refueled to ensure the shortest travel time.

When the preset travel route is determined, a route-specific vehicle energy consumption corresponding to the preset travel route is predicted, according to the multi-domain fusion information. The route-specific vehicle energy consumption corresponding to the preset travel route can be predicted by any one of the following five methods.

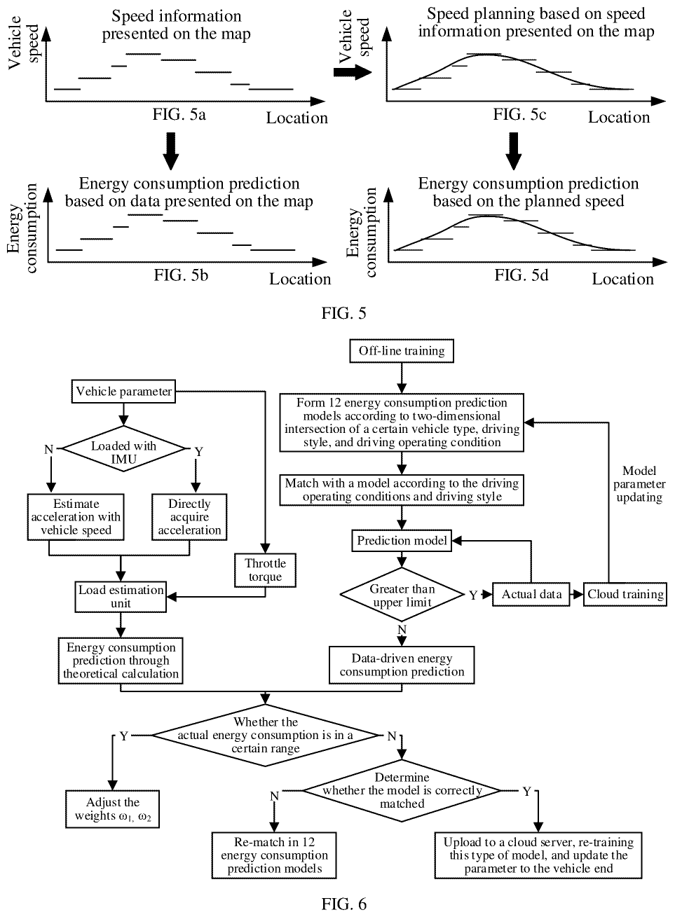

For example, referring to FIG. 5, FIG. 5 schematically shows the energy consumption prediction according to some embodiments of the present disclosure. FIG. 5a schematically shows the speed presented on the map. The actual map data is not the speed, but the distance of and estimated passing time through each section, from which the average speed on this section is calculated. Therefore, the data is discrete. FIG. 5b schematically shows direct energy consumption prediction based on the presentations on the map. Since the speed is discrete and the energy consumption is directly related to the speed, the energy consumption is also discrete. FIG. 5c schematically shows the result of speed planning based on the presentations on the map. The speed planning is to control the vehicle to drive at the planned speed. A continuous speed is given, so that the energy consumption can be lower. Therefore, the planning is discrete. FIG. 5d schematically shows the results of energy consumption prediction based on the planned speed. For example, for the steps of energy consumption prediction based on the data presented on the map, please refer to the steps in section 1, 2 or 3; and for the steps of energy consumption prediction based on the planned speed, please refer to the corresponding steps in section 4 below.

1. By the automobile theoretical energy consumption prediction algorithm, and according to the road traffic flow speed and the static parameters of the vehicle, the route-specific vehicle energy consumption corresponding to the preset travel route is predicted. The route-specific vehicle energy consumption is corrected/adjusted according to the user behavior information, and the corrected/adjusted route-specific vehicle energy consumption is a theoretical energy consumption demand.

In some embodiments, the static parameters of the vehicle at least includes: wind resistance, rolling resistance, acceleration resistance, and slope resistance to the vehicle.

In some embodiments, the theoretical energy consumption demand is calculated by a formula below: drive force*road traffic flow speed*time, and the drive force Fₜ=F_{f}+F_{w}+Fᵢ+Fⱼ; where Fₜ represents the drive force, F_{f} represents the rolling resistance, F_{w} represents the air resistance, Fᵢ represents the slope resistance, Fⱼ represents the acceleration resistance.

In some embodiments, Referring to FIG. 6, FIG. 6 schematically shows the logic of an energy consumption prediction method according to some embodiments of the present disclosure. For example, the energy consumption prediction method predicts the energy consumption corresponding to a travel route based on the automobile theory and data-driven fusion according to the predicted operating condition information. For example, the automobile theory mainly calculates a main range of energy consumption prediction, to ensure that the data-driven mode will not have a large deviation. The road condition information may further include the slope information. The static parameters of the vehicle include the wind resistance, rolling resistance, acceleration resistance, and slope resistance of the vehicle. The static parameters of the vehicle may further include the driving speed, curb weight, windward area, and other factors that affect the energy consumption, such as inherent parameters of the vehicle affecting the energy consumption.

For example, the automobile theoretical energy consumption prediction algorithm is derived from Fₜ=F_{f}+F_{w}+Fᵢ+Fⱼ, where F_{f} is the rolling resistance, and F_{f}=mgf, in which m is the curb weight, in kg; g is the acceleration of gravity, and g is 9.8 m/s; f is the rolling resistance coefficient; F_{w} is the air resistance,

$${F}_{w} = \frac{{C}_{D} {Au}_{a}^{2}}{21.15} ,$$

C_{D} is the air resistance coefficient; A is the windward area, in square meter; uₐ is the vehicle speed, in km/h; Fᵢ is the slope resistance, Fᵢ=mg sin α, α is the slope angle; Fⱼ is the acceleration resistance, Fⱼ=σma, σ is the rotating mass conversion factor of the vehicle; and a is the vehicle acceleration in m/s². In addition to the vehicle parameters, the change of load is also considered. The load is estimated according to the vehicle acceleration and the throttle torque. If the vehicle is equipped with an inertial measurement unit (IMU), the acceleration comes from the IMU. If the vehicle has no IMU, the acceleration is estimated by the change of the vehicle speed.

2. The road type, driving style and vehicle type information are inputted into a target energy consumption prediction model, and the target energy consumption prediction model outputs a predicted route-specific vehicle energy consumption corresponding to the preset travel route, where the route-specific vehicle energy consumption is a reference energy consumption demand. For example, the target energy consumption prediction model is determined from multiple preset energy consumption prediction models according to at least one of the road type of the preset travel route or the driving style information of the user.

In some embodiments, the vehicle type information refers to the vehicle parameters, and the target energy consumption prediction model is a data-driven part. In the data-driven part, not only the driving style and driving operating condition, but also the use of vehicle air conditioners, the power consumptions of the battery thermal management system and low-voltage accessories such as lights, instruments, fans, water pumps, multimedia, seat heating, and seat ventilation, the coming weather conditions in the travel, such as temperature, humidity, and wind speed, the coming terrain conditions in the travel, for example, viaduct bridge, slope, air resistance, and track resistance, the distribution of refueling addresses and charging addresses, the charging condition at the end point, and others are considered.

The data-driven way is to obtain an energy consumption prediction model by off-line training based on the machine learning algorithm, and then carry out data closed-loop predictive online learning according to the real-time running data. When the model error constantly exceeds a certain threshold, data are collected, and the data are uploaded to the cloud for self-learning training of the model, to improve the model accuracy. The model parameters are updated to the off-line vehicle-end model through cloud services, where the off-line vehicle-end model runs in the on-board unit of the vehicle.

In some embodiments, the road type includes: ordinary road, expressway, highway, and congested road.

In some embodiments, the user's driving style is divided into aggressive, ordinary and mild according to the rate of change of the opening of the accelerator pedal and the rate of change of the acceleration.

In some embodiments, as shown in FIG. 6, because the energy consumption of different vehicles and drivers varies greatly, all the driving behavior data of a certain vehicle type are analyzed by two-dimensional clustering according to the driving style and driving operating condition. For example, the driving operating condition is divided into ordinary road, expressway, highway, and congested road, and the driving style is divided into aggressive, ordinary and mild according to the rate of change of the opening of the accelerator pedal and the rate of change of the acceleration. 12 groups of driving data of this vehicle type are divided by two-dimensional intersection. Based on the 12 groups of data, off-line training of the energy consumption prediction model is performed by using random forest and other algorithms, and 12 different parameter models are obtained to feature the energy consumption prediction models corresponding to different group classifications.

The obtained model is deployed in a vehicle-end controller after model compression, and a driving style identification algorithm is deployed at the vehicle end, to dynamically identify the driver's driving style, and driving operating condition, so that a corresponding model is called to predict the energy consumption corresponding to the travel route.

Additionally, after the actual driving behavior occurs, the predicted energy consumption is compared with the actual energy consumption, the driving behavior data with an error greater than a certain threshold is uploaded to the cloud, to trigger the cloud training of the prediction model, update the corresponding energy consumption prediction model, and realizes data closed-loop learning.

3. According to the theoretical energy consumption demand and the reference energy consumption demand of the vehicle corresponding to the preset travel route, the route-specific vehicle energy consumption corresponding to the preset travel route is predicted. The theoretical energy consumption demand is calculated by the automobile theoretical energy consumption prediction algorithm, and the reference energy consumption demand is outputted by the target energy consumption prediction model. The theoretical energy consumption demand and the reference energy consumption demand are weighted and added, to predict the route-specific vehicle energy consumption corresponding to the preset travel route.

In some embodiments, a first weight of the theoretical energy consumption demand and a second weight of the reference energy consumption demand are acquired; and the theoretical energy consumption demand and the reference energy consumption demand of the vehicle are weighted according to the first weight and the second weight, to predict the route-specific vehicle energy consumption of the vehicle.

In some embodiments, the determined first weight of the theoretical energy consumption demand and second weight of the reference energy consumption demand are used for weighted calculation, to predict the route-specific vehicle energy consumption of the vehicle. Because of the calculation error of the automobile theoretical energy consumption prediction algorithm, the target energy consumption prediction model may be distorted. Therefore, when the two are combined, the second weight of the reference energy consumption demand will become increasingly greater with the increase of data volume, and the first weight of the theoretical energy consumption demand will become increasingly smaller.

In some embodiments, the sum of the first weight of the theoretical energy consumption demand and the second weight of the reference energy consumption demand is controlled to 1, and the first weight of the theoretical energy consumption demand and the second weight of the reference energy consumption demand are updated with the constraint condition that the actual road section-specific vehicle energy consumption is in a preset range, to obtain the updated first weight of the theoretical energy consumption demand and the updated second weight of the reference energy consumption demand. The first weight of the theoretical energy consumption demand and the second weight of the reference energy consumption demand can be acquired by acquiring the updated first weight of the theoretical energy consumption demand and the updated second weight of the reference energy consumption demand of the vehicle.

In some embodiments, if the predicted road section-specific vehicle energy consumption of the vehicle corresponding to a nth road section is different from the actual road section-specific vehicle energy consumption corresponding to the nth road section, the actual road section-specific vehicle energy consumption of the vehicle corresponding to the nth road section and a model identifier of the target energy consumption prediction model are sent to a server, so that the server can optimize the energy consumption prediction model corresponding to the model identifier based on the actual road section-specific vehicle energy consumption corresponding to the nth road section.

In some embodiments, the actual road section-specific vehicle energy consumption of the vehicle corresponding to the nth road section and a model identifier of the target energy consumption prediction model are sent to a server. The server retrains the energy consumption prediction model corresponding to the model identifier until a target energy consumption prediction model reaching preset conditions is achieved. Then, the parameter of the energy consumption prediction model corresponding to the model identifier is updated. If the training is completed, the parameter is sent to the vehicle-end off-line model; otherwise, the parameter of the energy consumption prediction model corresponding to the model identifier is continuously used.

In some embodiments, the road section-specific vehicle energy consumption of the vehicle corresponding to the nth road section is predicted as follows.

The first weight of the theoretical energy consumption demand and the second weight of the reference energy consumption demand of the vehicle corresponding to the nth road section are acquired, where n is a positive integer. The theoretical energy consumption demand and the reference energy consumption demand of the vehicle corresponding to the nth road section are weighted according to the first weight and the second weight, to predict the vehicle energy consumption of the vehicle corresponding to the nth road section.

In some embodiments, the first weight of the theoretical energy consumption demand and the second weight of the reference energy consumption demand corresponding to the nth road section are acquired, where n is, for example, a positive integer. The theoretical energy consumption demand and the reference energy consumption demand corresponding to the nth road section are weighted, to predict the road section-specific vehicle energy consumption of the vehicle corresponding to the nth road section.

In some embodiments, after the vehicle travels through the nth road section, the actual road section-specific vehicle energy consumption of the vehicle corresponding to the nth road section is acquired. If the actual road section-specific vehicle energy consumption is in a threshold range, the first weight and the second weight are kept unchanged, where the threshold range is determined according to the predicted road section-specific vehicle energy consumption of the vehicle corresponding to the nth road section.

In some embodiments, according to the theoretical energy consumption demand and the reference energy consumption demand, the theoretical energy consumption demand and the reference energy consumption demand are weighted by using the current weights, to obtain the predicted road section-specific vehicle energy consumption. After driving through the road section, the actual road section-specific vehicle energy consumption is acquired, and compared with the predicted value. If the difference value is within a threshold range, the first weight and the second weight are kept unchanged.

In some embodiments, the theoretical energy consumption demand and the reference energy consumption demand of the vehicle corresponding to the nth road section are acquired. According to a first initial weight of the theoretical energy consumption demand and a first initial weight of the reference energy consumption demand, the theoretical energy consumption demand and the reference energy consumption demand of the vehicle corresponding to the nth road section are weighted, to obtain a first reference road section-specific vehicle energy consumption corresponding to the nth road section. After the vehicle travels through the nth road section, the actual road section-specific vehicle energy consumption of the vehicle corresponding to the nth road section is acquired. If the actual road section-specific vehicle energy consumption is greater than the first reference road section-specific vehicle energy consumption, the target energy consumption prediction model is optimized.

In some embodiments, according to the weights of the theoretical energy consumption demand and the reference energy consumption demand of the vehicle corresponding to the nth road section, the theoretical energy consumption demand and the reference energy consumption demand of the vehicle corresponding to the road section are weighted, to obtain a first reference road section-specific vehicle energy consumption. After the vehicle travels through the road section, the actual vehicle energy consumption and the first reference road section-specific vehicle energy consumption are compared. If the actual road section-specific vehicle energy consumption is greater than the first reference road section-specific vehicle energy consumption, the target energy consumption prediction model is optimized, to improve the accuracy.

In some embodiments, the theoretical energy consumption demand and the reference energy consumption demand of the vehicle corresponding to the nth road section are acquired. According to a second initial weight of the theoretical energy consumption demand and a second initial weight of the reference energy consumption demand, the theoretical energy consumption demand and the reference energy consumption demand of the vehicle corresponding to the nth road section are weighted, to obtain a second reference road section-specific vehicle energy consumption corresponding to the nth road section. After the vehicle travels through the nth road section, the actual road section-specific vehicle energy consumption of the vehicle corresponding to the nth road section is acquired. If the actual road section-specific vehicle energy consumption is less than the second reference road section-specific vehicle energy consumption, the target energy consumption prediction model is optimized.

In some embodiments, according to the weights of the theoretical energy consumption demand and the reference energy consumption demand of the vehicle corresponding to the nth road section, the theoretical energy consumption demand and the reference energy consumption demand of the vehicle corresponding to the road section are weighted, to obtain a second reference road section-specific vehicle energy consumption. After the vehicle travels through the road section, the actual road section-specific vehicle energy consumption and the second reference road section-specific vehicle energy consumption are compared. If the actual road section-specific vehicle energy consumption is less than the second reference road section-specific vehicle energy consumption, the target energy consumption prediction model is optimized, to improve the accuracy.

In some embodiments, the first weight of the theoretical energy consumption demand and the second weight of the reference energy consumption demand of the vehicle corresponding to the nth road section can be acquired as follows. The theoretical energy consumption demand and the reference energy consumption demand of the vehicle corresponding to the nth road section in the preset travel route are acquired. According to a first initial weight of the theoretical energy consumption demand and a first initial weight of the reference energy consumption demand, the theoretical energy consumption demand and the reference energy consumption demand of the vehicle corresponding to the nth road section are weighted, to obtain a first reference road section-specific vehicle energy consumption corresponding to the nth road section. According to a second initial weight of the theoretical energy consumption demand and a second initial weight of the reference energy consumption demand, the theoretical energy consumption demand and the reference energy consumption demand of the vehicle corresponding to the nth road section are weighted, to obtain a second reference road section-specific vehicle energy consumption corresponding to the nth road section. After the vehicle travels through the nth road section, the actual road section-specific vehicle energy consumption of the vehicle corresponding to the nth road section is acquired. If the actual road section-specific vehicle energy consumption is greater than the second reference road section-specific vehicle energy consumption and less than the first reference road section-specific vehicle energy consumption, the first weight and the second weight are updated. The updated first weight is used as a current first weight of the theoretical energy consumption demand, and the updated second weight is used as a current second weight of the reference energy consumption demand.

In some embodiments, as shown in FIG. 6, a preset distance L is 5 km, the first weight is ω₁, the second weight is ω₂, the first initial weight of the theoretical energy consumption demandE_{theoretical} is 0.2, the first initial weight of the reference energy consumption demandE_{model} is 0.8, the second initial weight of the theoretical energy consumption demand is 0.8, the second initial weight of the reference energy consumption demand is 0.2, and the reference road section-specific vehicle energy consumption is Eₜₒₜₐₗ, including the first reference road section-specific vehicle energy consumption and the second reference road section-specific vehicle energy consumption. The fusion mode of energy consumption prediction methods is weighted sum: Eₜₒₜₐₗ=ω₁E_{theoretical}+ω₂E_{model}, in which ω₁, ω₂Δ[0.2, 0.8].

The type of the energy consumption prediction model is re-matched and the weights ω₁, ω₂ in the energy consumption prediction method are adjusted every 5 km. When the actual road section-specific vehicle energy consumption 0.8E_{theoretical}+0.2E_{model}<E_{actual 1}<0.2E_{theoretical}+0.8E_{model}, ω₁, ω₂ are re-adjusted. The method for further adjustment is to solve ω₁+ω₂=1, E_{actual1}=ω₁E_{theoretical}+ω₂E_{model}, and the weights are retained.

When the actual road section-specific vehicle energy consumption E_{actual1}>0.2E_{theoretical}+0.8E_{model}, whether the current energy consumption prediction model is matched correctly is determined according to the driving operating condition and driving style. If incorrectly matched, re-matching is performed in 12 energy consumption prediction models. If correctly matched, E_{actual 1} in the 5 km is uploaded to the cloud servicer, or this type of energy consumption prediction model is retrained locally on the vehicle, until a target energy consumption prediction model reaching preset conditions is achieved. The parameter of this type of energy consumption prediction model is updated.

If the training is completed, the parameter is sent to the vehicle-end off-line model; otherwise, the parameter of the energy consumption prediction model of this type is continuously used. When E_{actual 1}<0.8E_{theoretical}+0.2E_{model}, the energy consumption prediction models of other driving operating conditions and driving styles are re-matched according to E_{actual 1}. Every time the vehicle is driven through 5 km, the type of the energy consumption prediction model is re-matched according to the driving operating conditions and driving styles and the weights in the energy consumption prediction method are adjusted. When the type of the energy consumption prediction model in the previous section is satisfied, the weights ω₁, ω₂ in the energy consumption prediction method in the previous section are used for prediction, and the above weight adjustment method and model parameter updating are carried out.

4. By the automobile theoretical energy consumption prediction algorithm, and according to the driving style, the road traffic flow speed, the static parameters of the vehicle, and the target vehicle speed corresponding to the minimum route-specific vehicle energy consumption, the route-specific vehicle energy consumption corresponding to the preset travel route is predicted.

In some embodiments, the vehicle state information at least includes the static parameters of the vehicle and the target vehicle speed corresponding to the minimum route-specific vehicle energy consumption, the road condition information at least includes the road traffic flow speed, and the user behavior information at least includes the driving style of the user. When the vehicle speed is planned, and a target vehicle speed, that is, an energy-saving vehicle speed, is obtained, the route-specific vehicle energy consumption corresponding to the preset travel route can be predicted by the automobile theoretical energy consumption prediction algorithm according to the driving style, the road traffic flow speed, the static parameters of the vehicle, and the target vehicle speed corresponding to the minimum route-specific vehicle energy consumption. The route-specific vehicle energy consumption calculated in this way is accurate.

In some embodiments, when the intelligent driving function is enabled and the vehicle speed planning is activated, an operation is triggered that predicts the route-specific vehicle energy consumption corresponding to the preset travel route by the automobile theoretical energy consumption prediction algorithm, according to the user behavior information, the road traffic flow speed, the static parameters of the vehicle, and the target vehicle speed corresponding to the minimum vehicle energy consumption. When the intelligent driving function is enabled and the navigation-assisted driving function is enabled, an operation is triggered that predicts the route-specific vehicle energy consumption corresponding to the preset travel route by the automobile theoretical energy consumption prediction algorithm, according to the user behavior information, the road traffic flow speed, the static parameters of the vehicle, and the target vehicle speed corresponding to the minimum vehicle energy consumption. When the intelligent driving function is enabled the navigation-assisted driving function is disabled, the adaptive cruise control function is enabled, there is no preceding vehicle (e.g., no other vehicle ahead of the vehicle), and the energy-saving driving guidance function is enabled, an operation is triggered that predicts the route-specific vehicle energy consumption corresponding to the preset travel route by the automobile theoretical energy consumption prediction algorithm, according to the user behavior information, the road traffic flow speed, the static parameters of the vehicle, and the target vehicle speed corresponding to the minimum vehicle energy consumption.

In some embodiments, when the intelligent driving function is disabled and the energy-saving driving guidance function is enabled, an operation is triggered that predicts the route-specific vehicle energy consumption corresponding to the preset travel route by the automobile theoretical energy consumption prediction algorithm, according to the user behavior information, the road traffic flow speed, the static parameters of the vehicle, and the target vehicle speed corresponding to the minimum vehicle energy consumption.

In some embodiments, the energy-saving driving guidance function refers to the function of controlling and guiding the vehicle to travel at the target speed corresponding to the minimum route-specific vehicle energy consumption corresponding to the route.

For example, the target vehicle speed is determined as follows. A speed sequence is generated according to the road traffic flow speed on the preset travel route and a current vehicle speed of the vehicle by taking the minimum route-specific vehicle energy consumption as an objective function, where the current vehicle speed is the vehicle speed of the vehicle at the start point of the preset travel route. The speed sequence is corrected based on a restriction condition, to obtain a corrected speed sequence, where the restriction condition at least includes the driving style. The corrected speed sequence is the target speed, and the target speed is the optimum energy-saving speed.

In some embodiments, the restriction condition further includes one or more of travel time, traffic flow speed information, acceleration restriction, deceleration restriction, maximum allowable passing speed through an area, and traffic light information.

In some embodiments, the restriction condition includes one or more of travel time, acceleration restriction, deceleration restriction, maximum allowable passing speed through an area, traffic light information, and driving style of the driver.

For example, the traffic light information includes: traffic light countdown and distance to the traffic light, etc. The maximum allowable passing speed through an area is the speed limit of a road section and the passing traffic flow speed. That is, the acceleration restriction, deceleration restriction, and so on, can be determined. The restriction condition may further include: one or more of road slope, vehicle speed of the preceding vehicle, and distance from the preceding vehicle.

In some embodiments, the acceleration restriction and deceleration restriction includes physical acceleration and deceleration constraints caused by the characteristics of the vehicle itself; physical restrictions caused by the road conditions, where the road conditions include pavement types such as asphalt, mud, and sand pavements; and differences in environmental factors such as weather and humidity. In an embodiment, according to the driver's historical driving behavior data, the actual acceleration and deceleration habits during driving at different speeds are taken as restrictions to ensure the driver's driving comfort.

In some embodiments, the speed sequence is corrected based on a restriction condition, to obtain a corrected speed sequence. The corrected speed sequence is the target speed, and the target speed is the optimum energy-saving speed.

In some embodiments, the target vehicle speed is determined as follows. Based on the road traffic flow speed on the preset travel route, the current vehicle speed, and the restriction condition information, a smooth speed sequence is determined, where the restriction condition at least includes the driving style, and the current vehicle speed is the vehicle speed of the vehicle at the start point of the preset travel route. The smooth speed sequence is used as an initial speed solution and inputted into a vehicle model. By taking the minimum route-specific vehicle energy consumption as an objective function, a speed sequence is generated by the vehicle model according to the initial speed solution.

In some embodiments, a vehicle model based on a state space matrix is constructed according to the vehicle dynamics. Because of a nonlinear term in the model, linearization is performed in the vicinity of an operating point to obtain a multi-stage operating model. For example, the selection of the operating point is determined by the operating torque interval. The wheel torque demand can be calculated by a coefficient formula for the bench test of vehicles. The torque range required for the normal traveling of the vehicle is determined. The corresponding torque range is divided by the preset areas, for example, the corresponding torque range is divided by the preset 5 areas.

For example, the control input of the vehicle model is the current acceleration, and the state variables include the vehicle speed, the traffic light information, the distance from the current location to the destination, the speed and acceleration of the preceding vehicle, and the relative distance to the obstacle, that is, the relative distance to the adjacent preceding vehicle. By constraining the control input and the state variables, that is, [x1, x2, . . . , xn]≤[δ1max, −δ1min, . . . , δnmax, −δnmin], where Xn represents an nth state variable mentioned above, and [Δnmax, −δnmin] represents the upper and lower limits of the nth state variable, the fitting of various restrictions in the real environment is realized. The minimum vehicle energy consumption is taken as an objective function, and the objective function is solved by the vehicle model to generate a speed sequence.

In some embodiments, based on the road traffic flow speed on the preset travel route, the current vehicle speed, and the restriction condition information, a smooth speed sequence is determined, and the smooth speed sequence is used as an initial speed solution and inputted into a vehicle model. This process is as follows. Based on the road traffic flow speed on the preset travel route, the current vehicle speed, and the restriction condition information, an average speed is obtained. The speed changes between adjacent road sections are smoothed, to obtain a smooth speed sequence. According to the driving style, the road traffic flow speed, and the location information of traffic lights, the speed on a road section in a different driving scenario is corrected, to partially correct the smooth speed sequence. An initial optimization range of the vehicle model is determined based on the partially corrected smooth speed sequence, and the smooth speed sequence is used as an initial speed solution and inputted into the vehicle model.

In some embodiments, based on the road traffic flow speed on the preset travel route, the current vehicle speed, and the restriction condition information, an average speed is obtained. The speed changes between adjacent road sections are smoothed, to obtain a smooth speed sequence. According to the driving style, the road traffic flow speed, and the location information of traffic lights, the speed on a road section in a different driving scenario is corrected, to partially correct the smooth speed sequence.

For example, the driving style is the same as that in the energy consumption prediction model, and includes aggressive, ordinary, and mild. When the driving style is aggressive, the traffic flow speed on all the road sections is increased. When the driving style is ordinary, the traffic flow speed on all the existing road sections is maintained. When the driving style is mild, the traffic flow speed on all the road sections is decreased. The partial correction according to the location of traffic lights is as follows. At a certain distance to the traffic lights and in combination with the driving style that is aggressive, ordinary, or mild, the speed is increased with an acceleration of A1, A2, or A3, or the speed is decreased with a deceleration of B1, B2, or B3, where A1>A2>A3, and |B1|>|B2|>|B3|.

The speed demands between adjacent road sections are smoothly connected by Bessel function, and an acceleration sequence obeying Poisson distribution is established, to synthesize a speed sequence on a coming route. Then an acceleration sequence is obtained, which is used as the initial solution and substituted into the objective function for solution.

A calculation control input sequence a=[a1, a2, . . . , am] is obtained, where am represents an optimum acceleration value obtained by solving the model in a target time domain. The optimum energy-saving speed is obtained from the initial speed and the optimum acceleration sequence. During the traveling process of the vehicle, an optimum energy-saving speed sequence in the target time domain is obtained by repeatedly substituting into the above process calculation.

In some embodiments, according to the driving style, the road traffic flow speed, and the location information of traffic lights, the speed on a road section in a different driving scenario is corrected, to partially correct the smooth speed sequence. This process is as follows. When the target vehicle speed cannot be maintained due to traveling following other vehicles for a long time, the current acceleration and current vehicle speed of the vehicle, the obstacle speed, and the relative distance to the obstacle are inputted into a vehicle following model, and a partially corrected smooth speed sequence is generated by the vehicle following model by taking the minimum route-specific vehicle energy consumption and the relative distance to the obstacle that is greater than a preset distance threshold as objective functions.

In some embodiments, the speed sequence is determined by the relative change value of acceleration and the minimum vehicle energy consumption in the driving comfort dimension. The current acceleration, the current speed, the traffic light information, the distance from the current location to the destination, the speed of the preceding vehicle, and the relative distance to the obstacle are inputted into the vehicle following model. The minimum road section-specific vehicle energy consumption and a relative change value of acceleration that is less than a preset threshold are taken as objective functions, which are solved by the vehicle following model to obtain the speed sequence.

In some embodiments, according to the driving style, the road traffic flow speed, and the location information of traffic lights, the speed on a road section in a different driving scenario is corrected, to partially correct the smooth speed sequence. This process is as follows. When passing through a traffic light intersection, the current acceleration and current vehicle speed of the vehicle, the traffic light information, the obstacle speed, and the relative distance to the obstacle are inputted into an intersection vehicle speed model. A partially corrected smooth speed sequence is generated by the intersection vehicle speed model by taking the minimum route-specific vehicle energy consumption and the passing time through a traffic light intersection that is less than a preset expected intersection passing time as objective functions.

In some embodiments, the current acceleration and speed of the vehicle, the traffic light information, the obstacle speed, and the relative distance to the obstacle are inputted into an intersection vehicle speed model. The goal of this model is to minimize the road section-specific vehicle energy consumption, and to ensure that the traveling time of the vehicle is lower than a preset expected intersection traveling-through time, whereby a partially corrected smooth speed sequence is generated. This adjustment takes into account the preceding vehicle, pedestrian, and other possible obstacles, to optimize the driving efficiency and reduce the energy consumption of the vehicle.

5. For any candidate travel route, if the route-specific vehicle energy consumption corresponding to any candidate travel route is present in a historical database, the route-specific vehicle energy consumption corresponding to any candidate travel route in the historical database is used as the route-specific vehicle energy consumption of the vehicle corresponding to any candidate travel route. The historical database stores the route-specific vehicle energy consumption corresponding to at least one travel route in a historical time period.

In some embodiments, as shown in FIG. 3, historical road data of the user is collected, and a data-driven road feature sample database is established. For example, the road feature sample database records the historical road information and compares the current road type. If the current road type matches the historical data feature, the corresponding historical route is directly retrieved and outputted. For example, the historical data feature matching includes the road type such as provincial highway the road section where the vehicle resides, and global positioning system (GPS) coordinates, etc. The road feature sample database performs matching analysis on a current alternative route, and determines whether there is an overlapping road section. If present, the historical route is reserved as an alternative route, and the time information, distance information and other information of the historical route are obtained.

For example, if absent, the time information, distance information and other information of the route are calculated and stored in the road feature sample database.

In some embodiments, as shown in FIG. 3, the information of each road section in different routes, the traffic information, and the vehicle information are retrieved. For example, the information of each road section includes information such as road speed limit, road length, and slope of the road section, and the traffic information includes traffic flow speed information. The information is inputted into the energy consumption prediction model to get a feedback corresponding to the future energy consumption prediction. If the route includes a highway, a toll fee corresponding to the route is calculated, converted into the fuel consumption by using the fuel price at that moment, and added to the energy consumption cost. A travel route corresponding to the minimum energy consumption is outputted and shown to the user.

III. A target SOC corresponding to each road section is planed according to the road section-specific vehicle energy consumption corresponding to each road section, to achieve a minimum fuel consumption corresponding to the preset travel route.

In some embodiments, a target SOC corresponding to each road section is planed according to the road section-specific vehicle energy consumption corresponding to each road section, to achieve a minimum fuel consumption corresponding to the preset travel route. This process is as follows. The target SOC corresponding to each road section is planed according to an initial SOC of the power battery and the road section-specific vehicle energy consumption corresponding to each road section, to achieve a minimum fuel consumption corresponding to the preset travel route.

In some embodiments, the target SOC corresponding to each road section can be planed according to the initial SOC of the power battery and the road section-specific vehicle energy consumption corresponding to each road section as follows. According to the initial SOC of the power battery corresponding to each road section and the road section-specific vehicle energy consumption corresponding to each road section, a predicted SOC variation of the vehicle at the end of each road section is determined. According to the predicted SOC variation, multiple SOC varying routes are determined. For example, each SOC varying route includes a group of SOCs. an SOC varying route in the multiple SOC varying routes that enables the vehicle to have the minimum fuel consumption when travels on the preset travel route is determined as a target SOC varying route. The SOCs included in the target SOC varying route is determined as the target SOCs corresponding to various road sections.

In some embodiments, for each road section, the initial SOC of the power battery, that is, the state of charge of the battery at the start of the road section, and the road section-specific vehicle energy consumption, that is, the energy consumption of the vehicle during the driving on the road section, are considered. Through the energy consumption corresponding to each road section, the change in quantity of electricity of the power battery during the driving of the vehicle is predicted. The SOC variation is predicted by calculation, to obtain the change in quantity of electricity of the battery after the vehicle travels through each road section. According to the predicted SOC variations, multiple SOC varying routes are determined, and each SOC varying route represents a possible change in quantity of electricity of the power battery. After multiple SOC varying routes are determined, an SOC varying route that can achieve the minimum fuel consumption when traveling on the preset travel route is selected and used as a target SOC varying route. After the target SOC varying route is determined, the target SOC corresponding to each road section is determined according to the SOC values included in the route.

In some embodiments, the target SOC at the end of the first road section in the preset travel route is determined according to the initial SOC of the vehicle corresponding to the preset travel route and the predicted SOC variation corresponding to the first road section.

The target SOC at the end of a non-first road section in the preset travel route is determined according to the predicted SOC variation corresponding to the non-first road section and the target SOC at the end of the road section previous to the non-first road section.

In some embodiments, the target SOC at the end of the first road section is determined according to the initial SOC of the vehicle corresponding to the preset travel route and the predicted SOC variation corresponding to the first road section. The predicted SOC variation refers to the change in quantity of electricity of the battery after the vehicle travels through the first road section. By combining the initial SOC and the predicted SOC variation, the target SOC at the end of the first road section can be calculated.

The target SOC at the end of a non-first road section is calculated according to the predicted SOC variation corresponding to the road section, that is, the change in quantity of electricity of the battery after the vehicle travels through the road section, in combination with the target SOC at the end of the road section previous to the non-first road section. Because the SOC of the vehicle is of a continuous changing process, when the target SOC corresponding to a current road section is considered, the influence of the previous road section needs to be considered, and the target SOC at the end of the non-first road section can be determined by combining the predicted SOC variation and the target SOC corresponding to the previous road section.

In some embodiments, the predicted SOC variation includes a first predicted SOC variation and a second predicted SOC variation. The upper limit of the target SOC corresponding to the first road section in the preset travel route is determined according to the initial SOC and the first predicted SOC variation corresponding to the first road section. The lower limit of the target SOC corresponding to the first road section is determined according to the initial SOC and the second predicted SOC variation corresponding to the first road section. The upper limit of the target SOC corresponding to the non-first road section in the preset travel route is determined according to the first predicted SOC variation corresponding to the non-first road section and the upper limit of the target SOC corresponding to the road section previous to the non-first road section. The lower limit of the target SOC corresponding to the non-first road section is determined according to the second predicted SOC variation corresponding to the non-first road section and the lower limit of the target SOC corresponding to the road section previous to the non-first road section.

In some embodiments, the SOC corresponding to a target road section in the preset travel route is determined according to a first predicted SOC range corresponding to the target road section and a second predicted SOC range corresponding to the target road section. When the target road section is the first road section in the preset travel route, the first predicted SOC range corresponding to the target road section is determined according to the initial SOC of the vehicle corresponding to the preset travel route and the predicted SOC variation corresponding to the target road section. When the target road section is not the first road section in the preset travel route, the first predicted SOC range corresponding to the target road section is determined according to the upper and lower limit of the target SOC corresponding to the road section previous to the target road section and the predicted SOC variation corresponding to the target road section. When the target road section is the last road section in the preset travel route, the second predicted SOC range corresponding to the target road section is the end SOC of the power battery when the vehicle travels to the end point of the preset travel route. When the target road section is not the last road section in the preset travel route, the second predicted SOC range corresponding to the target road section is determined according to the upper and lower limit of the target SOC corresponding to the road section next to the target road section and the predicted SOC variation corresponding to the road section next to the target road section.

In some embodiments, if the target road section is the first road section in the preset travel route, the first predicted SOC range is determined based on the initial SOC of the vehicle corresponding to the route and the predicted SOC variation corresponding to the road section, ensuring that the current state of the power battery at the start of the travel and the predicted energy consumption corresponding to the road section are combined.

If the target road section is not the first road section in the preset travel route, the first predicted SOC range needs to combine the upper and lower limit of the target SOC corresponding to the previous road section and the predicted SOC variation corresponding to the target road section, ensuring that the influence of the previous road section is considered when the target SOC is calculated.

If the target road section is the last road section in the preset travel route, the second predicted SOC range will be the end SOC of the battery when the vehicle travels to the end point of the route, ensuring that the second predicted SOC range is determined by combining the expected state of charge of the power battery at the end of the travel of the vehicle.

If the target road section is not the last road section in the preset travel route, the second predicted SOC range is determined according to the upper and lower limit of the target SOC corresponding to the road section next to the target road section and the predicted SOC variation corresponding to the road section next to the target road section, ensuring that the expected influence of the next road section is combined when the target SOC is calculated.

In some embodiments, the upper and lower limit of the target SOC corresponding to the target road section are determined by an intersection of the first predicted SOC range corresponding to the target road section and the second predicted SOC range corresponding to the target road section.

In some embodiments, the predicted SOC variation corresponding to the target road section is determined according to the charging and discharging power range corresponding to the target road section. The charging and discharging power range is obtained according to the road section-specific vehicle energy consumption when the vehicle travels on a corresponding road section, the noise, vibration and harshness (NVH) limited power of the engine of the vehicle, and the maximum charging and discharging power of the power battery, and the route-specific vehicle energy consumption is determined according to the road condition information of the corresponding road section.

In some embodiments, for example, the target road section is a highway, and the vehicle energy consumption of the vehicle is 10 kWh per kilometer. On the highway, the NVH limited power is low, because the road surface is relatively flat, and the noise and vibration of the engine are relatively small. The NVH limited power is assumed to be 5 KW, and the maximum charging and discharging power of the power battery of the vehicle is assumed to be 50 kW. Then the charging and discharging power range corresponding to the highway is determined to be from 5 kW to 50 kW.

The highway is usually flat and the traffic is smooth, so the energy consumption corresponding to the highway is predicted to be relatively low. For example, the route-specific vehicle energy consumption is 8 kWh per kilometer. According to the charging and discharging power range and the route-specific vehicle energy consumption, the predicted SOC variation is calculated. Assuming that the SOC variation of the battery after traveling through 1 kilometer on the highway is calculated to be −0.1 (indicating that the SOC of the battery decreases by 0.1 each time traveling through 1 kilometer) by the system through the prediction algorithm. Accordingly, for the target road section that is a highway, the predicted SOC variation is determined to be −0.1, that is, the SOC of the battery decreases by 0.1 each time traveling through 1 kilometer.

In some embodiments, the end SOC is determined according to the initial SOC of the power battery of the vehicle at the start point of the preset travel route.

In some embodiments, the end SOC is determined according to the initial SOC of the power battery of the vehicle at the start point of the preset travel route. That is, the end SOC can be obtained by subtracting the predicted SOC variation from the initial SOC of the battery.

In some embodiments, when the initial SOC is greater than or equal to a first preset threshold, the end SOC is a second preset threshold; and when the initial SOC is less than the first preset threshold, the end SOC is the first preset threshold, where the second preset threshold is greater than the first preset threshold.

In some embodiments, the first preset threshold is 30%, and the second preset threshold is 50%. When the initial SOC is 35%, the end SOC will be set to 50%. If the initial SOC is 25%, the end SOC will be set to 30%.

In some embodiments, the preset travel route of the vehicle is divided into at least one road section.

The target state of charge (SOC) after the vehicle travel through each road section is determined.

According to the actual SOC and target SOC of the power battery of the vehicle, the engine and the motors of the vehicle are controlled.

For example, one road section can correspond to one target SOC. Based on this, the target SOC is the SOC of the battery expected to reach after the vehicle travels through one road section. When the vehicle travels, the remaining quantity of electricity in the battery can be controlled by switching the driving mode according to the target SOC. One road section may correspond to at least two target SOCs. Based on this, one road section can be divided into multiple intervals, and one interval corresponds to one target SOC. When the vehicle travels in one interval, the remaining quantity of electricity in the battery can be controlled by switching the driving mode according to the target SOC corresponding to the interval.

In some embodiments, the SOC corresponding to a target road section in the preset travel route is determined according to a first predicted SOC range corresponding to the target road section and a second predicted SOC range corresponding to the target road section.

When the target road section is the first road section in the preset travel route, the first predicted SOC range corresponding to the target road section is determined according to the initial SOC of the vehicle corresponding to the preset travel route and the predicted SOC variation corresponding to the target road section.

When the target road section is not the first road section in the preset travel route, the first predicted SOC range corresponding to the target road section is determined according to the upper and lower limit of the target SOC corresponding to the road section previous to the target road section and the predicted SOC variation corresponding to the target road section.

When the target road section is the last road section in the preset travel route, the second predicted SOC range corresponding to the target road section is the end SOC of the power battery when the vehicle travels to the end point of the preset travel route.

When the target road section is not the last road section in the preset travel route, the second predicted SOC range corresponding to the target road section is determined according to the upper and lower limit of the target SOC corresponding to the road section next to the target road section and the predicted SOC variation corresponding to the road section next to the target road section.

In some embodiments, the upper and lower limit of the target SOC corresponding to the target road section are determined by an intersection of the first predicted SOC range corresponding to the target road section and the second predicted SOC range corresponding to the target road section.

In some embodiments, the target road section included in the preset travel route includes at least one sub-road section, and each sub-road section correspond to sub-road condition information respectively. The target road section is determined based on the sub-road condition information of at least one sub-road section included.

For example, the target road section can be any one of the road sections in the preset travel route. For example, each road section of the preset travel route includes at least one sub-road section, and each sub-road section corresponds to sub-road condition information respectively. For example, the sub-road condition information is used to describe the road condition of the corresponding sub-road section. In some embodiments of the present disclosure, each road section is determined based on the sub-road condition information of at least one sub-road section included in the road section.

For example, after the preset travel route is determined, the sub-road section belonging to the preset travel route and the sub-road condition information corresponding to each sub-road section can be acquired from the map.

Then, according to the sub-road condition information of each sub-road section, several adjacent sub-road sections are selected and joined, to get a road section.

For example, it is assumed that the preset travel route outputted by the map includes sub-road section 1, sub-road section 2, sub-road section 3, sub-road section 4, sub-road section 5, sub-road section 6, sub-road section 7, sub-road section 8, sub-road section 9, and sub-road section 10.

According to the sub-road condition information of each sub-road section, sub-road section 1 is determined as road section 1, the adjacent sub-road section 2 and sub-road section 3 are joined to form road section 2, the adjacent sub-road section 4, sub-road section 5, and sub-road section 6 are joined to form road section 3, and the adjacent sub-road section 7, sub-road section 8, sub-road section 9, and sub-road section 10 are joined to form road section 4. In this way, the preset travel route is divided into four road sections. Because each sub-road section has its own road conditions, the preset travel route can be divided into at least one road section based on the road conditions of each sub-road section, so that each road section also has its own road conditions.

It is to be understood that because the number of sub-road sections outputted by the map is often large, the direct use of sub-road sections as divided road sections in the preset travel route will lead to too much computational complexity for the subsequent calculation of mode switching condition information (such as the target SOC), causing the failure to meet the real-time requirement. In some embodiments of the present disclosure, each sub-road section is combined according to the road conditions, which reduces the number of divided road sections, and reduce the computational complexity for the calculation of mode switching condition information (such as target SOC).

In some embodiments, the sub-road condition information includes: at least one of road type, road name, road traffic sign, road speed limit, congestion level, road length, required traveling time, average vehicle speed, slope, traffic light information, and weather information.

For example, the road type includes ordinary road, expressway, highway, and congested road. The congestion level can include high, medium, and low, which is used to reflect different road congestion degrees. The required traveling time is the time required for vehicles to travel from a start point of a sub-road section to an end point of the sub-road section, which can be obtained by big data analysis based on historical data of multiple vehicles traveling on the sub-road section. The average vehicle speed is the average speed of the vehicle traveling on the sub-road section, for example, the average vehicle speed of a vehicle traveling on the sub-road section on which the vehicle control method is performed, or the average vehicle speed of multiple vehicles traveling on the sub-road section.

For example, if the average vehicle speed of vehicle 1 traveling on the sub-road section is 10 m/s, the average vehicle speed of vehicle 2 traveling on the sub-road section is 11 m/s, and the average vehicle speed of vehicle 3 traveling on the sub-road section is 9 m/s, then the average vehicle speed on the sub-road section can be determined to be (10+11+9)/3=10 m/s based on the average vehicle speeds of vehicles 1, 2 and 3.

In some embodiments, the sub-road condition information and the target road section meet at least one of the following conditions: the sub-road condition information includes the road type, and all the sub-road sections included in the target road section have the same road type; or the sub-road condition information includes the average vehicle speed, and the average vehicle speeds on all the sub-road sections included in the target road section fall within the same vehicle speed range.

For example, all the sub-road sections included in the target road section having the same road type means that if one road section includes two sub-road sections, the road types of the two sub-road sections are the same type. The average vehicle speeds on all the sub-road sections included in the target road section falling within the same vehicle speed range means that if one road section includes at least two sub-road sections, the average vehicle speeds on the two sub-road sections fall within the same vehicle speed range.

It can be understood that the two constraint conditions that all the sub-road sections included in the target road section have the same road type and the average vehicle speeds on all the sub-road sections included in the target road section falls within the same vehicle speed range can exist alone or at the same time.

In some embodiments, one road section can be determined as follows. At least two adjacent sub-road sections having the same road type are combined and used as a pre-divided road section. If the average vehicle speed on a sub-road section adjacent to the pre-divided road section and the average vehicle speed on the sub-road sections in the pre-divided road section fall within the same vehicle speed range, the pre-divided road section and the adjacent sub-road section are combined and used as one road section in the preset travel route.

In some embodiments of the present disclosure, the preset travel route can be divided into at least one road section by the vehicle or a server, and the vehicle acquires the division result.

In the process of road section division, for example, any road section can be determined as follows. At least two adjacent sub-road sections having the same road type are joined into one pre-divided road section. If the average vehicle speed on one or more sub-road sections adjacent to the pre-divided road section and the average vehicle speed on the sub-road sections in the pre-divided road section fall within the same vehicle speed range, the adjacent one or more sub-road sections are joined to the pre-divided road section, to obtain one road section in the preset travel route.

For example, the preset travel route includes sub-road section 1, sub-road section 2, sub-road section 3, sub-road section 4, and sub-road section 5. For example, sub-road sections 1, 2, and 3 have the same road type, sub-road section 4 and sub-road section 5 have the same road type, and the road types of sub-road section 3 and sub-road section 4 are different.

Based on the road section determining method, sub-road section 1, 2, and 3 are joined into one pre-divided road section 1, the sub-road sections 4 and 5 are joined into another pre-divided road section 2. Assuming that the average vehicle speeds on sub-road sections 1, 2, and 3 and sub-road section 4 both fall within the vehicle speed range 10 m/s-15 m/s, sub-road sections 1, 2, 3, and 4 are joined into one road section, and sub-road section 5 is used as another road section.

In some embodiments, the sub-road condition information includes the road length of the sub-road section. After determining the road section based on the sub-road condition information of each sub-road section, the road length of each road section needs to be greater than or equal to a preset length threshold. By restricting the road length of each road section, the number of divided road sections can be ensured not to be too large, to reduce the computational complexity.

For example, when the road length of one sub-road section is greater than or equal to the length threshold, the one sub-road section is determined as one road section. When the road length of one sub-road section is less than the length threshold, the one sub-road section is combined with a sub-road section adjacent to the one sub-road section into one road section.

For example, if the length threshold is 1 km and the length of a certain sub-road section is 1.5 km, the sub-road section can be regarded as one road section alone. If the length of a certain sub-road section is 0.8 km, the sub-road section and an adjacent sub-road section are joined to form one road section, so that the length of the joined road section is greater than or equal to 1 km. If the road length after one adjacent sub-road section is joined is still less than 1 km, multiple adjacent sub-road sections can be joined.

In some embodiments, the target road section in the preset travel route is obtained based on a road interval having road characteristic parameters that are successfully matched with road condition data of a preset road condition, where the road interval is obtained from the preset travel route according to the road condition data of the preset travel route, and the road characteristic parameters of the road interval are determined according to historical driving parameters of vehicles on the road section.

After the user determines the preset travel route based on the map on a terminal display screen, the road condition data of the preset travel route, for example, speed limit, slope and other signal data, can be automatically retrieved according to the preset travel route, and then the sub-road condition information is statistically analyzed, and the preset travel route is divided into several road intervals according to the sub-road condition information. Then historical driving parameters such as speed and acceleration when historical vehicles travel through the road interval are obtained based on big data analysis. Then the corresponding road characteristic parameters such as average vehicle speed, average acceleration, standard deviation of the vehicle speed, and standard deviation of the acceleration can be calculated according to fundamental calculation formulas with the vehicle speed and acceleration retrieved from big data.

By the comparison and identification of the calculated road characteristic parameters corresponding to the vehicle and the pre-stored road condition data corresponding to the preset road condition, the road condition data of the preset road condition matched with the road characteristic parameters of the road interval is determined, and identified as the preset road condition corresponding to the road condition data. The preset travel route of the vehicle is divided into several road sections according to the road condition data.

It is to be understood that the road sections determined according to the preset travel routes can be obtained based on road planning. For example, assuming that the obtained road condition data corresponding to the preset travel route includes speed limit data of 60 Km/h and speed limit data of 80 Km/h, the preset travel route can be divided into road interval a corresponding to the speed limit data of 60 Km/h and road interval b corresponding to the speed limit data of 80 Km/h.

For example, the road characteristic parameters include: average vehicle speed, average acceleration, standard deviation of the vehicle speed, and standard deviation of the acceleration. Historical driving parameters such as vehicle speed and acceleration when historical vehicles travel through road interval a are obtained based on big data analysis. The average vehicle speed, average acceleration, standard deviation of the vehicle speed, and standard deviation of the acceleration when the vehicle travels through road interval a are calculated by an average value calculation formula and a standard deviation calculation formula, and compared with pre-stored road condition data corresponding to the preset road condition. When the calculated road characteristic parameters are within the road condition data range of the preset road conditions, the road interval is determined as one road section. Similarly, the road section corresponding to road interval b can be obtained.

In some embodiments, the target road section in the preset travel route is outputted by a neural network model trained in advance, where the input of the neural network model includes the road condition data of the preset travel route.

For example, the neural network model can be trained in advance, so that the neural network model can output at least one road section in the preset travel route after the road condition data of the preset travel route is inputted, to form a road section sequence.

In some embodiments, the road condition information of the target road section is obtained according to the sub-road condition information of the sub-road section included in the target road section.

For example, road section A includes three sub-road sections, that is, sub-road section 1, sub-road section 2, and sub-road section 3. Therefore, the road condition information of road section A is determined by the sub-road condition information of sub-road section 1, the sub-road condition information of sub-road section 2, and the sub-road condition information of sub-road section 3.

In some embodiments, the target SOC corresponding to the target road section in the preset travel route is determined as follows. According to the target SOC corresponding to the road section previous to the target road section and the road condition information of the target road section, the target SOC corresponding to the target road section is determined. In an embodiment, according to the target SOC corresponding to the road section next to the target road section and the road condition information of the road section next to the target road section, the target SOC corresponding to the target road section is determined.

For example, assuming that the target road section is the 3rd road section, the target SOC corresponding to the 3rd road section can be determined according to the target SOC corresponding to the 2nd road section and the road condition information of the 3rd road section. In an embodiment, the target SOC corresponding to the 3rd road section can be determined according to the target SOC corresponding to the 4th road section and the road condition information of the 4th road section.

In some embodiments, the determination of the target SOC corresponding to the target road section according to the target SOC corresponding to the road section previous to the target road section and the road condition information of the target road section includes the following steps. According to the road condition information of the target road section, an SOC variation after the vehicle travels through the target road section is determined. According to the target SOC corresponding to the road section previous to the target road section and the SOC variation corresponding to the target road section, the target SOC corresponding to the target road section is determined.

For example, assuming that the target road section is the 3rd road section, an SOC variation after the vehicle travels through the 3rd road section can be determined according to the road condition information of the 3rd road section; and the target SOC corresponding to the 3rd road section can be determined according to the target SOC corresponding to the 2nd road section and the SOC variation corresponding to the 3rd road section.

In some embodiments, the determination of the target SOC corresponding to the target road section according to the target SOC corresponding to the road section next to the target road section and the road condition information of the road section next to the target road section includes the following steps. According to the road condition information of the road section next to the target road section, an SOC variation after the vehicle travels through the road section next to the target road section is determined. According to the target SOC corresponding to the road section next to the target road section and the SOC variation corresponding to the road section next to the target road section, the target SOC corresponding to the target road section is determined.

For example, assuming that the target road section is the 3rd road section, an SOC variation after the vehicle travels through the 4th road section can be determined according to the road condition information of the 4th road section. According to the target SOC corresponding to the 4th road section and the SOC variation corresponding to the 4th road section, the target SOC corresponding to the 3rd road section can be determined.

In some embodiments, the target SOC is determined as follows. The initial SOC of the power battery of the vehicle corresponding to the preset travel route is acquired. According to the initial SOC and the road condition information of each road section, the target SOC corresponding to each road section is determined.

In some embodiments of the present disclosure, when the vehicle is at the start point of the preset travel route, the actual SOC of the power battery is the initial SOC. Referring to FIG. 7, FIG. 7 schematically shows a division of road sections according to some embodiments of the present disclosure. As shown in FIG. 7, the preset travel route includes road section 1, road section 2, road section 3, and road section 4. The start point of the preset travel route is the start point A of road section 1. That is, when the vehicle travels to point A, the actual SOC of the power battery is the initial SOC corresponding to the preset travel route. The road condition information is used to reflect the road condition of a corresponding road section. Based on the initial SOC and the road condition information of each road section, the target SOC corresponding to each road section can be determined. When the vehicle travels on a certain road section, the vehicle uses the target SOC corresponding to the road section as a target usable amount of electricity in the power battery, so that after the vehicle travels through the road section, the remaining amount of electricity in the power battery is close to the target SOC. As such, the energy consumption of the vehicle can be effectively reduced by managing the amount of electricity in the power battery of the vehicle through the road conditions of each road section.

In some embodiments, both the sub-road condition information and the road condition information include the road type; and the road type of the target road section is the target road type in the road types of various sub-road sections included in the target road section. For example, the sub-road section corresponding to the target road type accounts for the highest proportion in all sub-road sections included in the target road section.

For example, for a certain road section, such as road section A, the road types of various sub-road sections included in road section A are counted. There are 3 sub-road sections of road type 1, and 1 sub-road section of road type 2. The road type of the sub-road section with the highest proportion is determined as the target road type, and the target road type is the road type of road section A.

In some embodiments, the sub-road condition information and the road condition information both include the average vehicle speed and the road length, and the average vehicle speed on the target road section is calculated based on the average vehicle speed on and the road length of each sub-road section in the target road section, where the road length of the target road section is the sum of the road lengths of various sub-road sections in the target road section.

For example, for a certain road section, such as road section A, the road lengths of various sub-road sections included in road section A are added to get the road length of road section A. For a certain sub-road section, the road length of the sub-road section is divided by the average vehicle speed on the sub-road section to obtain the required traveling time through the sub-road section. The required traveling time through various sub-road sections included in road section A is added, to obtain the required traveling time through road section A. The road length of road section A is divided by the required traveling time through road section A, to obtain the average vehicle speed on road section A.

In some embodiments, the determination of the target SOC corresponding to each road section according to the initial SOC and the road condition information corresponding to each road section includes the following steps. The route-specific vehicle energy consumption corresponding to the preset travel route is predicted according to the road condition information of the preset travel route and the energy consumption affecting information. The target SOC of the power battery corresponding to each road section is determined according to the initial SOC of the power battery and the road section-specific vehicle energy consumption corresponding to each road section, to achieve the minimum fuel consumption corresponding to the preset travel route.

In some embodiments, for example, the preset travel route include a highway between cities, an urban road, and a short rural road. The initial SOC of the power battery is 60%.

The route-specific vehicle energy consumption corresponding to the highway section is predicted to be 480 kWh according to the road condition information of the preset travel route and the energy consumption affecting information in combination. The route-specific vehicle energy consumption corresponding to the urban road section is 240 kWh. The route-specific vehicle energy consumption corresponding to the rural road section is 180 kWh. The target SOC of the power battery corresponding to each road section is determined according to the initial SOC of the power battery and the road section-specific vehicle energy consumption corresponding to each road section, to achieve the minimum fuel consumption corresponding to the preset travel route.

For example, for the expressway section, to achieve the minimum fuel consumption, the energy consumption is reduced as much as possible. For example, the goal is set to manage to keep SOC at 50% or higher, to cope with possible emergencies. The energy consumption corresponding to urban road is high, and the speed is slow. SOC can be improved by recovering the braking energy, and the goal can be set to keep SOC at 60% or higher. For the rural road section, the energy consumption corresponding to rural road is low, but the road conditions may be complex, which requires a certain SOC reserve. For example, the goal is set to keep SOC at 55% or higher.

In some embodiments, the determination of the target SOC corresponding to each road section according to the road condition information of each road section and the end SOC includes the following steps. According to the road condition information of each road section, an SOC variation after the vehicle travels through each road section is determined. According to the end SOC and the SOC variation corresponding to each road section, the target SOC corresponding to each road section is determined.

In some embodiments of the present disclosure, because the road condition information can reflect the road condition of a road section, the SOC variation of the vehicle after traveling through the road section that is, the SOC variation of the power battery when the vehicle travels from the start point to the end point of the road section, can be predicted according to the road condition information of the road section. When the end SOC is determined, the target SOC corresponding to each road section can be determined according to the end SOC and the SOC variation corresponding to each road section.

In some embodiments, assuming that the preset travel route includes k road sections, where k is a positive integer, the end SOC is the target SOC corresponding to the kth road section; and the target SOC corresponding to an (i−1)^{th} road section is calculated according to the target SOC corresponding to an i^{th} road section and the SOC variation corresponding to the i^{th} road section, wherein i=2, 3, 4, . . . , k.

For example, assuming k=5. Since the end SOC has been determined according to the initial SOC, the end SOC can be directly used as the target SOC of the 5th road section. After the target SOC corresponding to the 5th road section is determined, the target SOC corresponding to the 4th road section is calculated according to the target SOC corresponding to the 5th road section and the SOC variation corresponding to the 5th road section. Then, according to the target SOC corresponding to the 4th road section and the SOC variation corresponding to the 4th road section, the target SOC corresponding to 3rd road section is calculated. Similarly, the target SOC corresponding to the 3rd road section, the 2nd road section, and the 1st road section are calculated.

For example, if the target SOC corresponding to the 4th road section is 40% and the SOC variation corresponding to the 4th road section is 5%, the target SOC corresponding to the 3rd road section=the target SOC corresponding to the 4th road section−the SOC variation corresponding to the 4th road section=40%−5%=35%.

In some embodiments, the road condition information includes the road type, the congestion level, and the road length. The SOC variation corresponding to the target road section in the preset travel route is determined according to the power consumption per unit length and the road length of the target road section, where the power consumption per unit length of the target road section is determined according to the road type and the congestion level of the target road section.

For example, the power consumption per unit length may be historical data of the vehicle. For example, the vehicle used to travel on road section B, and the actual power consumption per unit length during the traveling process is a. If the road type of road section A in the preset travel route is the same as that of road section B, and the congestion level of road section A is also the same as that of road section B, then the power consumption per unit length of road section A is determined to be a. By multiplying the power consumption per unit length with the road length of the road section, the SOC variation corresponding to the road section can be obtained.

In some embodiments, the power consumption per unit length of the target road section is obtained by querying a preset table according to the road type and the congestion level of the target road section.

For example, the preset table stores the correspondence relationship between the road type and congestion level and the power consumption per unit length. According to the correspondence relationship, the corresponding power consumption per unit length can be queried according to the road type and congestion level of the road section.

In some embodiments, after the vehicle travels through a preset road length of road, the to-be-updated power consumption per unit length in the preset table is updated according to the actual power consumption per unit length of the vehicle on the preset road length of road.

For example, the actual power consumption of the vehicle corresponding to the preset road length of road can be obtained every time the vehicle travels through the preset road length of road. According to the actual power consumption and the preset road length, the actual power consumption per unit length is obtained. The to-be-updated power consumption per unit length in the preset table is updated according to the actual power consumption per unit length.

For example, the preset road length is 1 km. The actual power consumption of the vehicle on 1 km of the road can be obtained every time the vehicle travels through 1 km of the road, so as to obtain the actual power consumption per unit length. For example, in the preset table, the power consumption per unit length corresponding to the road type and congestion level of the 1 km of road is the to-be-updated power consumption per unit length. In some embodiments of the present disclosure, the to-be-updated power consumption per unit length in the preset table is updated according to the actual power consumption per unit length.

In some embodiments, the to-be-updated power consumption per unit length in the preset table is updated to the actual power consumption per unit length.

Assuming that the to-be-updated power consumption per unit length in the preset table corresponds to road type 1 and congestion level 1, the power consumption per unit length corresponding to road type 1 and congestion level 1 in the preset table is the actual power consumption per unit length after updating.

In some embodiments, the to-be-updated power consumption per unit length in the preset table is updated to a target power consumption per unit length, where the target power consumption per unit length is calculated according to the to-be-updated power consumption per unit length, a first weight corresponding to the to-be-updated power consumption per unit length, the actual power consumption per unit length, and a second weight corresponding to the actual power consumption per unit length.

For example, the sum of the first weight and the second weight is equal to 1. The to-be-updated power consumption per unit length is multiplied by the first weight, to obtain a first product; and the actual power consumption per unit length is multiplied by the second weight, to obtain a second product. The sum of the first product and the second product is taken as the power consumption per unit length. Assuming that the to-be-updated power consumption per unit length in the preset table corresponds to road type 1 and congestion level 1, the power consumption per unit length corresponding to road type 1 and congestion level 1 in the preset table is the target power consumption per unit length after updating.

In some embodiments, the road condition information includes the road type, the congestion level, and the required traveling time. The SOC variation corresponding to the target road section in the preset travel route is determined according to the SOC change rate corresponding to the target road section and the required traveling time, where the SOC change rate corresponding to the target road section is determined according to the road type and the congestion level of the target road section.

For example, the SOC change rate may be historical data of the vehicle. For example, the vehicle used to travel on road section B, and the actual SOC change rate during the traveling process is a. If the road type of road section A in the preset travel route is the same as that of road section B, and the congestion level of road section A is also the same as that of road section B, then the SOC change rate corresponding to road section A is determined to be a. By multiplying the SOC change rate with the required traveling time through the road section, the SOC variation corresponding to the road section can be obtained.

In some embodiments, the determination of the target SOC corresponding to each road section according to the initial SOC and the road condition information corresponding to each road section includes the following steps. According to the initial SOC and the road condition information of each road section, the target SOC of the vehicle at the end of each road section is determined; and according to the target SOC of the vehicle at the end of each road section is determined, the target SOC corresponding to each road section is determined.

In some embodiments of the present disclosure, the road condition information can reflect the road condition of a road section; and according to the initial SOC and the road condition information of each road section, the target SOC of the vehicle traveling to the end of each road section can be determined. That is, when the vehicle travels to the end point of each road section, the actual SOC of the power battery is within a range, which is determined by the initial SOC and the road condition in combination. After the target SOC at the end of each road section is determined, one SOC can be determined from the target SOC at the end of reach road section and used as the target SOC corresponding to the road section.

In some embodiments, multiple SOC varying routes are determined according to the target SOCs. For example, each SOC varying route includes a group of SOCs. an SOC varying route in the multiple SOC varying routes that enables the vehicle to have the minimum energy consumption when travels on the preset travel route is determined as a target SOC varying route. The SOCs included in the target SOC varying route are determined as the target SOCs corresponding to various road sections.

For example, there are 5 road sections, and one SOC is randomly selected from the target SOC corresponding to each road section, so a group of SOCs can be obtained. That is, the group of SOCs include 5 SOCs. The group of SOC forms a SOC varying route. After multiple SOC varying route are determined from the target SOCs, a target SOC varying route can be determined therefrom, where the target SOC varying route enables the vehicle to have the minimum energy consumption when travels on the preset travel route.

For example, the SOC varying route in the multiple SOC varying routes that enables the vehicle to have the minimum energy consumption when travels on the preset travel route can be determined by a simulation model.

In some embodiments, the target SOC at the end of the first road section in the preset travel route is determined according to the initial SOC and the road condition information of the first road section. The target SOC at the end of a non-first road section in the preset travel route is determined according to the road condition information of the non-first road section and the target SOC at the end of a road section previous to the non-first road section.

For example, according to the initial SOC and the road condition information of the first road section in the preset travel route, the target SOC of the vehicle at the end of the first road section is determined; and for each road section other than the first road section in the preset travel route, the target SOC of the vehicle at the end of the road section is determined according to the road condition information of the road section and the target SOC at the end of a road section previous to the road section.

That is, according to second operating condition data of the vehicle on the first road section, the battery consumption when the vehicle travels through this road section is calculated; and based on the initial SOC of the battery of the vehicle corresponding to the first road section, the SOC of the battery of the vehicle at the end of the first road section is predicted. Accordingly, the range of SOC change of the battery corresponding to the first road section is determined. The initial SOC of the battery corresponding to the second road section is determined according to the range of SOC change of the battery corresponding to the first road section. Based on the initial SOC of the battery corresponding to the second road section and the predicted battery consumption corresponding to the second road section, the SOC of the battery of the vehicle at the end of the second road section is calculated. Accordingly, the range of SOC change of the battery corresponding to the second road section is determined. Similarly, the initial SOC of the battery corresponding to the third road section is determined according to the range of SOC change of the battery corresponding to the second road section. In this manner, the target SOC of the battery corresponding to each road section in the preset travel route is determined.

In some embodiments, the upper and lower limit of the target SOC corresponding to the first road section are determined according to the initial SOC and the road condition information of the first road section. The upper limit of the target SOC corresponding to the non-first road section is determined according to the road condition information of the non-first road section and the upper limit of the target SOC corresponding to the road section previous to the non-first road section. The lower limit of the target SOC corresponding to the non-first road section is determined according to the road condition information of the non-first road section and the lower limit of the target SOC corresponding to the road section previous to the non-first road section.

For example, according to the initial SOC and the road condition information of the first road section, a first SOC is determined, where the first SOC is the SOC of the battery when the vehicle travels in the hybrid mode to the end of the first road section. According to the initial SOC and the road condition information of the first road section, a second SOC is determined, where the second SOC is the SOC of the battery when the vehicle travels in the pure-electric mode to the end of the first road section. The first SOC is taken as the upper limit and the second SOC is taken as the lower limit, to obtain the target SOC of the vehicle at the end of the first road section.

According to the road condition information of the road section and the upper limit of the target SOC corresponding to the previous road section, a third SOC is determined, where the third SOC is the SOC of the battery when the vehicle travels in the hybrid mode to the end of the road section. According to the road condition information of the road section and the lower limit of the target SOC corresponding to the previous road section, a fourth SOC is determined, where the fourth SOC is the SOC of the battery when the vehicle travels in the pure-electric mode to the end of the road section. The third SOC is taken as the upper limit and the fourth SOC is taken as the lower limit, to obtain the target SOC of the vehicle at the end of the road section.

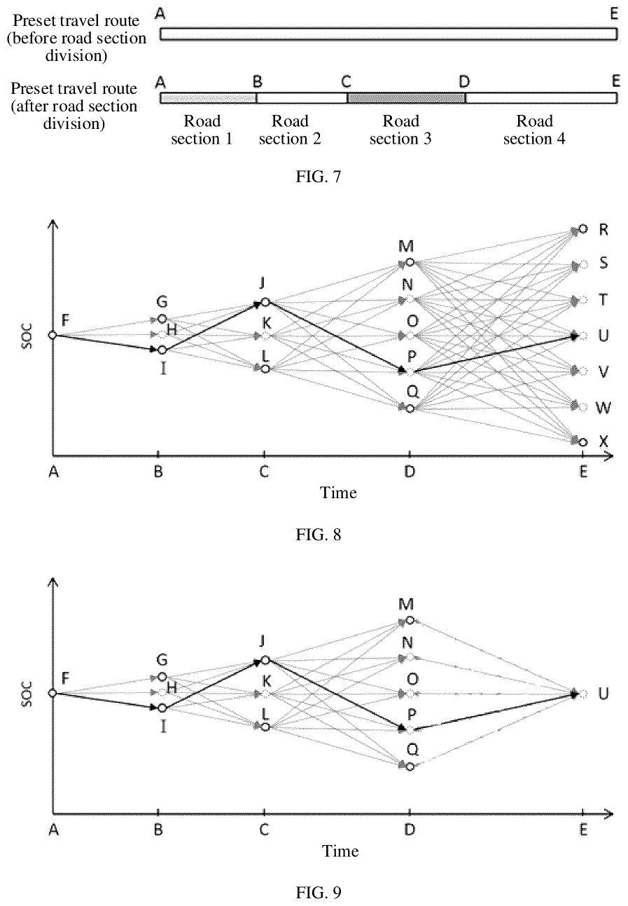

Referring to FIG. 8, FIG. 8 schematically shows an SOC prediction according to some embodiments of the present disclosure. For example, for the road sections divided in FIG. 8, the first road section is road section 1 corresponding to AB section.

As shown in FIG. 8, the initial SOC of the vehicle at point A is F. If the vehicle travels in the hybrid mode, that is, the vehicle is powered exclusively by fuel when travels on road section 1 from point A to point B and the battery is in a charging state, the first SOC at point B is determined to be G, that is, the upper limit of the SOC of the battery corresponding to road section 1 is G. If the vehicle travels in the pure electric mode, that is, the vehicle is powered exclusively by electricity when travels on road section 1 from point A to point B and the battery in a discharging state, the second SOC at point B is determined to be I, that is, the lower limit of the SOC of the battery corresponding to road section 1 is I. Accordingly, the range of SOC change of the battery corresponding to road section 1 is determined to be [I,G]. Assuming that of the actual SOC F of the battery corresponding to road section 1 is 70%, the upper limit G of the SOC of the battery at point B is 75%, and the lower limit I of the SOC of the battery is 65%, the target SOC of the battery corresponding to road section 1 is [65%, 75%].

Then, according to the second operating condition data corresponding to road section 2 and the target SOC of battery corresponding to the road section previous to road section 2, that is, road section 1, the target SOC of the battery after the vehicle travels through road section 2 is determined.

The upper limit G of the SOC of the battery corresponding to road section 1 is taken as the initial SOC of the battery corresponding to road section 2. If the vehicle travels in the hybrid mode, that is, the vehicle is powered exclusively by fuel when travels on road section 2 and the battery is in a charging state, the third SOC at point C is determined to be J, that is, the upper limit of the SOC of the battery corresponding to road section 2 is J.

Then, the lower limit I of the SOC of the battery corresponding to road section 1 is taken as the initial SOC of the battery corresponding to road section 2. If the vehicle travels in the pure electric mode, that is, the vehicle is powered exclusively by electricity when travels on road section 2 from point B to point C and the battery in a discharging state, the fourth SOC at point C is determined to be L, that is, the lower limit of the SOC of the battery corresponding to road section 2 is L. Therefore, the target SOC of the battery corresponding to road section 2 is determined as [L, J].

In some embodiments, the determination of the target SOC corresponding to each road section according to the initial SOC and the road condition information corresponding to each road section includes the following steps. The end SOC of the power battery when the vehicle travels to the end point of the preset travel route is determined according to the initial SOC. According to the initial SOC, the end SOC, and the road condition information of the preset travel route, the target SOC of the vehicle at the end of each road section in the preset travel route is determined. According to the target SOC, the target SOC corresponding to each road section in the preset travel route is determined.

Considering the battery characteristics, when the vehicle travels to the end point of the preset travel route, the remaining amount of electricity in the power battery needs to be kept within a certain range, such as 17%-25%.

Based on this, the end SOC of the power battery when the vehicle travels to the end point of the preset travel route can be determined according to the initial SOC. After the initial SOC and the end SOC are determined, the target SOC corresponding to each road section can be determined according to the initial SOC, the end SOC, and the road condition information corresponding to each road section.

In some embodiments, the target SOC corresponding to a target road section in the preset travel route is determined according to a first target SOC and a second target SOC corresponding to the target road section. When the target road section is the first road section in the preset travel route, the first target SOC corresponding to the target road section is determined according to the initial SOC and the road condition information of the target road section. When the target road section is not the first road section in the preset travel route, the first target SOC corresponding to the target road section is determined according to the first target SOC corresponding to a road section previous to the target road section and the road condition information of the target road section. When the target road section is the last road section in the preset travel route, the second target SOC of the target road section is determined according to the end SOC and the road condition information of the target road section. When the target road section is not the last road section in the preset travel route, the second target SOC of the target road section is determined according to the second target SOC of a road section next to the target road section and the road condition information of the target road section.

In some embodiments of the present disclosure, according to the initial SOC and the road condition information of each road section, the first target SOC of the vehicle at the end of each road section is determined; according to the end SOC and the road condition information of each road section, the second target SOC of the vehicle at the start of each road section is determined; according to the first target SOC and the second target SOC, the target SOC is determined.

The road condition information can reflect the road condition of a road section; and according to the initial SOC and the road condition information of each road section, the first target SOC of the vehicle traveling to the end of each road section can be determined. That is, when the vehicle travels to the end point of each road section, the actual SOC of the power battery is within a range, which is determined by the initial SOC and the road condition in combination. According to the end SOC and the road condition information of each road section, the second target SOC of the vehicle traveling to the start of each road section can be determined. That is, when the vehicle travels to the start point of each road section, the actual SOC of the power battery is within a range, which is determined by the end SOC and the road condition in combination.

It is to be understood that since the adjacent road sections are connected end to end, the end of a certain road section is the start of a road section next to the road section. After the first target SOC at the end of each road section and the second target SOC at the start of each road section are determined, the target SOC at the end of each road section is determined according to the first target SOC and the second target SOC. Finally, one SOC can be determined from the target SOC at the end of reach road section and used as the target SOC corresponding to the road section. For example, the first target SOC at the end of the last road section in the preset travel route can be the end SOC corresponding to the preset travel route, and the second target SOC at the start of the first road section in the preset travel route can be the initial SOC corresponding to the preset travel route.

In some embodiments, the target SOC is an intersection of the first target SOC and the second target SOC. For example, for any road section other than the last road section in the preset travel route, the first target SOC at the end of the road section can be intersected with the target SOC at the start of a road section next to the road section, to obtain the target SOC at the end of each road section. For example, the target SOC at the end of the last road section is the end SOC corresponding to the preset travel route. Referring to FIG. 9, FIG. 9 schematically shows another SOC prediction according to some embodiments of the present disclosure. FIG. 9 shows the finally obtained target SOC. For example, the initial SOC corresponding to the preset travel route is F, and the end SOC corresponding to the preset travel route is U. For example, the first road section in FIG. 8 is road section 1 corresponding to AB section, and the second road section is road section 2 corresponding to BC section. Assuming that the first target SOC at the end of road section 1 is [65%, 75%], the second target SOC at the start of road section 2 is [60%, 70%], the range of variation at the end of road section 1 is [65%, 70%] after intersection.

In some embodiments, the first target SOC corresponding to the target road section is determined according to the charging and discharging power range corresponding to the target road section, the road condition information of the target road section, and the initial SOC. The second target SOC corresponding to the target road section is determined according to the charging and discharging power range corresponding to the target road section, the road condition information of the target road section, and the end SOC. The charging and discharging power range corresponding to the target road section is obtained according to the road section-specific vehicle energy consumption when the vehicle travels on the target road section, the noise, vibration and harshness (NVH) limited power of the engine of the vehicle, and the maximum charging and discharging power of the power battery, and the road section-specific vehicle energy consumption corresponding to the target road section is determined according to the road condition information of the target road section.

The road section-specific vehicle energy consumption after the vehicle travels through a road section is determined according to the road condition information of the road section. According to the road condition information, the initial SOC, the road section-specific vehicle energy consumption, the NVH limited power of the engine of the vehicle, and the maximum charging and discharging power of the power battery, the first target SOC of the vehicle at the end of the road section is determined. For example, the NVH limited power is a power threshold obtained by limiting the power of the engine considering that the NVH performance of the engine needs to reach a certain index.

In some embodiments of the present disclosure, for any road section A, the vehicle energy consumption after the vehicle travels through road section A can be predicted according to the road condition information of road section A. Considering the influence of the road condition information, the initial SOC, the road section-specific vehicle energy consumption, the NVH limited power of the engine of the vehicle, and the maximum charging and discharging power of the power battery on the charging and discharging power of the power battery, the first target SOC of the vehicle at the end of road section A can be determined according to the road condition information, the initial SOC, the road section-specific vehicle energy consumption, the NVH limited power of the engine of the vehicle, and the maximum charging and discharging power of the power battery.

The road section-specific vehicle energy consumption after the vehicle travels through a road section is determined according to the road condition information of the road section. According to the road condition information, the end SOC, the vehicle energy consumption, the NVH limited power of the engine of the vehicle, and the maximum charging and discharging power of the power battery, the second target SOC of the vehicle at the start of a road section is determined.

For any road section A, the road section-specific vehicle energy consumption after the vehicle travels through road section A can be predicted according to the road condition information of road section A. Considering the influence of the road condition information, the end SOC, the road section-specific vehicle energy consumption, the NVH limited power of the engine of the vehicle, and the maximum charging and discharging power of the power battery on the charging and discharging power of the power battery, the second target SOC of the vehicle at the start of road section A can be determined according to the road condition information, the end SOC, the road section-specific vehicle energy consumption, the NVH limited power of the engine of the vehicle, and the maximum charging and discharging power of the power battery.

According to the road section-specific vehicle energy consumption, the NVH limited power, and the and the maximum charging and discharging power, the charging and discharging power range corresponding to each road section is obtained. According to the initial SOC, the road condition information, and the charging and discharging power range, the first target SOC is determined.

In some embodiments of the present disclosure, according to the road section-specific vehicle energy consumption, the NVH limited power, and the and the maximum charging and discharging power, the charging and discharging power range corresponding to each road section is obtained. According to the initial SOC, the upper limit of the charging and discharging power range corresponding to the first road section, and the road condition information of the first road section, the upper limit of the first target SOC at the end of the first road section is calculated. According to the initial SOC, the lower limit of the charging and discharging power range corresponding to the first road section, and the road condition information of the first road section, the lower limit of the first target SOC at the end of the first road section is calculated.

Further, according to the upper limit of the first target SOC at the end of the first road section, the upper limit of the charging and discharging power range corresponding to the second road section, and the road condition information of the second road section, the upper limit of the first target SOC at the end of the second road section is calculated. According to the lower limit of the first target SOC at the end of the first road section, the lower limit of the charging and discharging power range corresponding to the second road section, and the road condition information of the second road section, the lower limit of the first target SOC at the end of the second road section is calculated. Similarly, the first target SOC at the end of each road section is calculated.

According to the road section-specific vehicle energy consumption, the NVH limited power, and the and the maximum charging and discharging power, the charging and discharging power range corresponding to each road section is obtained. According to the end SOC, the road condition information, and the charging and discharging power range, the second target SOC is determined.

In some embodiments of the present disclosure, according to the road section-specific vehicle energy consumption, the NVH limited power, and the and the maximum charging and discharging power, the charging and discharging power range corresponding to each road section is obtained. According to the end SOC, the upper limit of the charging and discharging power range corresponding to the last road section, and the road condition information of the last road section, the lower limit of the second target SOC at the start of the last road section is calculated. According to the end SOC, the lower limit of the charging and discharging power range corresponding to the last road section, and the road condition information of the last road section, the upper limit of the second target SOC at the start of the last road section is calculated. Further, according to the upper limit of the second target SOC at the start of the last road section, the lower limit of the charging and discharging power range corresponding to the penultimate road section, and the road condition information of the penultimate road section, the upper limit of the second target SOC at the start of the penultimate road section is calculated. According to the lower limit of the second target SOC at the start of the last road section, the upper limit of the charging and discharging power range corresponding to the penultimate road section, and the road condition information of the penultimate road section, the lower limit of the second target SOC at the start of the penultimate road section is calculated. Similarly, the second target SOC at the start of each road section can be calculated.

In some embodiments, the road section-specific vehicle energy consumption corresponding to the target road section is obtained by a target energy consumption prediction model after the road condition information of the target road section and the driving style information of the user are inputted into the target energy consumption prediction model, where the target energy consumption prediction model is determined from multiple preset energy consumption prediction models according to the road condition information of the target road section and the driving style information of the user.

According to the road condition information of the road section and the driving style information of the user, the target energy consumption prediction model is determined from multiple preset energy consumption prediction models. The road condition information of the road section and the driving style information of the user are inputted into the target energy consumption prediction model, to obtain the vehicle energy consumption corresponding to the road section outputted by the target energy consumption prediction model.

For example, the road condition information includes the road type, the average vehicle speed, the congestion level, the slope, the altitude, the traffic light information, and the weather information. According to the road type of road section A and the driving style information of the driver of the vehicle, the target energy consumption prediction model is be determined. Then, the road type, the average vehicle speed, the congestion level, the slope, the altitude, the traffic light information, the weather information, and the driving style information are inputted into the target energy consumption prediction model, to obtain the road section-specific vehicle energy consumption corresponding to road section A outputted by the model.

For example, the road condition information, the driving style information, the vehicle condition, and the vehicle setting habit of the user are inputted into the target energy consumption prediction model, to obtain the road section-specific vehicle energy consumption outputted by the model, thus improving the accuracy of the prediction result.

For example, the vehicle condition includes the vehicle weight, the wind resistance coefficient, the rolling resistance coefficient, and the tyre pressure, etc. The vehicle setting habit may include the air conditioner setting habit.

In some embodiments, one SOC is selected from the target SOC corresponding to each road section; and one SOC varying route among multiple SOC varying routes is obtained according to various SOCs.

For example, as shown in FIG. 9, the initial SOC at point A is F. Assuming that point H in the target SOC [I,G] of the battery is taken as the target SOC value, point K in the target SOC [L,J] of the battery is taken as the target SOC value, point N in the target SOC [Q,M] of the battery is taken as the target SOC value, and point T in the target SOC [X,R] of the battery is taken as the target SOC value, then F-H-K-N-T is one SOC varying route.

It is to be understood that as the number of SOC values corresponding to each road section increases, the number of the SOC varying routes of the battery generated increases, the determination accuracy of the SOC varying route corresponding to the minimum energy consumption of the battery is higher, and the energy management effect of the vehicle achieved is better.

In some embodiments, methods such as dynamic planning algorithm and Pontryagin's minimum principle (PMP) algorithm can be used to determine the target SOC varying route from multiple SOC varying routes that can minimize the energy consumption when the vehicle runs on the preset travel route. In these algorithms, the target SOC corresponding to each road section is used as a feasible region of a state variable.

For the sake of numerical calculation, the feasible region needs to be discretized, that is, the target SOC corresponding to each road section is discretized. For example, it can be discretized at equal intervals. If the difference between the maximum and minimum SOC corresponding to a certain road section is greater than 0.005, it can be discretized at intervals of 0.005. If difference between the maximum and minimum SOC corresponding to a certain road section is less than 0.005, the SOC is discretized into three equal parts. The control variables include the operation mode, and the engine operating point (torque, and speed) For example, the operation mode includes pure electric, series and parallel.

To reduce the computational power demand and speed up the calculation process, the feasible region of the engine operating point can be simplified, and the engine operating point in series and parallel mode is a control line calculated when the system efficiency is optimum. The NVH restriction needs to be considered to optimize the solution of the engine operating point, and the NVH constraint is simplified as a constraint line only related to the vehicle speed to constrain the rotational speed of the engine. By solving the optimization problem in the calculated feasible region, target SOC varying route corresponding to the minimum energy consumption can be obtained. The SOCs included in the target SOC varying route can be taken as the target SOCs corresponding to various road sections in the preset travel route.

In some embodiments, when the initial SOC is greater than or equal to a first preset threshold, the end SOC is a second preset threshold, where the second preset threshold is greater than the first preset threshold; and when the initial SOC is less than the first preset threshold, the end SOC is the first preset threshold.

For example, the second preset threshold can be a pre-calibrated electricity supply ensuring SOC of 25%, and the first preset threshold may be a pre-calibrated minimum allowable SOC of 17%.

It should be understood that 25% and 17% here are merely examples, and the values of the electricity supply ensuring SOC and the minimum allowable SOC can be adjusted according to the actual conditions. If the initial SOC corresponding to the preset travel route is greater than or equal to 17%, the end SOC corresponding to the preset travel route is determined to be 25%; and if the initial SOC corresponding to the preset travel route is less than 17%, the end SOC corresponding to the preset travel route is 17%.

In some embodiments, the step of controlling, according to the actual SOC and target SOC of the power battery of the vehicle, the engine and the motors of the vehicle is as follows. The actual SOC of the power battery of the vehicle when the vehicle travels on a target road section in the preset travel route is acquired. For example, the target road section may be any road section in the preset travel route. According to the actual SOC and the target SOC corresponding to the target road section, the vehicle is controlled to travel in the pure electric mode or non-pure electric mode.

In some embodiments of the present disclosure, when the vehicle travels on any road section in the preset travel route, such as road section A, road section A is the target rod section. The actual SOC of the power battery can be obtained in real time when the vehicle travels on the target road section. The actual SOC is compared with the target SOC corresponding to the target road section, and the vehicle is controlled to switch to the pure electric mode or non-pure electric mode according to the comparison result.

For example, the non-pure electric mode may include a hybrid mode (the internal combustion engine and the electric motor jointly serve as power sources). In an embodiment, the non-pure electric mode may include a hybrid mode and a pure fuel mode. It should be understood that the hybrid mode is only an example, and the non-pure electric mode may also include other operating modes, which are not limited here.

In some embodiments, the step of controlling, according to the actual SOC and the target SOC corresponding to the target road section, the vehicle to travel in the pure electric mode or non-pure electric mode is as follows.

When the vehicle speed of the vehicle is greater than or equal to a preset vehicle speed threshold, if the difference between the actual SOC and the target SOC is greater than or equal to a preset difference, the vehicle is controlled to travel in the pure electric mode; and if the difference between the actual SOC and the target SOC is less than the preset difference, the vehicle is controlled to travel in the hybrid mode.

In some embodiments of the present disclosure, considering the engine characteristics, when the vehicle speed of the vehicle is less than the vehicle speed threshold, the engine is not allowed to start. Based on this, the preset difference is assumed to be 2%. When the vehicle speed of the vehicle is greater than or equal to the preset vehicle speed threshold,

(a) if the actual SOC-target SOC≥2%, the vehicle is controlled to switch to the pure electric mode and the engine is stopped; and (b) if the actual SOC-target SOC≤2%, the engine is controlled to start, and the vehicle is switched to the hybrid mode. For example, the hybrid mode includes a series mode and a parallel mode. In some embodiments of the present disclosure, when the vehicle is switched to the hybrid mode, the vehicle travels preferably in the parallel mode; and if the conditions for travel in the parallel mode are not met, the vehicle travels in the series mode.

In some embodiments, the step of controlling, according to the actual SOC and the target SOC corresponding to the target road section, the vehicle to travel in the pure electric mode or non-pure electric mode is as follows. When the vehicle speed of the vehicle is less than the vehicle speed threshold, the vehicle is controlled to travel in the pure electric mode. For example, considering the engine characteristics, when the vehicle speed of the vehicle is less than the vehicle speed threshold, the engine is not allowed to start. Therefore, if the vehicle speed of the vehicle is less than the vehicle speed threshold, the vehicle is directly switched to travel in the pure electric mode.

In some embodiments, the vehicle speed threshold is positively correlated with the actual SOC of the power battery. That is, when the actual SOC of the power battery increases, the corresponding vehicle speed threshold increases accordingly; and when the actual SOC of the power battery decreases, the corresponding vehicle speed threshold decreases accordingly. For example, the vehicle speed threshold can be obtained by experimental calibration.

In some embodiments, if the preset travel route includes only one road section, the step of controlling, according to the actual SOC and target SOC of the power battery of the vehicle, the engine and the motors of the vehicle is as follows. The road section-specific vehicle energy consumption after the vehicle travels through a road section is determined according to the road condition information of the road section. When the initial SOC is greater than the end SOC: if the SOC difference is greater than or equal to the vehicle energy consumption, the vehicle is controlled to travel in the pure electric mode; and if the SOC difference is less than the vehicle energy consumption, the vehicle is controlled to travel in the hybrid mode to maintain the actual SOC of the power battery to be the initial SOC, and then the vehicle is controlled to travel in the pure electric mode. When the initial SOC is less than or equal to the end SOC, the vehicle is controlled to travel in the hybrid mode.

For example, the SOC difference is the difference between the initial SOC and the end SOC. If the SOC difference is greater than or equal to the road section-specific vehicle energy consumption, it means that the user's energy consumption demand can be met only by using battery power, so the vehicle can be controlled to travel in the pure electric mode on the preset travel route. If the SOC difference is less than the road section-specific vehicle energy consumption, it means that the user's energy consumption demand cannot be met only by using the battery power. Therefore, the vehicle can be controlled to travel in the hybrid mode on the preset travel route to maintain the actual SOC of the power battery to be the initial SOC, and then the vehicle is controlled to travel in the pure electric mode.

In some embodiments, the step of controlling, according to the actual SOC and target SOC of the power battery of the vehicle, the engine and the motors of the vehicle is as follows.

When the target SOC corresponding to the target road section is less than the initial SOC corresponding to the target road section: if the actual SOC of the power battery is greater than the minimum allowable SOC or the target SOC corresponding to the target road section, the vehicle is controlled to travel in the pure electric mode on the target road section; and if the actual SOC of the power battery is equal to the minimum allowable SOC or the target SOC corresponding to the target road section, the vehicle is controlled to travel in the hybrid mode to maintain the actual SOC of the power battery.

When the target SOC corresponding to the target road section is greater than the initial SOC corresponding to the target road section: if the actual SOC of the power battery is less than the maximum allowable SOC or the target SOC corresponding to the target road section, the vehicle is controlled to travel in the hybrid mode on the target road section; if the actual SOC of the power battery is equal to the maximum allowable SOC or the target SOC corresponding to the target road section, the vehicle is controlled to travel in the hybrid mode to maintain the actual SOC of the power battery; and if the actual SOC of the power battery is greater than the maximum allowable SOC or the target SOC corresponding to the target road section, the vehicle is controlled to travel in the pure electric mode on the target road section.

In some embodiments, the step of controlling, according to the actual SOC and target SOC of the power battery of the vehicle, the engine and the motors of the vehicle is as follows. According to the road condition information of the target road section in the preset travel route, a category coefficient of the target road section is determined. According to the target SOC corresponding to the target road section and the category coefficient of the target road section, an equivalent factor corresponding to the target road section is determined. By using the equivalent factor corresponding to the target road section and the equivalent consumption minimum strategy (ECMS), the instantaneous output power of the power battery of the vehicle at each moment on the target road section operation is determined. The vehicle is controlled according to the instantaneous output power.

For example, the category coefficient indicates the road condition category of a road section. For example, if the road type of a road section is expressway and the congestion level is medium, the category coefficient of the road section is 1. That is, the category coefficient 1 indicates that the road type of the road section is expressway and the congestion level is medium. For road section A, the equivalent factor corresponding to road section A can be determined according to the target SOC corresponding to road section A and the category coefficient of road section A. It is to be understood that the equivalent factor is the equivalent factor in ECMS, the explanation of which is shown in ECMS, and will not be repeated here. By using the equivalent factor and ECMS, the instantaneous output power of the power battery of the vehicle at each moment can be determined. Because each road section corresponds to its own equivalent factor, the instantaneous output power of the power battery at each moment in the time period when the vehicle travels on road section A is determined based on the equivalent factor corresponding to road section A and ECMS when the vehicle travels on road section A.

In some embodiments, the equivalent factor corresponding to the target road section is obtained by querying a table according to the category coefficient of the target road section and the target SOC.

For example, the target SOC corresponding to the target road section can be acquired, for example, the target road section is any road section in the preset travel route; and according to the category coefficient of the target road section and the target SOC, the equivalent factor corresponding to the target road section is obtained by querying a table. For example, the equivalent factor corresponding to the category coefficient of the target road section and the target SOC can be found by querying a table. For example, the table stores the correspondence relation between the category coefficient and target SOC and the equivalent factor.

In some embodiments, the instantaneous output power of the power battery when the vehicle travels on the target road section is calculated by a formula below:

$$arg H ( u , SOC ( t ) , t ) = arg {\dot{m}}_{eng} ( u , t ) + s ( t ) * S \dot{O} C ( t ) ,$$

where H (u, SOC (t), t) is the Hamiltonian function established according to ECMS,arg H (u, SOC (t), t) is the instantaneous output power of the power battery at time t,\dot{m}_{eng}(u, t) is the fuel consumption of the engine of the vehicle, s(t) is the equivalent factor at time t, SOC(t) is the SOC of the power battery at time t,S\dot{O}C(t) is the SOC change rate, and u is the fuel consumption.

For example, after obtaining the equivalent factor, the instantaneous output power of the battery of the hybrid electric vehicle corresponding to the equivalent factor can be obtained by ECMS, so that the hybrid electric vehicle can be controlled according to the instantaneous output power of the power battery. Moment t can be any moment.

In some embodiments, the steps of controlling the vehicle according to the instantaneous output power is as follows. The power demand of the vehicle at moment t is acquired. According to the vehicle power demand, the instantaneous output power of the power battery at time t, and the NVH limited power of the engine, the instantaneous output power of the engine at moment t is determined. According to the instantaneous output power of the power battery at moment t and the instantaneous output power of the engine at time t, the power battery and the engine are controlled.

For example, the power demand of the vehicle at moment t can be determined according to the vehicle speed of the vehicle and the depth at which the driver presses the accelerator pedal. According to the vehicle power demand, the instantaneous output power of the power battery at moment t calculated by ECMS and the NVH limited power of the engine, the instantaneous output power of the engine at moment t can be determined. Therefore, at time t, the vehicle can control, according to the instantaneous output power of the power battery at moment t and the instantaneous output power of the engine at time t, the power battery and the engine.

Therefore, the output power can be obtained based on the equivalent factor optimized in real time, to realize the whole-road full-time domain optimum energy management, thus reducing the energy consumption.

In some embodiments, considering that some unexpected situations may occur when the vehicle travels on the preset travel route, in view of this, when the vehicle travels on the target road section, if the difference between the actual SOC of the power battery of the vehicle and the target SOC corresponding to the target road section is greater than a set threshold, the target SOC is determined again. When the location of the vehicle deviates from the preset travel route, the target SOC is re-determined. When the vehicle travels on the target road section, if the road condition of the target road section changes, the target SOC is determined again.

For example, the target road section can be any road section in the preset travel route. For example, the vehicle is currently travels on road section A. If the difference between the actual SOC of the power battery of the vehicle and the target SOC corresponding to road section A is greater than the set threshold, the target SOCs of road section A and subsequent road sections will be determined again. If the location of the vehicle deviates from the preset travel route, the preset travel route of the vehicle changes. A new preset travel route and the target SOC corresponding to the new preset travel route can be determined at this time. If the road condition of road section A changes, for example, sudden traffic jam occurs, the target SOCs of road section A and subsequent road sections will be determined again. In this way, some unexpected situations that may occur on the preset travel route can be coped with to reduce the energy consumption of the vehicle.

In some embodiments, the preset travel route includes a start point and an end point. If the end point of the preset travel route has a charging condition, the end SOC when the vehicle travels to the end point is reduced.

In some embodiments, whether the end point has a charging condition can be determined based on whether the attribute of the end point presented on the navigation is a charging station and the number of charging piles usable at the charging station. If the end point is a charging station and has a usable charging pile, the end point is determined to have a charging condition, or the end point is determined not to have a charging condition. The charging condition can also be determined according to the historical charging behavior at home, company and favorite locations set by the navigation. If the home is commonly used location where a certain frequency of charging behavior occurs, it is determined as having a charging condition, otherwise it is determined as not having a charging condition.

For example, a logic for determining the historical charging behavior is that when a navigation ending instruction is received, or the distance from the end point is <=0.5 km, or the end point type is home, company, or a favorite location, the end point is determined to have a charging pile if the travel is less than 2 km and the travel time is less than 10 min before the plug-in action and the plug-in duration is more than 5 min, and the end point is determined to have a charging condition if the fast charging times and slow charging times are >=3.

In some embodiments, if the end point has a charging condition, and a navigation ending instruction is received, or the distance from the end point is <−0.5 km, or the end point type is home, company, or a favorite location, when the SOC is <=balance point +10, the vehicle is powered off and a charging device is not plugged in. After the cumulative number of times of low-SOC access failure is >=3, the fast charging times, slow charging times, and number of times of low-SOC access failure are all cleared to 0, and the end point is renewed to have no charging condition.

In some embodiments, the reduced end SOC satisfies the minimum allowable SOC of the vehicle.

In some embodiments, the minimum allowable SOC of the vehicle is the SOC required for traveling by the vehicle.

In some embodiments, the end point of the preset travel route having a charging condition includes the following situation. If a charging address is present at the end point and an idle charging pile is present at the charging address the end point is determined to have a charging condition.

In some embodiments, the control device 50 is further configured to update, when the vehicle travels to the end point of any road section, the target SOC corresponding to a remaining road section according to the target SOC of the power battery corresponding to any road section and the predicted road section-specific vehicle energy consumption corresponding to the remaining road section to achieve the minimum fuel consumption corresponding to the preset travel route.

In some embodiments, each time the vehicle travels through a road section, for example 1 km, the target SOC corresponding to a remaining road section is updated according to the target SOC of the power battery corresponding to any road section and the road section-specific vehicle energy consumption corresponding to the remaining road section to achieve the minimum fuel consumption corresponding to the preset travel route.

In some embodiments, the control device 50 is further configured to re-perform road section division, if the road condition information is updated, on a remaining travel route, to obtain at least one new road section. The remaining travel route is a route from a current location of the vehicle to the end point of the preset travel route in the preset travel route. The target SOC corresponding to each new road section is updated according to the initial SOC of the power battery and the road section-specific vehicle energy consumption corresponding to each new road section, to achieve the minimum fuel consumption corresponding to the preset travel route.

In some embodiments, if the congestion level in the received road condition information is updated, for example, the congestion level changes from smooth to congestion, road section division is re-performed on the remaining travel route, to obtain at least one new road section. The remaining travel route is a route from a current location of the vehicle to the end point of the preset travel route in the preset travel route. The target SOC corresponding to each new road section is updated according to the initial SOC of the power battery and the road section-specific vehicle energy consumption corresponding to each new road section, to achieve the minimum fuel consumption corresponding to the preset travel route.

In summary, in the control method for an intelligent energy management system for a new energy vehicle according to some embodiments of the present disclosure, road section division is performed on the preset travel route on which the vehicle travels, and a corresponding target SOC is determined for each road section, so that the vehicle can control, when travels on each road section, the engine, the drive motor, the electric generator, and the power battery, according to the target SOC and the actual vehicle demand corresponding to the road section, to enable the engine to operate in an efficient operating interval during operation, thus reducing the fuel consumption and improving the driving and riding experience of the user during traveling.

IV. The engine 10, the drive motor 20, the electric generator 30, and the power battery 40 are controlled according to the target SOC and the actual vehicle demand corresponding to each road section, to enable the engine 10 to operate in an efficient operating interval during operation.

In some embodiments, the engine 10, the drive motor 20, the electric generator 30, and the power battery 40 are controlled according to the target SOC and the actual vehicle demand corresponding to each road section, such that both the rotational speed and the torque of the engine 10 can work efficiently.

In some embodiments, according to the initial SOC, the target SOC, and the actual vehicle demand corresponding to each road section, the engine, the drive motor, the electric generator, and the power battery are controlled, to enable the engine to operate in an efficient operating interval during operation, This process is as follows. If the target SOC is greater than the initial SOC by a certain threshold, and the actual vehicle demand is less than a vehicle demand enabling the engine to operate in a high-efficiency and economic zone, the engine is controlled to drive the electric generator efficiently to generate electricity, and the excess electricity is stored in the power battery. If the target SOC is greater than the initial SOC by a certain threshold, and the actual vehicle demand is greater than or equal to a vehicle demand enabling the engine to operate in a high-efficiency and economic zone, the engine is controlled to operate in a high-efficiency operating interval and supply energy to the power battery, and the vehicle is driven by the drive motor, or the drive motor and the engine. If the target SOC is less than the initial SOC by a certain threshold, the engine is controlled to stop.

In some embodiments, if the target SOC is greater than the initial SOC by a certain threshold, and the actual vehicle demand is less than a vehicle demand enabling the engine to operate in a high-efficiency and economic zone, the engine drive the electric generator efficiently to generate electricity, and the excess electricity is stored in the power battery. The vehicle travels in the hybrid mode at this time. If the target SOC is greater than the initial SOC by a certain threshold, and the actual vehicle demand is greater than or equal to a vehicle demand enabling the engine to operate in a high-efficiency and economic zone, the engine is controlled to operate in a high-efficiency operating interval and supply energy to the power battery, and the vehicle is driven by the drive motor, or the drive motor and the engine. The vehicle travels in the hybrid mode at this time. If the target SOC is less than the initial SOC by a certain threshold, the engine is controlled to stop. The vehicle travels in the pure-electric mode at this time.

In some embodiments, the control device 50 is further configured to control the vehicle to travel on the preset travel route based on a target vehicle speed.

In some embodiments, the control device 50 is further configured to generate prompt information based on the target vehicle speed corresponding to the minimum vehicle energy consumption, where the prompt information is used to prompt the driver to control the vehicle to travel based on the target vehicle speed corresponding to the minimum vehicle energy consumption.

In some embodiments, the prompt information includes at least one of the target vehicle speed or pedal control information.

In some embodiments, when the prompt information is the target vehicle speed, it can be used for human-machine interaction with the driver through instruments, PADs, or HUDs. When the prompt information is the pedal control information, the vehicle speed be back calculated into the form of accelerator pedal and brake pedal, for human-computer interaction with the driver.

In some embodiments, according to the target SOC corresponding to each road section, the actual vehicle demand corresponding to each road section and the reduced end SOC when the vehicle travels to the end point, the engine, the drive motor, the electric generator, and the power battery are controlled, to enable the engine to operate in an efficient operating interval during operation.

In some embodiments, if the self-start function of the navigation system is disabled, the navigation system is off, and the preset travel route is a commuter route, the control device is further configured to: control, according to corresponding historical traveling data of the vehicle on the commuter route, the engine, the drive motor, the electric generator, and the power battery, to enable the engine to operate in an efficient operating interval during operation.

In some embodiments, prediction is performed by identifying the pattern of historical traveling data. For example, if the preset travel route is determined to be a commuter route by identifying the historical traveling data, the traveling operating condition of the vehicle is a commuting operating condition, which is regarded as the future traveling operating condition. If the identification is unsuccessful, the prediction is failed.

For example, the traveling data used for storage and prediction are mainly data related to vehicle energy consumption, such as speed, slope, and power demand. According to the target SOC and actual vehicle demand corresponding to each road section and a commuting energy management strategy, the engine, the drive motor, the electric generator, and the power battery are controlled, to enable the engine to operate in an efficient operating interval during operation.

In some embodiments, the historical driving data includes a vehicle speed sequence when the vehicle travels through the commuter route in a historical time period.

In some embodiments, the historical driving data includes a vehicle speed sequence when the vehicle travels through the commuter route in a historical time period. The engine, the drive motor, the electric generator and the power battery are controlled through the vehicle speed sequence, according to the target SOC and the actual vehicle demand corresponding to each road section and the commuting energy management strategy, to enable the engine to operate in an efficient operating interval during operation.

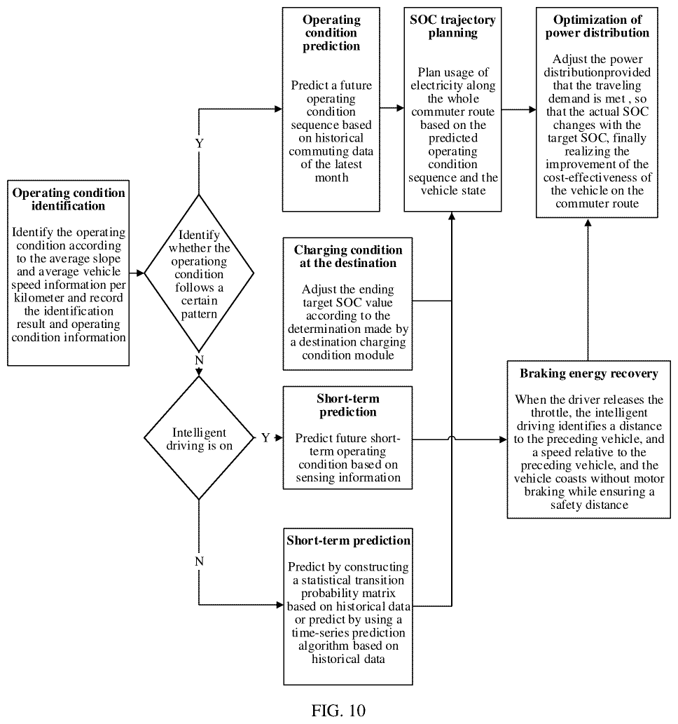

In some embodiments, referring to FIG. 10, FIG. 10 schematically shows an energy management based on historical traveling data according to some embodiments of the present disclosure.

For example, during operating condition identification, the operating condition is identified according to the average slope and average vehicle speed information per kilometer, and the identification result and operating condition information are recorded. If the identified operating condition follows a certain pattern, the operating condition is predicted. Based on historical commuting data of the latest month, a future operating condition sequence is predicted, and an SOC trajectory is planned. Based on the predicted operating condition sequence and the vehicle state, usage of electricity along the whole commuter route is planned. Based on a determination made by an end point charging condition module, an ending target SOC value is adjusted. Provided that the traveling demand is met, the power distribution is adjusted, so that the actual SOC changes with the target SOC, finally realizing the improvement of the cost-effectiveness of the vehicle on the commuter route. If the identified operating condition does not follow a certain pattern, it is determined whether intelligent driving is on. When the intelligent driving is on, a future short-term operating condition is predicted based on sensing information. When the driver releases the throttle, the intelligent driving identifies a distance to the preceding vehicle, and a speed relative to the preceding vehicle, and the vehicle coasts without motor braking while ensuring a safety distance. When the intelligent driving is not on, the operating condition is predicted by constructing a statistical transition probability matrix based on historical data, or predicted by using a time-series prediction algorithm based on historical data.

In some embodiments, if the self-start function of the navigation system is disabled, the navigation system is off, and the preset travel route is not a commuter route, the control device 50 is further configured to: predict, when the vehicle travels on the preset travel route, the vehicle speed of the vehicle in a preset time period, to obtain a predicted vehicle speed of the vehicle in the preset time period; predict, according to the predicted vehicle speed in the preset time period, a component control sequence of the vehicle in the preset time period; and control, according to a first control instruction in the component control sequence, a corresponding component, where the component includes at least one of the throttle and the pedal.

In some embodiments, the component includes at least one of the throttle and the pedal. The component control sequence includes at least one control instruction on the component. Controlling the corresponding component refers to controlling the corresponding component to execute the first control instruction.

In some embodiments, for example, the preset time period is 5 to 10 sec in the future, the vehicle speed in the future 5 to 10 sec is predicted by using the historical data or an intelligent driving sensor; a component control sequence of the vehicle in the preset time period is predicted according to the predicted vehicle speed in the preset time period, where the component includes at least one of the throttle and the pedal; and the corresponding component is controlled according to the first control instruction in the component control sequence. The other control instructions in the component control sequence are sequentially executed for optimization. Through the optimization in the preset time period, the fuel consumption of the user can be reduced.

In some embodiments, the preset time period refers to a time period having a first preset duration that has elapsed since the last time the corresponding component is controlled according to the control instruction. For example, after traveling based on the predicted vehicle speed in 5 to 10 sec, the vehicle speed in the future 5 to 10 sec is further predicted. For example, the first preset duration may be future 5 to 10 sec.

In some embodiments, the vehicle speed of the vehicle in a preset time period is predicted, to obtain a predicted vehicle speed of the vehicle in the preset time period. This process is as follows. When the intelligent driving function is disabled, the historical traveling data of the vehicle in a preset historical time period is acquired; and the vehicle speed of the vehicle in the preset time period is predicted according to the historical traveling data, to obtain the predicted vehicle speed of the vehicle in the preset time period.

In some embodiments, when the intelligent driving function is disabled the vehicle speed of the vehicle in future 5 to 10 sec is predicted according to the historical traveling data, to obtain the predicted vehicle speed of the vehicle in the future 5 to 10 sec. The preset time period may be future 5 to 10 sec.

In some embodiments, the historical traveling data includes a vehicle speed sequence. The vehicle speed of the vehicle in the preset time period is predicted according to the historical traveling data, to obtain a predicted vehicle speed of the vehicle in the preset time period. This process is as follows. The vehicle speed sequence is divided, to obtain at least one vehicle speed interval. A vehicle speed state transition probability corresponding to a vehicle speed state transition from a vehicle speed state corresponding to a target vehicle speed interval in the at least one vehicle speed interval to a vehicle speed state corresponding to a vehicle speed interval next to the target vehicle speed interval is acquired, to construct a system state transition probability matrix. The target vehicle speed interval is any vehicle speed interval in the at least one vehicle speed interval, and the system state transition probability matrix includes at least one transition probability. According to the system state transition probability matrix and the vehicle speed of the vehicle at the current moment, the vehicle speed at each moment in the preset time period is predicted, to obtain the predicted vehicle speed of the vehicle in the preset time period.

In some embodiments, the vehicle speed sequence is divided, to obtain at least one vehicle speed interval. A system state transition probability matrix is constructed where the system state transition probability matrix represents a vehicle speed state transition probability corresponding to a vehicle speed state transition from a vehicle speed state corresponding to a target vehicle speed interval to a vehicle speed state corresponding to a vehicle speed interval next to the target vehicle speed interval. According to the system state transition probability matrix and the vehicle speed of the vehicle at the current moment, the vehicle speed at each moment in the preset time period is predicted, to obtain the predicted vehicle speed of the vehicle in the preset time period.

In some embodiments, according to the system state transition probability matrix and the vehicle speed of the vehicle at the current moment, the vehicle speed at each moment in the preset time period is predicted, to obtain a predicted vehicle speed of the vehicle in the preset time period. The process is as follows. According to a speed change limit of the vehicle and a traffic flow speed limit, the system state transition probability matrix is corrected. According to the corrected system state transition probability matrix and the vehicle speed of the vehicle at the current moment, the vehicle speed at each moment in the preset time period is predicted, to obtain the predicted vehicle speed of the vehicle in the preset time period.

In some embodiments, the vehicle speed sequence is divided, to obtain at least one vehicle speed interval. A system state transition probability matrix is constructed where the system state transition probability matrix represents a vehicle speed state transition probability corresponding to a vehicle speed state transition from a vehicle speed state corresponding to a target vehicle speed interval to a vehicle speed state corresponding to a vehicle speed interval next to the target vehicle speed interval. According to a speed change limit of the vehicle and a traffic flow speed limit, the system state transition probability matrix is corrected. According to the corrected system state transition probability matrix and the vehicle speed of the vehicle at the current moment, the vehicle speed at each moment in the preset time period is predicted, to obtain the predicted vehicle speed of the vehicle in the preset time period.

For example, a rolling time window mode is adopted for short-term recording of the vehicle speed, and the vehicle speed is recorded as Vt|p={vt-i: 1≤i≤p}, where to meet the accuracy of short-term prediction, the value of p may be 40.

Vehicle speed intervals are divided according to the historical data of the vehicle, and a probability pmij of the vehicle speed changing from a current vehicle speed interval to another vehicle speed interval at a next moment is calculated, to construct a system state transition probability matrix Pm=(pmij)n×n.

Considering the speed change limit of the vehicle and the traffic flow speed limit obtained above, the system state transition probability matrix Pm is corrected. For example, the traffic flow speed limit is an average speed to limit the maximum and minimum speeds of the vehicle in the future traveling process, and the speed change limit of the vehicle affects a corresponding maximum acceleration or maximum deceleration of the vehicle, limiting a speed change range between adjacent moments.

According to the system state transition probability matrix and the current vehicle speed, the most probable vehicle speed interval at the next moment is predicted. For example, the current vehicle speed is 20 kilometers per hour, and the most probable vehicle speed interval at the next moment is predicted according to the transition probability matrix to be a vehicle speed interval of 20 kilometers per hour to 30 kilometers per hour. A predicted future speed at moment f is calculated based on Vt|f=vt|tΠPm(n), n=1, and 2, . . . f. A predicted future speed sequence, the acceleration and speed of the preceding vehicle, the relative distance to the preceding vehicle are obtained, For example, it is assumed by default that the acceleration of the preceding vehicle tends to remain unchanged in the future. The above data is substituted into a vehicle longitudinal dynamics model to calculate whether a safe driving condition is met. If the safe driving condition is met, the predicted vehicle speed in the preset time period is outputted. If the safe driving condition is not met, a safety warning is given.

In some embodiments, a short-term predicted operating condition is obtained according to the predicted vehicle speed. This process is as follows. According to the corrected system state transition probability matrix and the predicted vehicle speed in the preset time period, the operating condition of the vehicle in the preset time period is predicted, to obtain the short-term predicted operating condition. The short-term predicted operating condition includes the predicted vehicle speed of the vehicle in the preset time period.

In some embodiments, the control device 50 is further configured to: control, when the distance to the preceding vehicle or the speed relative to the preceding vehicle is determined not to meet the safe traveling condition, the vehicle to brake.

In some embodiments, when the intelligent driving sensor identifies the distance to the preceding vehicle or the speed relative to the preceding vehicle does not meet the safe traveling condition mechanical braking is activated to intervene in the control, to ensure the safety of the user during traveling.

In some embodiments, if the intelligent driving function is enabled, the navigation-assisted driving function is disabled, the adaptive cruise control function is enabled, there is no preceding vehicle, and the vehicle speed planning is not activated, the control device is further configured to control the vehicle to travel based on the current vehicle speed.

In some embodiments, if the intelligent driving function is enabled, the navigation-assisted driving function is disabled, the adaptive cruise control function is enabled, there is a preceding vehicle, and the vehicle speed planning is not activated, the control device is further configured to acquire a current vehicle speed of the preceding vehicle ahead the vehicle; and control the vehicle to travel based on the current vehicle speed of the preceding vehicle.

In some embodiments, the control device 50 is further configured to: trigger, when the intelligent driving function is enabled the navigation-assisted driving function is disabled, the adaptive cruise control function is enabled, there is a preceding vehicle, and the vehicle speed planning is activated, an operation of generating a speed sequence according to the road traffic flow speed on the preset travel route and the current vehicle speed of the vehicle by taking the minimum route-specific vehicle energy consumption as an objective function, where the current vehicle speed is the vehicle speed of the vehicle at the start point of the preset travel route; correcting the speed sequence based on a restriction condition, to obtain a corrected speed sequence, where the restriction condition at least includes the driving style; acquire a current vehicle speed of the preceding vehicle ahead the vehicle; and determine, according to the current vehicle speed of the preceding vehicle and the target vehicle speed of the vehicle, a control vehicle speed of the vehicle; and control the vehicle to travel based on the control vehicle speed.

In some embodiments, when the current vehicle speed of the preceding vehicle is greater than or equal to the target vehicle speed of the vehicle, the control vehicle speed of the vehicle is the target vehicle speed. When the current vehicle speed of the preceding vehicle is less than the target vehicle speed of the vehicle, the control vehicle speed of the vehicle is the current vehicle speed of the preceding vehicle.

In some embodiments, the control device 50 is further configured to: predict, when the intelligent driving function is enabled, the navigation-assisted driving function is disabled, and the adaptive cruise control function is disabled, a vehicle speed of the vehicle in a preset time period according to acquired intelligent driving sensing data, to obtain a predicted vehicle speed of the vehicle in the preset time period, and control the vehicle to travel based on the predicted vehicle speed.

In some embodiments, The preset time period is, for example, future 5 to 10 sec. Current vehicle information and ambient environment information is collected by intelligent driving sensors such as a laser radar, a millimeter wave radar, and a camera, and a predicted vehicle speed in the future 5 to 10 sec is calculated. The vehicle is controlled to travel based on the predicted vehicle speed.

In some embodiments, according to the target SOC and actual vehicle demand corresponding to each road section, traffic light information, and an energy management strategy based on navigation information fusion, the engine, the drive motor, the electric generator, and the power battery are controlled, to enable the engine to operate in an efficient operating interval during operation, This process is as follows. According to the current vehicle speed of the vehicle and the traffic light information, it is determined whether the vehicle is able to pass through a signalized intersection where a traffic light corresponding to the traffic light information is located. If the vehicle is not able to pass through the signalized intersection where the traffic light corresponding to the traffic light information is located, an allowed traveling time of the vehicle is calculated; the engine is controlled to operate efficiently or stop, the vehicle is controlled to travel based on the current vehicle speed of the vehicle during the allowed traveling time, and at the end of the allowed traveling time, mechanical braking is inactivated and a preset energy recovery level is activated.

In some embodiments, the allowed traveling time of the vehicle is calculated as follows. A distance by which the vehicle can coast is calculated; according to the distance by which the vehicle can coast and a distance between the vehicle and the traffic light, an allowed traveling distance of the vehicle is determined; and according to the allowed traveling distance and the current vehicle speed of the vehicle, the allowed traveling time of the vehicle is determined.

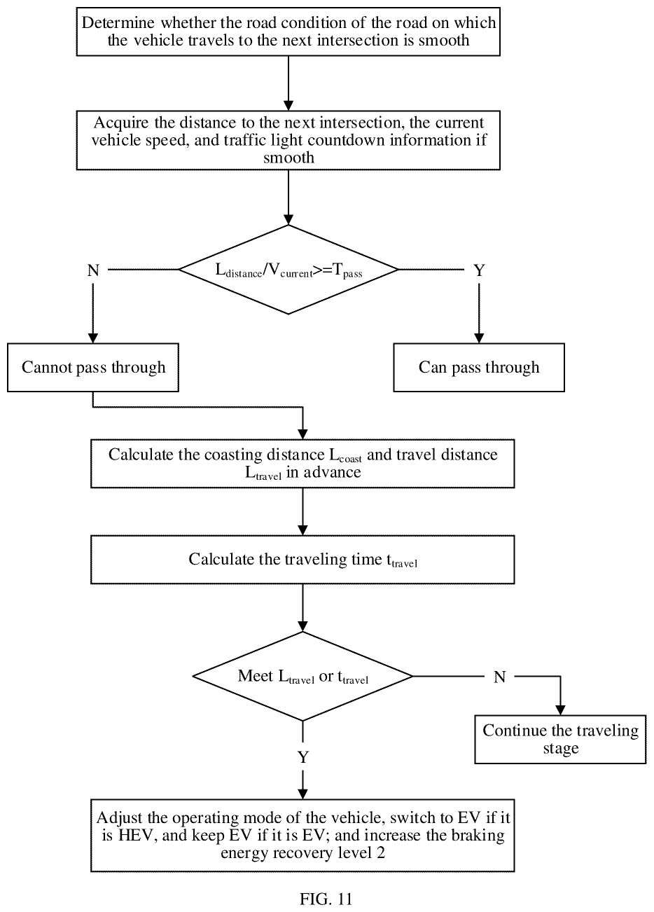

In some embodiments, the energy management strategy based on navigation information fusion further includes partial correction based on traffic light information fusion. Referring to FIG. 11, FIG. 11 schematically shows the logic of partial correction based on traffic light information fusion according to some embodiments of the present disclosure. Considering the partial correction based on traffic light information fusion, a phase and countdown of the traffic light ahead, the vehicle speed, and the distance between the vehicle and the traffic light are acquired from the navigation system. According to the current vehicle speed, the distance, and the traffic light countdown, whether the vehicle is able to pass through the signalized intersection is determined. If

$${t}_{c u r r e n t} = \frac{{L}_{d i s t a n c e}}{{V}_{c u r r e n t}} < {T}_{p a s s} ,$$

the vehicle is able to pass through the signalized intersection. If

$${t}_{c u r r e n t} = \frac{{L}_{d i s t a n c e}}{{V}_{c u r r e n t}} \geq {T}_{p a s s} ,$$

the vehicle is not able to pass through the signalized intersection.

When the vehicle is not able to pass through the signalized intersection, a coasting distance L_{coast} is calculated in advance, and a traveling distance Lₜᵣₐᵥₑₗ that the vehicle can travel at the current vehicle speed is calculated according to Lₜᵣₐᵥₑₗ=L_{distance}−L_{coast}, where L_{coast} represents a distance required to decelerate from the current vehicle speed to stop without intervention of mechanical braking, while increasing a braking energy recovery level 2. A traveling time tₜᵣₐᵥₑₗ that the vehicle can travel at the current vehicle speed is calculated according to

$${t}_{travel} = \frac{{L}_{travel}}{{V}_{c u r r e n t}} .$$

When the vehicle meets Lₜᵣₐᵥₑₗ or tₜᵣₐᵥₑₗ, coasting with the braking energy recovery level 2 is started. At this moment, if the operating mode of the vehicle is a hybrid electric vehicle (HEV) mode, the vehicle switches to an electric vehicle (EV) mode; and if the operating mode of the vehicle is the EV mode, the vehicle keeps operating in the EV mode.

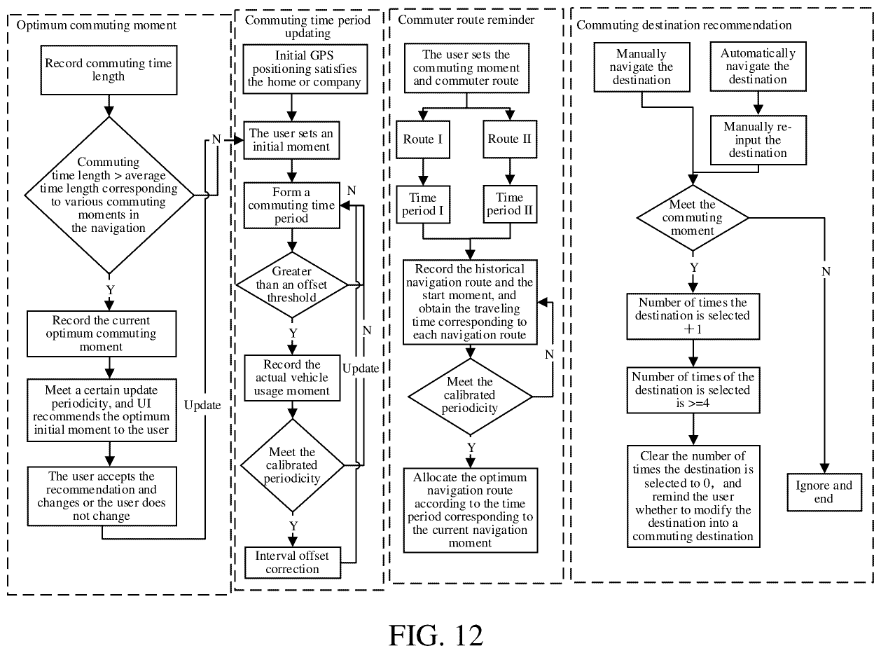

In some embodiments, the energy management strategy based on navigation information fusion further includes an automatic navigation method for commuting, when automatic navigation is enabled and the preset travel route is a commuter route. Referring to FIG. 12, FIG. 12 schematically shows the logic of updating automatic navigation initial moment according to some embodiments of the present disclosure;

For example, it consists of optimum commuting moment, commuting time period update, commuter route reminder, and commuting end point recommendation. It aims to automatically start the navigation system once powered on, and correct the commuting time period and the commuter route timely, so as to meet the customized commuting needs of different users, and improve the efficiency of commuting navigation. In the automatic navigation method for commuting, an end point is identified according to a preset commuting periodicity, a moment of going to work, a moment of leaving work, a residential address, and a home address preset by a user, and a commuting operating condition is further identified.

The commuting operating condition includes a go-to-work operating condition and leave-work operating condition. When the vehicle is started, an on-board server first determines whether an initial location is met according to GPS, then forms a go-to-work time period and a leave-work time period according to the moment of going to work, the moment of leaving work, and a time offset, and determines whether the current operating condition is a commuting operating condition by determining whether the current moment is in the commuting periodicity and the commuting time period, thereby automatically starting the navigation system.

In some embodiments, for the optimal commuting moment, consumed time lengths corresponding to a current commuting moment and different moments are recorded through the navigation system a current optimum commuting moment is determined through comparison and recorded, and after a certain update periodicity is met, the current optimum commuting moment is recommended to the user through a user interface (UI), so as to change the optimum commuting moment.

In some embodiments, for the commuting time period update, an interval offset correction amount of the current commuting time period is obtained according to the distribution and proportions of moments at which the navigation system is automatically started, moments at which the navigation system is not automatically started but is manually started and possible commuting moments in the go-to-work time period and the leave-work time period formed according to the moment of going to work, the moment of leaving work, and the time offset. When an update periodicity is satisfied, the commuting time period is updated based on the current moment and the interval offset correction amount of the current commuting time period.

In some embodiments, the commuter route reminder mainly includes storing and identifying historical navigation routes. For example, the historical navigation routes include automatic navigation commuter routes and manual navigation commuter routes. Usage periods and corresponding usage durations of the navigation routes are analyzed. When a periodicity is satisfied, an optimum navigation route matching a navigation time period corresponding to a current navigation moment is determined, and provided for selection by the user.

In some embodiments, for the commuting end point recommendation, when the automatic navigation fails due to a change of commuting address, and the commuting time period is satisfied, the number of times the navigation end point is selected is increased by 1. When the number of times the navigation end point has been consecutively selected is >=4, the user is reminded whether to set the navigation end point as the commuting end point, and clear the number of times the navigation end point is selected to 0.

When none of the above strategies is satisfied, the control device 50 is further configured to adjust, according to the driving style, the current vehicle speed of the vehicle, or current environmental information where the vehicle is located, an electricity supply ensuring SOC; and control, according to a comparison result of an actual SOC and an adjusted electricity supply ensuring SOC of the vehicle, the engine, the drive motor, the electric generator, and the power battery, to enable the engine to operate in an efficient operating interval during operation.

In some embodiments, according to information such as driving style, vehicle speed, plateau, and low temperature, electricity supply ensuring SOCs under different historical operating conditions are dynamically adjusted to meet the vehicle demand. The operating mode, engine start-stop, and power distribution are dynamically adjusted by comparing the actual SOC with the electricity supply ensuring SOC. The electricity supply ensuring SOC may be the target SOC.

In some embodiments of the present disclosure, the target SOC corresponding to each road section is planned to achieve a minimum fuel consumption corresponding to the travel route, and the vehicle is controlled according to the target SOC and the actual vehicle demand corresponding to each road section, to realize the reasonable allocation of fuel and electricity in a hybrid electric vehicle, and reduce the fuel consumption and vehicle usage cost of the vehicle. The engine, the drive motor, the electric generator, and the power battery are controlled, to enable the engine to operate in an efficient operating interval during operation, improve the NVH performance of the engine, avoid the frequent start and stop of the engine, and improve the driving and riding comfort. The route-specific vehicle energy consumption corresponding to the preset travel route is predicted according to the multi-domain fusion information, that is, the route-specific vehicle energy consumption is predicted by fusing the cockpit domain and power domain information, to improve the accuracy of energy consumption prediction, and further improve the fuel saving performance.

Based on the above description, in some embodiments of the present disclosure, the control device 50 may further perform pre-heating management.

In some embodiments, the control device 50 is further configured to: adjust, according to the state of charge, the preset travel route, and an appointed boarding time of the user, a temperature of the power battery.

In some embodiments, the state of charge includes a current charging amount and charging rate of the power battery. Different routes lead to different driving modes and battery usage statuses, which have different effects on the heat generation of the battery. If the user is expected to get on the vehicle in a short period of time, a measure needs to be taken to quickly adjust the battery temperature, to achieve an optimum performance at departure.

In some embodiments, a target passenger compartment temperature is generated according to a current passenger compartment temperature and the appointed boarding time of the user, and the passenger compartment temperature in the vehicle is controlled through an air conditioner to reach the target passenger compartment temperature.

In some embodiments, when the target passenger compartment temperature is greater than the current passenger compartment temperature, cooling water of the engine is controlled to provide pre-heating.

In some embodiments, before traveling, a pre-travel target passenger compartment temperature deviation value is generated according to a passenger compartment temperature on a panel, navigation information, a temperature outside the vehicle, the state of charge, and the boarding time of the user, and the passenger compartment temperature on the panel is corrected according to the pre-travel target passenger compartment temperature deviation value, to generate the target passenger compartment temperature. Deviation correction values are divided into a cooling type and a heating type. In some embodiments, when the air conditioner is in a heating mode, the cooling water of the engine is further used to pre-heat the passenger compartment. By optimizing the heating or cooling power, the passenger compartment is slowly pre-heated or pre-cooled in advance, so as to reduce the energy loss caused by high current, thereby reducing the power consumption of the air conditioner and accessories in a high-temperature or low-temperature environment, and reducing the fuel consumption. In addition, the pre-heating and pre-cooling alleviate the lag between the target temperature and the actual control temperature of components and the passenger compartment caused by heat capacity, thereby ensuring the efficiency of components and the comfort of the passenger compartment in high-temperature and low-temperature environments.

In some embodiments, the control device 50 is further configured to: adjust, according to the state of charge, the preset travel route, and an appointed boarding time of the user, a temperature of the power battery.

In some embodiments, before traveling, a target temperature of the battery is adjusted according to the state of charge, the appointed boarding time of the user, and mileage information, and thermal management of the battery is started in advance, to improve the battery efficiency during traveling and reduce the energy consumption of the vehicle.

In some embodiments, a target temperature deviation value is acquired during the traveling process of the vehicle, the target passenger compartment temperature is corrected according to the target temperature deviation value, and the passenger compartment temperature of the vehicle is controlled to reach the corrected target passenger compartment temperature.

In some embodiments, the target temperature deviation value is acquired during the traveling process of the vehicle as follows.

During the traveling process of the vehicle, a temperature influencing factor is collected, where the temperature influencing factor includes at least one of vehicle information and environmental information. The vehicle information includes at least one of window opening information, engine water temperature, navigation time, and the target temperature deviation value. The environmental information includes at least one of weather information and the temperature outside the vehicle. According to a temperature deviation value corresponding to the temperature influencing factor, the target temperature deviation value is determined.

In some embodiments, the temperature influencing factor corresponds to multiple temperature deviation values. The target temperature deviation value is determined according to the temperature deviation value corresponding to the temperature influencing factor as follows. A mileage of the preset travel route is acquired. If the mileage is greater than a third preset distance threshold, a first temperature deviation value in the multiple temperature deviation values is determined as the target temperature deviation value, where the first temperature deviation value is smaller than the other temperature deviation values in the multiple temperature deviation values than the first temperature deviation value.

In some embodiments, the temperature influencing factor corresponds to multiple temperature deviation values.

The target temperature deviation value is determined according to the temperature deviation value corresponding to the temperature influencing factor as follows. A mileage of the preset travel route is acquired. If the mileage is less than or equal to a third preset distance threshold and the target passenger compartment temperature is greater than the current passenger compartment temperature, a first temperature deviation value in the multiple temperature deviation values is determined as the target temperature deviation value, where the first temperature deviation value is smaller than the other temperature deviation values in the multiple temperature deviation values than the first temperature deviation value.

In some embodiments, the temperature influencing factor corresponds to multiple temperature deviation values. The target temperature deviation value is determined according to the temperature deviation value corresponding to the temperature influencing factor as follows. A mileage of the preset travel route is acquired. If the mileage is less than or equal to a third preset distance threshold and the target passenger compartment temperature is less than the current passenger compartment temperature, a second temperature deviation value in the multiple temperature deviation values is determined as the target temperature deviation value, where the second temperature deviation value is greater than the other temperature deviation values in the multiple temperature deviation values than the second temperature deviation value.

In some embodiments, during traveling, the target temperature deviation value is generated according to the weather information, the window opening information, the engine water temperature, the temperature outside the vehicle, the navigation time, and the target passenger compartment temperature information on the panel, and the target passenger compartment temperature is corrected according to the target temperature deviation value. When the mileage is greater than the third preset distance threshold, it indicates that the current travel is a long-distance travel. To ensure better comfort of the passenger compartment, the deviation value with the smallest absolute value, i.e., the first temperature deviation value, is determined as a final target passenger compartment temperature deviation value. When the mileage is less than or equal to the third preset distance threshold, it indicates that the current travel is a short-distance travel, and there is a tendency to reduce the energy consumption of the vehicle while ensuring that the temperature of the passenger compartment is comfortable and acceptable. In the cooling mode, the deviation value with the largest absolute value, i.e., the second temperature deviation value, is determined as the final target passenger compartment temperature deviation value. In the heating mode, the deviation value with the smallest absolute value, i.e., the first temperature deviation value, is determined as the final target passenger compartment temperature deviation value.

In some embodiments, the control device 50 is further configured to: predict an output duration of a to-be-outputted power of the engine, and start the engine when the output duration is greater than a third preset duration.

In some embodiments, if there is a road section with a long engine start time for the vehicle to travel through in the future, the engine is started in advance for pre-heating, so as to improve the thermal efficiency of the engine during traveling.

In some embodiments, the control device 50 is further configured to: predict a traffic congestion time of the vehicle, and increase a water temperature of the engine when an interval between a current time and the traffic congestion time is a fourth preset duration.

In some embodiments, the water temperature of the engine is increased by reducing a pump speed of the engine or reducing a fan speed of the engine.

In some embodiments, in the case of a coming traffic jam, the target water temperature of the engine is increased, and the pump speed and the fan speed of the engine are reduced, so as to reduce the energy consumption.

In some embodiments, the target temperature of the battery is adjusted, to reduce the energy consumption of the thermal management of the battery.

In some embodiments, the control device 50 is further configured to:
predict an end point of the preset travel route, stop adjustment of the water temperature of the engine according to a target water temperature deviation of the engine when a distance between the current location of the vehicle and the end point is less than a preset distance, and increase the water temperature of the engine, until the water temperature of the engine is higher than a preset temperature threshold before the vehicle reaches the end point.

In some embodiments, when the distance between the current location of the vehicle and the end point is less than the preset distance, that is, the vehicle is about to reach the end point, the target water temperature of the engine is increased in advance, and the pump speed and the fan speed of the engine may be reduced, so as to reduce the energy consumption.

In some embodiments, the control device 50 is further configured to: predict an end point of the preset travel route, stop adjustment of a temperature of the power battery according to a target temperature deviation of the power battery when a distance between the current location of the vehicle and the end point is less than a preset distance, and adjust the temperature of the power battery, until the temperature of the power battery is in a preset temperature interval before the vehicle reaches the end point.

In some embodiments, before the vehicle reaches the end point, the adjustment of the temperature of the power battery according to the target temperature deviation of the power battery is stopped, and the temperature of the power battery is adjusted, until the temperature of the power battery is in the preset temperature interval before the vehicle reaches the end point, thereby reducing the energy consumption required to maintain the battery temperature.

In some embodiments, the control device 50 is further configured to: predict an end point of the preset travel route, stop control of a passenger compartment temperature of the vehicle to reach a target passenger compartment temperature when a distance between the current location of the vehicle and the end point is less than a preset distance, and correct the target passenger compartment temperature.

In some embodiments, before the vehicle reaches the end point, the target passenger compartment temperature is corrected, to reduce the energy consumption required to maintain the passenger compartment temperature.

In some embodiments of the present disclosure, pre-heating management is performed before and during traveling, and by optimizing the heating or cooling power according to the heating or cooling requirement, the passenger compartment is slowly pre-heated or pre-cooled in advance, so as to reduce the energy loss caused by high current, thereby reducing the power consumption of the air conditioner and accessories in a high-temperature or low-temperature environment, and reducing the fuel consumption.

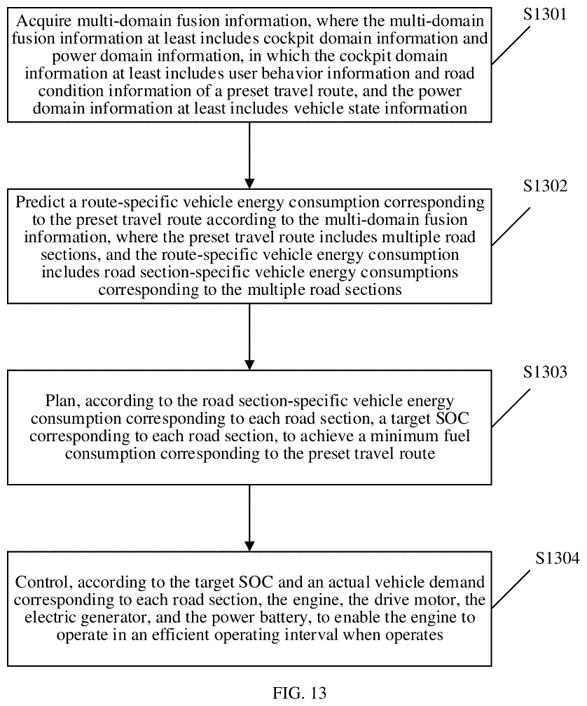

Based on the above description, referring to FIG. 13, FIG. 13 schematically shows a flowchart of a control method for an intelligent energy management system for a new energy vehicle according to some embodiments of the present disclosure. The control method for an intelligent energy management system for a new energy vehicle shown in FIG. 13 includes, without limitation, Steps S1301-S1304.
S1301: Multi-domain fusion information is acquired, where the multi-domain fusion information at least includes cockpit domain information and power domain information, for example, the cockpit domain information at least includes user behavior information and road condition information of a preset travel route, and the power domain information at least includes vehicle state information.

The steps in this embodiment can be made reference to the steps for the control device 50 to acquire the multi-domain fusion information, and will not be repeated here.
S1302: A route-specific vehicle energy consumption corresponding to the preset travel route is predicted, according to the multi-domain fusion information, where the preset travel route includes multiple road sections, and the route-specific vehicle energy consumption includes road section-specific vehicle energy consumptions corresponding to the multiple road sections.

In some embodiments, if a self-start function of the navigation system is enabled and a current system time is within a preset vehicle usage time period, the navigation system is automatically started, and the preset travel route is determined according to the current location information of the vehicle.

In some embodiments, if the self-start function of the navigation system is disabled the preset travel route is determined in response to an end point inputted by the user.

In some embodiments, the preset travel route includes multiple road sections, and the multiple road sections are divided according to road condition information of each road section. The route-specific vehicle energy consumption includes road section-specific vehicle energy consumptions corresponding to the multiple road sections. Each road section-specific vehicle energy consumption is related to the road condition information of each road section.

In some embodiments, the division of each road section is related to the road condition information of the preset travel route.

In some embodiments, each road section is divided according to at least one of the road type and the congestion level of the preset travel route.

In some embodiments, the preset travel route is determined in response to an end point inputted by the user. At least one candidate energy-saving route can be determined according to a start point and an end point of the vehicle. The predicted route-specific vehicle energy consumption corresponding to the at least one candidate energy-saving route is less than the predicted route-specific vehicle energy consumptions corresponding to other routes. The route-specific vehicle energy consumption is predicted according to the multi-domain fusion information of each route. The preset travel route is determined in response to an operation of selecting at least one candidate energy-saving route. The preset travel route refers to the selected candidate energy-saving route. The preset travel route includes multiple road sections, and the route-specific vehicle energy consumption includes road section-specific vehicle energy consumptions corresponding to the multiple road sections.

In some embodiments, at least one candidate energy-saving route is determined according to a start point and an end point of the vehicle. A start point of any candidate travel route is the start point of the vehicle, and an end point of any candidate travel route is the end point. According to the multi-domain fusion information of each candidate travel route, the route-specific vehicle energy consumption of the vehicle corresponding to each candidate travel route is predicted. According to the route-specific vehicle energy consumption of the vehicle corresponding to each candidate travel route, at least one candidate energy-saving route is determined from the at least one candidate travel route. The route-specific vehicle energy consumption of the vehicle corresponding to any candidate energy-saving route is less than the route-specific vehicle energy consumptions of the vehicle corresponding to other candidate travel routes than the at least one candidate energy-saving route in the at least one candidate travel route.

In some embodiments, at least one candidate travel route is determined according to a start point and an end point of the vehicle. This process is as follows. At least one travel route from the start point to the end point of the vehicle is acquired. Based on a first travel dimension index of each travel route, m travel routes are determined from the at least one travel route, where m is a positive integer, and the first travel dimension index of any travel route of the m travel routes is less than the first travel dimension index of other travel routes than the m travel routes in the at least one travel route. Based on a second travel dimension index of the m travel routes, at least one candidate travel route is determined from the m travel routes, where the second travel dimension index of any candidate travel route is less than the second travel dimension index of other travel routes than the at least one candidate travel route in the m travel routes.

In some embodiments, the first travel dimension index includes a travel distance, and the second travel dimension index includes a travel time.

In some embodiments, based on the second travel dimension index of the m travel routes, at least one candidate travel route is determined from the m travel routes. This process is as follows. A target travel route with the minimum second travel dimension index is determined from the m travel routes. A travel route with a second travel dimension index that differs from the second travel dimension index of the target travel route by a value that is less than a preset index threshold is screened out from the m travel routes. The screened travel route is taken as the at least one candidate travel route.

In some embodiments, at least one candidate travel route is determined according to a start point and an end point of the vehicle. This process is as follows. At least one travel route from the start point to the end point of the vehicle is acquired. Travel dimension indexes of each travel route are acquired, where the weight of each travel dimension index corresponds to a current travel scenario of the vehicle. Each travel dimension index is weighed according to each weight, to obtain a comprehensive travel index of each travel route. According to the comprehensive travel index of each travel route, at least one candidate travel route is selected from at least one travel route, where the comprehensive travel index of the at least one candidate travel route is less than the comprehensive travel indexes of other travel routes than the at least one candidate travel route in the at least one travel route.

For example, when the preset travel route is determined, the remaining drivable mileage of the vehicle and the driving mileage to the end point need to be considered. If the remaining drivable mileage of the vehicle is less than the driving mileage to the end point, an energy-supplementing strategy in the driving process on the preset travel route is determined. That is, when the driving mileage to the end point is greater than the remaining drivable mileage based on the predicted energy consumptionL_{remaining}, the energy-supplementing strategy in the driving process on the preset travel route is determined.

In some embodiments, the energy-supplementing strategy in the driving process on the preset travel route can be determined as follows. The prior-fatigue drivable mileage of the driver is acquired. The prior-fatigue drivable mileage features the drivable mileage before the driver reaches a fatigue driving state. Based on the prior-fatigue drivable mileage and the remaining drivable mileage of the vehicle, the vehicle is controlled to drive to a target charging address for charging or to a target refueling address for refueling.

In some embodiments, based on the prior-fatigue drivable mileage and the remaining drivable mileage of the vehicle, the vehicle is controlled to drive to a target charging address for charging or to a target refueling address for refueling. This process is as follows. If the remaining drivable mileage of the vehicle is greater than or equal to the prior-fatigue drivable mileage and the distance between a first charging address and an end point of the prior-fatigue drivable mileage is less than a first preset distance threshold, the vehicle is controlled to drive to the first charging address for charging. The distance between the first charging address and the end point of the prior-fatigue drivable mileage is less than the distance between other charging addresses and the end point of the prior-fatigue drivable mileage.

In some embodiments, based on the prior-fatigue drivable mileage and the remaining drivable mileage of the vehicle, the vehicle is controlled to drive to a target charging address for charging or to a target refueling address for refueling. This process is as follows. If the remaining drivable mileage of the vehicle is greater than or equal to the prior-fatigue drivable mileage and the distance between a first charging address and an end point of the prior-fatigue drivable mileage is greater than or equal to a first preset distance threshold, the vehicle is controlled to drive to a second charging address for charging. The distance between the first charging address and the end point of the prior-fatigue drivable mileage is less than the distance between other charging addresses and the end point of the prior-fatigue drivable mileage. The second charging address features a charging address previous to the first charging address on the preset travel route.

In some embodiments, based on the prior-fatigue drivable mileage and the remaining drivable mileage of the vehicle, the vehicle is controlled to drive to a target charging address for charging or to a target refueling address for refueling. This process is as follows. If the remaining drivable mileage of the vehicle is less than the prior-fatigue drivable mileage and the difference between the prior-fatigue drivable mileage and the remaining drivable mileage is less than a second preset distance threshold, the vehicle is controlled to drive to a third charging address for charging. The third charging address is located before the end point of the remaining drivable mileage, and the distance between the third charging address and the end point of the remaining drivable mileage is less than the distance between other charging addresses and the end point of the prior-fatigue drivable mileage. Other charging addresses feature the remaining charging addresses than the third charging address in the charging addresses located before the end of the remaining removable mileage.

In some embodiments, based on the prior-fatigue drivable mileage and the remaining drivable mileage of the vehicle, the vehicle is controlled to drive to a target charging address for charging or to a target refueling address for refueling. This process is as follows. If the remaining drivable mileage of the vehicle is less than the prior-fatigue drivable mileage and the difference between the prior-fatigue drivable mileage and the remaining drivable mileage is greater than or equal to a second preset distance threshold, the vehicle is controlled to drive to a target refueling address for refueling. The target refueling address is located before the end point of the remaining drivable mileage, and the distance between the target refueling address and the end point of the remaining drivable mileage is less than the distance between other target refueling addresses and the end point of the prior-fatigue drivable mileage. Other refueling addresses feature the remaining charging addresses other than the target refueling address in the refueling addresses located before the end of the remaining removable mileage.

When the preset travel route is determined, a route-specific vehicle energy consumption corresponding to the preset travel route is predicted, according to the multi-domain fusion information. The route-specific vehicle energy consumption corresponding to the preset travel route can be predicted by any one of the following five methods.

1. By the automobile theoretical energy consumption prediction algorithm, and according to the road traffic flow speed and the static parameters of the vehicle, the route-specific vehicle energy consumption corresponding to the preset travel route is predicted. The route-specific vehicle energy consumption is corrected according to the user behavior information, and the corrected route-specific vehicle energy consumption is a theoretical energy consumption demand.

In some embodiments, the static parameters of the vehicle at least includes: wind resistance, rolling resistance, acceleration resistance, and slope resistance to the vehicle.

In some embodiments, the theoretical energy consumption demand is calculated by a formula below: drive force*road traffic flow speed*time, and the drive force Fₜ=F_{f}+F_{w}+Fᵢ+Fⱼ; where Fₜ represents the drive force, F_{f} represents the rolling resistance, F_{w} represents the air resistance, Fᵢ represents the slope resistance, Fⱼ represents the acceleration resistance.

2. The road type, driving style and vehicle type information are inputted into a target energy consumption prediction model, and the target energy consumption prediction model outputs a predicted route-specific vehicle energy consumption corresponding to the preset travel route, where the route-specific vehicle energy consumption is a reference energy consumption demand. For example, the target energy consumption prediction model is determined from multiple preset energy consumption prediction models according to at least one of the road type of the preset travel route or the driving style information of the user.

In some embodiments, the road type includes: ordinary road, expressway, highway, and congested road.

In some embodiments, the user's driving style is divided into aggressive, ordinary and mild according to the rate of change of the opening of the accelerator pedal and the rate of change of the acceleration.

3. According to the theoretical energy consumption demand and the reference energy consumption demand of the vehicle corresponding to the preset travel route, the route-specific vehicle energy consumption corresponding to the preset travel route is predicted. The theoretical energy consumption demand is calculated by the automobile theoretical energy consumption prediction algorithm, and the reference energy consumption demand is outputted by the target energy consumption prediction model. The theoretical energy consumption demand and the reference energy consumption demand are weighted and added, to predict the route-specific vehicle energy consumption corresponding to the preset travel route.

In some embodiments, a first weight of the theoretical energy consumption demand and a second weight of the reference energy consumption demand are acquired; and the theoretical energy consumption demand and the reference energy consumption demand of the vehicle are weighted according to the first weight and the second weight, to predict the route-specific vehicle energy consumption of the vehicle.

In some embodiments, the sum of the first weight of the theoretical energy consumption demand and the second weight of the reference energy consumption demand is controlled to 1, and the first weight of the theoretical energy consumption demand and the second weight of the reference energy consumption demand are updated with the constraint condition that the actual road section-specific vehicle energy consumption is in a preset range, to obtain the updated first weight of the theoretical energy consumption demand and the updated second weight of the reference energy consumption demand. The first weight of the theoretical energy consumption demand and the second weight of the reference energy consumption demand can be acquired by acquiring the updated first weight of the theoretical energy consumption demand and the updated second weight of the reference energy consumption demand.

In some embodiments, if the predicted road section-specific vehicle energy consumption of the vehicle corresponding to a nth road section is different from the actual road section-specific vehicle energy consumption corresponding to the nth road section, the actual road section-specific vehicle energy consumption of the vehicle corresponding to the nth road section and a model identifier of the target energy consumption prediction model are sent to a server, so that the server can optimize the energy consumption prediction model corresponding to the model identifier based on the actual road section-specific vehicle energy consumption corresponding to the nth road section.

In some embodiments, the road section-specific vehicle energy consumption of the vehicle corresponding to the nth road section is predicted as follows.

The first weight of the theoretical energy consumption demand and the second weight of the reference energy consumption demand of the vehicle corresponding to the nth road section are acquired, where n is a positive integer. The theoretical energy consumption demand and the reference energy consumption demand of the vehicle corresponding to the nth road section are weighted according to the first weight and the second weight, to predict the vehicle energy consumption of the vehicle corresponding to the nth road section.

In some embodiments, after the vehicle travels through the nth road section, the actual road section-specific vehicle energy consumption of the vehicle corresponding to the nth road section is acquired. If the actual road section-specific vehicle energy consumption is in a threshold range, the first weight and the second weight are kept unchanged, where the threshold range is determined according to the predicted road section-specific vehicle energy consumption of the vehicle corresponding to the nth road section.

In some embodiments, the theoretical energy consumption demand and the reference energy consumption demand of the vehicle corresponding to the nth road section are acquired. According to a first initial weight of the theoretical energy consumption demand and a first initial weight of the reference energy consumption demand, the theoretical energy consumption demand and the reference energy consumption demand of the vehicle corresponding to the nth road section are weighted, to obtain a first reference road section-specific vehicle energy consumption corresponding to the nth road section. After the vehicle travels through the nth road section, the actual road section-specific vehicle energy consumption of the vehicle corresponding to the nth road section is acquired. If the actual road section-specific vehicle energy consumption is greater than the first reference road section-specific vehicle energy consumption, the target energy consumption prediction model is optimized.

In some embodiments, the theoretical energy consumption demand and the reference energy consumption demand of the vehicle corresponding to the nth road section are acquired. According to a second initial weight of the theoretical energy consumption demand and a second initial weight of the reference energy consumption demand, the theoretical energy consumption demand and the reference energy consumption demand of the vehicle corresponding to the nth road section are weighted, to obtain a second reference road section-specific vehicle energy consumption corresponding to the nth road section. After the vehicle travels through the nth road section, the actual road section-specific vehicle energy consumption of the vehicle corresponding to the nth road section is acquired. If the actual road section-specific vehicle energy consumption is less than the second reference road section-specific vehicle energy consumption, the target energy consumption prediction model is optimized.

In some embodiments, the first weight of the theoretical energy consumption demand and the second weight of the reference energy consumption demand of the vehicle corresponding to the nth road section can be acquired as follows. The theoretical energy consumption demand and the reference energy consumption demand of the vehicle corresponding to the nth road section in the preset travel route are acquired. According to a first initial weight of the theoretical energy consumption demand and a first initial weight of the reference energy consumption demand, the theoretical energy consumption demand and the reference energy consumption demand of the vehicle corresponding to the nth road section are weighted, to obtain a first reference road section-specific vehicle energy consumption corresponding to the nth road section. According to a second initial weight of the theoretical energy consumption demand and a second initial weight of the reference energy consumption demand, the theoretical energy consumption demand and the reference energy consumption demand of the vehicle corresponding to the nth road section are weighted, to obtain a second reference road section-specific vehicle energy consumption corresponding to the nth road section. After the vehicle travels through the nth road section, the actual road section-specific vehicle energy consumption of the vehicle corresponding to the nth road section is acquired. If the actual road section-specific vehicle energy consumption is greater than the second reference road section-specific vehicle energy consumption and less than the first reference road section-specific vehicle energy consumption, the first weight and the second weight are updated. The updated first weight is used as a current first weight of the theoretical energy consumption demand, and the updated second weight is used as a current second weight of the reference energy consumption demand.

4. By the automobile theoretical energy consumption prediction algorithm, and according to the driving style, the road traffic flow speed, the static parameters of the vehicle, and the target vehicle speed corresponding to the minimum route-specific vehicle energy consumption, the route-specific vehicle energy consumption corresponding to the preset travel route is predicted.

In some embodiments, when the intelligent driving function is enabled and the vehicle speed planning is activated, an operation is triggered that predicts the route-specific vehicle energy consumption corresponding to the preset travel route by the automobile theoretical energy consumption prediction algorithm, according to the user behavior information, the road traffic flow speed, the static parameters of the vehicle, and the target vehicle speed corresponding to the minimum vehicle energy consumption. When the intelligent driving function is enabled and the navigation-assisted driving function is enabled, an operation is triggered that predicts the route-specific vehicle energy consumption corresponding to the preset travel route by the automobile theoretical energy consumption prediction algorithm, according to the user behavior information, the road traffic flow speed, the static parameters of the vehicle, and the target vehicle speed corresponding to the minimum vehicle energy consumption. When the intelligent driving function is enabled the navigation-assisted driving function is disabled, the adaptive cruise control function is enabled, there is no preceding vehicle, and the energy-saving driving guidance function is enabled, an operation is triggered that predicts the route-specific vehicle energy consumption corresponding to the preset travel route by the automobile theoretical energy consumption prediction algorithm, according to the user behavior information, the road traffic flow speed, the static parameters of the vehicle, and the target vehicle speed corresponding to the minimum vehicle energy consumption.

In some embodiments, when the intelligent driving function is disabled and the energy-saving driving guidance function is enabled, an operation is triggered that predicts the route-specific vehicle energy consumption corresponding to the preset travel route by the automobile theoretical energy consumption prediction algorithm, according to the user behavior information, the road traffic flow speed, the static parameters of the vehicle, and the target vehicle speed corresponding to the minimum vehicle energy consumption.

In some embodiments, the energy-saving driving guidance function refers to the function of controlling and guiding the vehicle to travel at the target speed corresponding to the minimum route-specific vehicle energy consumption corresponding to the route.

For example, the target vehicle speed is determined as follows. A speed sequence is generated by taking the minimum route-specific vehicle energy consumption as an objective function according to the road traffic flow speed on the preset travel route and a current vehicle speed of the vehicle, where the current vehicle speed is the vehicle speed of the vehicle at the start point of the preset travel route. The speed sequence is corrected based on a restriction condition, to obtain a corrected speed sequence, where the restriction condition at least includes the driving style. The corrected speed sequence is the target speed, and the target speed is the optimum energy-saving speed.

In some embodiments, the restriction condition further includes one or more of travel time, traffic flow speed information, the acceleration restriction and deceleration restriction, maximum allowable passing speed through an area, and traffic light information.

In some embodiments, the acceleration restriction and deceleration restriction includes physical acceleration and deceleration constraints caused by the characteristics of the vehicle itself; physical restrictions caused by the road conditions, where the road conditions include pavement types such as asphalt, mud, and sand pavements; and differences in environmental factors such as weather and humidity. In an embodiment, according to the driver's historical driving behavior data, the actual acceleration and deceleration habits during driving at different speeds are taken as restrictions to ensure the driver's driving comfort.

In some embodiments, the target vehicle speed is determined as follows. Based on the road traffic flow speed on the preset travel route, the current vehicle speed, and the restriction condition information, a smooth speed sequence is determined, where the restriction condition at least includes the driving style, and the current vehicle speed is the vehicle speed of the vehicle at the start point of the preset travel route. The smooth speed sequence is used as an initial speed solution and inputted into a vehicle model. By taking the minimum route-specific vehicle energy consumption as an objective function, a speed sequence is generated by the vehicle model according to the initial speed solution.

In some embodiments, based on the road traffic flow speed on the preset travel route, the current vehicle speed, and the restriction condition information, a smooth speed sequence is determined, the smooth speed sequence is used as an initial speed solution and inputted into a vehicle model. This process is as follows. Based on the road traffic flow speed on the preset travel route, the current vehicle speed, and the restriction condition information, an average speed is obtained. The speed changes between adjacent road sections are smoothed, to obtain a smooth speed sequence. According to the driving style, the road traffic flow speed, and the location information of traffic lights, the speed on a road section in a different driving scenario is corrected, to partially correct the smooth speed sequence. An initial optimization range of the vehicle model is determined based on the partially corrected smooth speed sequence, and the smooth speed sequence is used as an initial speed solution and inputted into the vehicle model.

In some embodiments, according to the driving style, the road traffic flow speed, and the location information of traffic lights, the speed on a road section in a different driving scenario is corrected, to partially correct the smooth speed sequence. This process is as follows. When the target vehicle speed cannot be maintained due to traveling following other vehicles for a long time, the current acceleration and current vehicle speed of the vehicle, the obstacle speed, and the relative distance to the obstacle are inputted into a vehicle following model, and a partially corrected smooth speed sequence is generated by the vehicle following model by taking the minimum route-specific vehicle energy consumption and the relative distance to the obstacle that is greater than a preset distance threshold as objective functions.

In some embodiments, according to the driving style, the road traffic flow speed, and the location information of traffic lights, the speed on a road section in a different driving scenario is corrected, to partially correct the smooth speed sequence. This process is as follows. When passing through a traffic light intersection, the current acceleration and current vehicle speed of the vehicle, the traffic light information, the obstacle speed, and the relative distance to the obstacle are inputted into an intersection vehicle speed model. A partially corrected smooth speed sequence is generated by the intersection vehicle speed model by taking the minimum route-specific vehicle energy consumption and the traveling time through a traffic light intersection that is less than a preset expected intersection traveling-through time as objective functions.

5. For any candidate travel route, if the route-specific vehicle energy consumption corresponding to any candidate travel route is present in a historical database, the route-specific vehicle energy consumption corresponding to any candidate travel route in the historical database is used as the route-specific vehicle energy consumption of the vehicle corresponding to any candidate travel route. The historical database stores the route-specific vehicle energy consumption corresponding to at least one travel route in a historical time period.

The steps in this embodiment can be made reference to the steps for the control device 50 to predict the route-specific vehicle energy consumption corresponding to the preset travel route according to the multi-domain fusion information, and will not be repeated here.
S1303: A target SOC corresponding to each road section is planed according to the road section-specific vehicle energy consumption corresponding to each road section, to achieve a minimum fuel consumption corresponding to the preset travel route.

In some embodiments, a target SOC corresponding to each road section is planed according to the road section-specific vehicle energy consumption corresponding to each road section, to achieve a minimum fuel consumption corresponding to the preset travel route. This process is as follows. The target SOC corresponding to each road section is planed according to an initial SOC of the power battery and the road section-specific vehicle energy consumption corresponding to each road section, to achieve a minimum fuel consumption corresponding to the preset travel route.

In some embodiments, the target SOC corresponding to each road section can be planed according to the initial SOC of the power battery and the road section-specific vehicle energy consumption corresponding to each road section as follows. According to the initial SOC of the power battery corresponding to each road section and the road section-specific vehicle energy consumption corresponding to each road section, a predicted SOC variation of the vehicle at the end of each road section is determined. According to the predicted SOC variation, multiple SOC varying routes are determined. For example, each SOC varying route includes a group of SOCs. An SOC varying route in the multiple SOC varying routes that enables the vehicle to have the minimum fuel consumption when travels on the preset travel route is determined as a target SOC varying route. The SOCs included in the target SOC varying route is determined as the target SOCs of various road sections.

In some embodiments, the target SOC at the end of the first road section in the preset travel route is determined according to the initial SOC of the vehicle in the preset travel route and the predicted SOC variation corresponding to the first road section.

The target SOC at the end of a non-first road section in the preset travel route is determined according to the predicted SOC variation corresponding to the non-first road section and the target SOC at the end of the road section previous to the non-first road section.

In some embodiments, the predicted SOC variation includes a first predicted SOC variation and a second predicted SOC variation. The upper limit of the target SOC corresponding to the first road section in the preset travel route is determined according to the initial SOC and the first predicted SOC variation corresponding to the first road section. The lower limit of the target SOC corresponding to the first road section is determined according to the initial SOC and the second predicted SOC variation corresponding to the first road section. The upper limit of the target SOC corresponding to the non-first road section in the preset travel route is determined according to the first predicted SOC variation corresponding to the non-first road section and the upper limit of the target SOC corresponding to the road section previous to the non-first road section. The lower limit of the target SOC corresponding to the non-first road section is determined according to the second predicted SOC variation corresponding to the non-first road section and the lower limit of the target SOC corresponding to the road section previous to the non-first road section.

In some embodiments, the SOC corresponding to a target road section in the preset travel route is determined according to a first predicted SOC range corresponding to the target road section and a second predicted SOC range corresponding to the target road section. When the target road section is the first road section in the preset travel route, the first predicted SOC range corresponding to the target road section is determined according to the initial SOC of the vehicle corresponding to the preset travel route and the predicted SOC variation corresponding to the target road section. When the target road section is not the first road section in the preset travel route, the first predicted SOC range corresponding to the target road section is determined according to the upper and lower limit of the target SOC corresponding to the road section previous to the target road section and the predicted SOC variation corresponding to the target road section. When the target road section is the last road section in the preset travel route, the second predicted SOC range corresponding to the target road section is the end SOC of the power battery when the vehicle travels to the end point of the preset travel route. When the target road section is not the last road section in the preset travel route, the second predicted SOC range corresponding to the target road section is determined according to the upper and lower limit of the target SOC corresponding to the road section next to the target road section and the predicted SOC variation corresponding to the road section next to the target road section.

In some embodiments, the upper and lower limit of the target SOC corresponding to the target road section are determined by an intersection of the first predicted SOC range corresponding to the target road section and the second predicted SOC range corresponding to the target road section.

In some embodiments, the predicted SOC variation corresponding to the target road section is determined according to the charging and discharging power range corresponding to the target road section. The charging and discharging power range is obtained according to the road section-specific vehicle energy consumption when the vehicle travels on a corresponding road section, the noise, vibration and harshness (NVH) limited power of the engine of the vehicle, and the maximum charging and discharging power of the power battery, and the route-specific vehicle energy consumption is determined according to the road condition information of the corresponding road section.

In some embodiments, the end SOC is determined according to the initial SOC of the power battery of the vehicle at the start point of the preset travel route.

In some embodiments, when the initial SOC is greater than or equal to a first preset threshold, the end SOC is a second preset threshold; and when the initial SOC is less than the first preset threshold, the end SOC is the first preset threshold, where the second preset threshold is greater than the first preset threshold.

In some embodiments, the preset travel route of the vehicle is divided into at least one road section.

The target state of charge (SOC) after the vehicle travels through each road section is determined.

According to the actual SOC and target SOC of the power battery of the vehicle, the engine and motors of the vehicle are controlled.

In some embodiments, the SOC corresponding to a target road section in the preset travel route is determined according to a first predicted SOC range corresponding to the target road section and a second predicted SOC range corresponding to the target road section.

When the target road section is the first road section in the preset travel route, the first predicted SOC range corresponding to the target road section is determined according to the initial SOC of the vehicle corresponding to the preset travel route and the predicted SOC variation corresponding to the target road section.

When the target road section is not the first road section in the preset travel route, the first predicted SOC range corresponding to the target road section is determined according to the upper and lower limit of the target SOC corresponding to the road section previous to the target road section and the predicted SOC variation corresponding to the target road section.

When the target road section is the last road section in the preset travel route, the second predicted SOC range corresponding to the target road section is the end SOC of the power battery when the vehicle travels to the end point of the preset travel route.

When the target road section is not the last road section in the preset travel route, the second predicted SOC range corresponding to the target road section is determined according to the upper and lower limit of the target SOC corresponding to the road section next to the target road section and the predicted SOC variation corresponding to the road section next to the target road section.

In some embodiments, the upper and lower limit of the target SOC corresponding to the target road section are determined by an intersection of the first predicted SOC range corresponding to the target road section and the second predicted SOC range corresponding to the target road section.

In some embodiments, the target road section included in the preset travel route includes at least one sub-road section, and each sub-road section correspond to sub-road condition information respectively. The target road section is determined based on the sub-road condition information of at least one sub-road section included.

In some embodiments, the sub-road condition information includes: at least one of road type, road name, road traffic sign, road speed limit, congestion level, road length, required traveling time, average vehicle speed, slope, traffic light information, and weather information. For example, the road type includes ordinary road, expressway, highway, and congested road. The congestion level can include high, medium, and low, which is used to reflect different road congestion degrees. The required traveling time is the time required for vehicles to travel from a start point of a sub-road section to an end point of the sub-road section, which can be obtained by big data analysis based on historical data of multiple vehicles traveling on the sub-road section. The average vehicle speed is the average speed of the vehicle traveling on the sub-road section, for example, the average vehicle speed of a vehicle traveling on the sub-road section on which the vehicle control method is performed, or the average vehicle speed of multiple vehicles traveling on the sub-road section. For example, if the average vehicle speed of vehicle 1 traveling on the sub-road section is 10 m/s, the average vehicle speed of vehicle 2 traveling on the sub-road section is 11 m/s, and the average vehicle speed of vehicle 3 traveling on the sub-road section is 9 m/s, then the average vehicle speed on the sub-road section can be determined to be (10+11+9)/3=10 m/s based on the average vehicle speeds of vehicles 1, 2 and 3.

In some embodiments, the sub-road condition information and the target road section meet at least one of the following conditions: the sub-road condition information includes the road type, and all the sub-road sections included in the target road section have the same road type; or the sub-road condition information includes the average vehicle speed, and the average vehicle speeds on all the sub-road sections included in the target road section fall within the same vehicle speed range.

In some embodiments, one road section can be determined as follows. At least two adjacent sub-road sections having the same road type are combined and used as a pre-divided road section. If the average vehicle speed on a sub-road section adjacent to the pre-divided road section and the average vehicle speed on the sub-road sections in the pre-divided road section fall within the same vehicle speed range, the pre-divided road section and the adjacent sub-road section are combined and used as one road section in the preset travel route.

In some embodiments, the sub-road condition information includes the road length of the sub-road section. After determining the road section based on the sub-road condition information of each sub-road section, the road length of each road section needs to be greater than or equal to a preset length threshold. By restricting the road length of each road section, the number of divided road sections can be ensured not to be too large, to reduce the computational complexity.

In some embodiments, the target road section in the preset travel route is obtained based on a road interval having road characteristic parameters that are successfully matched with road condition data of a preset road condition, where the road interval is obtained from the preset travel route according to the road condition data of the preset travel route, and the road characteristic parameters of the road interval are determined according to historical driving parameters of vehicles on the road section.

In some embodiments, the target road section in the preset travel route is outputted by a neural network model trained in advance, where the input of the neural network model includes the road condition data of the preset travel route.

In some embodiments, the road condition information of the target road section is obtained according to the sub-road condition information of the sub-road section included in the target road section.

In some embodiments, the target SOC corresponding to the target road section in the preset travel route is determined as follows. According to the target SOC corresponding to the road section previous to the target road section and the road condition information of the target road section, the target SOC corresponding to the target road section is determined. In an embodiment, according to the target SOC corresponding to the road section next to the target road section and the road condition information of the road section next to the target road section, the target SOC corresponding to the target road section is determined.

In some embodiments, the determination of the target SOC corresponding to the target road section according to the target SOC corresponding to the road section previous to the target road section and the road condition information of the target road section includes the following steps. According to the road condition information of the target road section, an SOC variation after the vehicle travels through the target road section is determined. According to the target SOC corresponding to the road section previous to the target road section and the SOC variation corresponding to the target road section, the target SOC corresponding to the target road section is determined.

In some embodiments, the determination of the target SOC corresponding to the target road section according to the target SOC corresponding to the road section next to the target road section and the road condition information of the road section next to the target road section includes the following steps. According to the road condition information of the road section next to the target road section, an SOC variation after the vehicle travels through the road section next to the target road section is determined. According to the target SOC corresponding to the road section next to the target road section and the SOC variation corresponding to the road section next to the target road section, the target SOC corresponding to the target road section is determined.

In some embodiments, the target SOC is determined as follows. The initial SOC of the power battery of the vehicle corresponding to the preset travel route is acquired; and the target SOC corresponding to each road section is determined according to the initial SOC and the road condition information of each road section.

In some embodiments, both the sub-road condition information and the road condition information include the road type; and the road type of the target road section is the target road type in the road types of various sub-road sections included in the target road section. For example, the sub-road section corresponding to the target road type accounts for the highest proportion in all sub-road sections included in the target road section.

In some embodiments, the sub-road condition information and the road condition information both include the average vehicle speed and the road length, and the average vehicle speed on the target road section is calculated based on the average vehicle speed on and the road length of each sub-road section in the target road section, where the road length of the target road section is the sum of the road lengths of various sub-road sections in the target road section.

In some embodiments, the determination of the target SOC corresponding to each road section according to the initial SOC and the road condition information corresponding to each road section includes the following steps. The route-specific vehicle energy consumption corresponding to the preset travel route is predicted according to the road condition information of the preset travel route and the energy consumption affecting information. The target SOC of the power battery corresponding to each road section is determined according to the initial SOC of the power battery and the road section-specific vehicle energy consumption corresponding to each road section, to achieve the minimum fuel consumption corresponding to the preset travel route.

In some embodiments, the determination of the target SOC corresponding to each road section according to the road condition information of each road section and the end SOC includes the following steps. According to the road condition information of each road section, an SOC variation after the vehicle travels through each road section is determined. According to the end SOC and the SOC variation corresponding to each road section, the target SOC corresponding to each road section is determined.

In some embodiments, assuming that the preset travel route includes k road sections, where k is a positive integer, the end SOC is the target SOC corresponding to the kth road section; and the target SOC corresponding to an (i−1)^{th} road section is calculated according to the target SOC corresponding to an i^{th} road section and the SOC variation corresponding to the i^{th} road section, where i=2, 3, 4, . . . , k.

In some embodiments, the road condition information includes the road type, the congestion level, and the road length. The SOC variation corresponding to the target road section in the preset travel route is determined according to the power consumption per unit length and the road length of the target road section, where the power consumption per unit length of the target road section is determined according to the road type and congestion level of the target road section.

In some embodiments, the power consumption per unit length of the target road section is obtained by querying a preset table according to the road type and the congestion level of the target road section.

In some embodiments, after the vehicle travels through a preset road length of road, the to-be-updated power consumption per unit length in the preset table is updated according to the actual power consumption per unit length of the vehicle on the preset road length of road.

In some embodiments, the to-be-updated power consumption per unit length in the preset table is updated to the actual power consumption per unit length.

In some embodiments, the to-be-updated power consumption per unit length in the preset table is updated to a target power consumption per unit length, where the target power consumption per unit length is calculated according to the to-be-updated power consumption per unit length, a first weight corresponding to the to-be-updated power consumption per unit length, the actual power consumption per unit length, and a second weight corresponding to the actual power consumption per unit length.

In some embodiments, the road condition information includes the road type, the congestion level, and the required traveling time. The SOC variation corresponding to the target road section in the preset travel route is determined according to the SOC change rate corresponding to the target road section and the required traveling time, where the SOC change rate corresponding to the target road section is determined according to the road type and the congestion level of the target road section.

In some embodiments, the determination of the target SOC corresponding to each road section according to the initial SOC and the road condition information corresponding to each road section includes the following steps. According to the initial SOC and the road condition information of each road section, the target SOC of the vehicle at the end of each road section is determined; and according to the target SOC of the vehicle at the end of each road section is determined, the target SOC corresponding to each road section is determined.

In some embodiments, multiple SOC varying routes are determined according to the target SOCs. For example, each SOC varying route includes a group of SOCs. an SOC varying route in the multiple SOC varying routes that enables the vehicle to have the minimum energy consumption when travels on the preset travel route is determined as a target SOC varying route. The SOCs included in the target SOC varying route are determined as the target SOCs corresponding to various road sections.

In some embodiments, the target SOC at the end of the first road section in the preset travel route is determined according to the initial SOC and the road condition information of the first road section. The target SOC at the end of a non-first road section in the preset travel route is determined according to the road condition information of the non-first road section and the target SOC at the end of a road section previous to the non-first road section.

In some embodiments, the upper and lower limit of the target SOC corresponding to the first road section are determined according to the initial SOC and the road condition information of the first road section. The upper limit of the target SOC corresponding to the non-first road section is determined according to the road condition information of the non-first road section and the upper limit of the target SOC corresponding to the road section previous to the non-first road section. The lower limit of the target SOC corresponding to the non-first road section is determined according to the road condition information of the non-first road section and the lower limit of the target SOC corresponding to the road section previous to the non-first road section.

According to the road condition information of the road section and the upper limit of the target SOC corresponding to the previous road section, a third SOC is determined, where the third SOC is the SOC of the battery when the vehicle travels in the hybrid mode to the end of the road section. According to the road condition information of the road section and the lower limit of the target SOC corresponding to the previous road section, a fourth SOC is determined, where the fourth SOC is the SOC of the battery when the vehicle travels in the pure-electric mode to the end of the road section. The third SOC is taken as the upper limit and the fourth SOC is taken as the lower limit, to obtain the target SOC of the vehicle at the end of the road section.

In some embodiments, the determination of the target SOC corresponding to each road section according to the initial SOC and the road condition information corresponding to each road section includes the following steps. The end SOC of the power battery when the vehicle travels to the end point of the preset travel route is determined according to the initial SOC. According to the initial SOC, the end SOC, and the road condition information of the preset travel route, the target SOC of the vehicle at the end of each road section in the preset travel route is determined. According to the target SOC, the target SOC corresponding to each road section in the preset travel route is determined.

In some embodiments, the target SOC corresponding to a target road section in the preset travel route is determined according to a first target SOC and a second target SOC corresponding to the target road section. When the target road section is the first road section in the preset travel route, the first target SOC corresponding to the target road section is determined according to the initial SOC and the road condition information of the target road section. When the target road section is not the first road section in the preset travel route, the first target SOC corresponding to the target road section is determined according to the first target SOC corresponding to a road section previous to the target road section and the road condition information of the target road section. When the target road section is the last road section in the preset travel route, the second target SOC of the target road section is determined according to the end SOC and the road condition information of the target road section. When the target road section is not the last road section in the preset travel route, the second target SOC of the target road section is determined according to the second target SOC of a road section next to the target road section and the road condition information of the target road section.

In some embodiments, the first target SOC corresponding to the target road section is determined according to the charging and discharging power range corresponding to the target road section, the road condition information of the target road section, and the initial SOC. The second target SOC corresponding to the target road section is determined according to the charging and discharging power range corresponding to the target road section, the road condition information of the target road section, and the end SOC. The charging and discharging power range corresponding to the target road section is obtained according to the road section-specific vehicle energy consumption when the vehicle travels on the target road section, the noise, vibration and harshness (NVH) limited power of the engine of the vehicle, and the maximum charging and discharging power of the power battery, and the road section-specific vehicle energy consumption corresponding to the target road section is determined according to the road condition information of the target road section.

The road section-specific vehicle energy consumption after the vehicle travels through a road section is determined according to the road condition information of the road section. According to the road condition information, the initial SOC, the road section-specific vehicle energy consumption, the NVH limited power of the engine of the vehicle, and the maximum charging and discharging power of the power battery. The first target SOC of the vehicle at the end of the road section is determined. For example, the NVH limited power is a power threshold obtained by limiting the power of the engine considering that the NVH performance of the engine needs to reach a certain index.

The road section-specific vehicle energy consumption after the vehicle travels through a road section is determined according to the road condition information of the road section. According to the road condition information, the end SOC, the vehicle energy consumption, the NVH limited power of the engine of the vehicle, and the maximum charging and discharging power of the power battery, the second target SOC of the vehicle at the start of a road section is determined.

According to the road section-specific vehicle energy consumption, the NVH limited power, and the and the maximum charging and discharging power, the charging and discharging power range corresponding to each road section is obtained. According to the initial SOC, the road condition information, and the charging and discharging power range, the first target SOC is determined.

According to the road section-specific vehicle energy consumption, the NVH limited power, and the and the maximum charging and discharging power, the charging and discharging power range corresponding to each road section is obtained. According to the end SOC, the road condition information, and the charging and discharging power range, the second target SOC is determined.

In some embodiments, the road section-specific vehicle energy consumption corresponding to the target road section is obtained by a target energy consumption prediction model after the road condition information of the target road section and the driving style information of the user are inputted into the target energy consumption prediction model, where the target energy consumption prediction model is determined from multiple preset energy consumption prediction models according to the road condition information of the target road section and the driving style information of the user.

According to the road condition information of the road section and the driving style information of the user, the target energy consumption prediction model is determined from multiple preset energy consumption prediction models. The road condition information of the road section and the driving style information of the user are inputted into the target energy consumption prediction model, to obtain the vehicle energy consumption corresponding to the road section outputted by the target energy consumption prediction model.

For example, the road condition information, the driving style information, the vehicle condition, and the vehicle setting habit of the user are inputted into the target energy consumption prediction model, to obtain the road section-specific vehicle energy consumption outputted by the model, thus improving the accuracy of the prediction result. For example, the vehicle condition includes the vehicle weight, the wind resistance coefficient, the rolling resistance coefficient, and the tyre pressure, etc. The vehicle setting habit may include the air conditioner setting habit.

In some embodiments, one SOC is selected from the target SOC corresponding to each road section; and one SOC varying route among multiple SOC varying routes is obtained according to various SOCs.

In some embodiments, methods such as dynamic planning algorithm and Pontryagin's minimum principle (PMP) algorithm can be used to determine the target SOC varying route from multiple SOC varying routes that can minimize the energy consumption when the vehicle runs on the preset travel route. In these algorithms, the target SOC corresponding to each road section is used as a feasible region of a state variable. For the sake of numerical calculation, the feasible region needs to be discretized, that is, the target SOC corresponding to each road section is discretized. For example, it can be discretized at equal intervals. If the difference between the maximum and minimum SOC corresponding to a certain road section is greater than 0.005, it can be discretized at intervals of 0.005. If difference between the maximum and minimum SOC corresponding to a certain road section is less than 0.005, the SOC is discretized into three equal parts. The control variables include the operation mode, and the engine operating point (torque, and speed). For example, the operation mode includes pure electric, series and parallel. To reduce the computational power demand and speed up the calculation process, the feasible region of the engine operating point can be simplified, and the engine operating point in series and parallel mode is the control line calculated when the system efficiency is optimum. The NVH restriction needs to be considered to optimize the solution of the engine operating point, and the NVH constraint is simplified as a constraint line only related to the vehicle speed to constrain the rotational speed of the engine. By solving the optimization problem in the calculated feasible region, a target SOC varying route corresponding to the minimum energy consumption can be obtained. The SOCs included in the target SOC varying route can be taken as the target SOCs corresponding to various road sections in the preset travel route.

In some embodiments, when the initial SOC is greater than or equal to a first preset threshold, the end SOC is a second preset threshold, where the second preset threshold is greater than the first preset threshold; and when the initial SOC is less than the first preset threshold, the end SOC is the first preset threshold.

In some embodiments, the step of controlling, according to the actual SOC and target SOC of the power battery of the vehicle, the engine and the motors of the vehicle is as follows. The actual SOC of the power battery of the vehicle when the vehicle travels on a target road section in the preset travel route is acquired. For example, the target road section may be any road section in the preset travel route. According to the actual SOC and the target SOC corresponding to the target road section, the vehicle is controlled to travel in the pure electric mode or non-pure electric mode.

In some embodiments, the step of controlling, according to the actual SOC and the target SOC corresponding to the target road section, the vehicle to travel in the pure electric mode or non-pure electric mode is as follows.

When the vehicle speed of the vehicle is greater than or equal to the preset vehicle speed threshold, if the difference between the actual SOC and the target SOC is greater than or equal to a preset difference, the vehicle is controlled to travel in the pure electric mode; and if the difference between the actual SOC and the target SOC is less than the preset difference, the vehicle is controlled to travel in the hybrid mode.

In some embodiments, the step of controlling, according to the actual SOC and the target SOC corresponding to the target road section, the vehicle to travel in the pure electric mode or non-pure electric mode is as follows. When the vehicle speed of the vehicle is less than the vehicle speed threshold, the vehicle is controlled to travel in the pure electric mode. For example, considering the engine characteristics, when the vehicle speed of the vehicle is less than the vehicle speed threshold, the engine is not allowed to start. Therefore, if the vehicle speed of the vehicle is less than the vehicle speed threshold, the vehicle is directly switched to travel in the pure electric mode.

In some embodiments, the vehicle speed threshold is positively correlated with the actual SOC of the power battery. That is, when the actual SOC of the power battery increases, the corresponding vehicle speed threshold increases accordingly; and when the actual SOC of the power battery decreases, the corresponding vehicle speed threshold decreases accordingly. For example, the vehicle speed threshold can be obtained by experimental calibration.

In some embodiments, if the preset travel route includes only one road section, the step of controlling, according to the actual SOC and target SOC of the power battery of the vehicle, the engine and the motors of the vehicle is as follows. The road section-specific vehicle energy consumption after the vehicle travels through a road section is determined according to the road condition information of the road section. When the initial SOC is greater than the end SOC: if the SOC difference is greater than or equal to the vehicle energy consumption, the vehicle is controlled to travel in the pure electric mode; and if the SOC difference is less than the vehicle energy consumption, the vehicle is controlled to travel in the hybrid mode to maintain the actual SOC of the power battery to be the initial SOC, and then the vehicle is controlled to travel in the pure electric mode. When the initial SOC is less than or equal to the end SOC, the vehicle is controlled to travel in the hybrid mode.

In some embodiments, the step of controlling, according to the actual SOC and target SOC of the power battery of the vehicle, the engine and the motors of the vehicle is as follows.

When the target SOC corresponding to the target road section is less than the initial SOC corresponding to the target road section: if the actual SOC of the power battery is greater than the minimum allowable SOC or the target SOC corresponding to the target road section, the vehicle is controlled to travel in the pure electric mode on the target road section; and if the actual SOC of the power battery is equal to the minimum allowable SOC or the target SOC corresponding to the target road section, the vehicle is controlled to travel in the hybrid mode to maintain the actual SOC of the power battery.

When the target SOC corresponding to the target road section is greater than the initial SOC corresponding to the target road section: if the actual SOC of the power battery is less than the maximum allowable SOC or the target SOC corresponding to the target road section, the vehicle is controlled to travel in the hybrid mode on the target road section; and if the actual SOC of the power battery is equal to the maximum allowable SOC or the target SOC corresponding to the target road section, the vehicle is controlled to travel in the hybrid mode to maintain the actual SOC of the power battery; and if the actual SOC of the power battery is greater than the maximum allowable SOC or the target SOC corresponding to the target road section, the vehicle is controlled to travel in the pure electric mode on the target road section.

In some embodiments, the step of controlling, according to the actual SOC and target SOC of the power battery of the vehicle, the engine and the motors of the vehicle is as follows. According to the road condition information of the target road section in the preset travel route, a category coefficient of the target road section is determined. According to the target SOC corresponding to the target road section and the category coefficient of the target road section, an equivalent factor corresponding to the target road section is determined. By using the equivalent factor corresponding to the target road section and the equivalent consumption minimum strategy (ECMS), the instantaneous output power of the power battery of the vehicle at each moment on the target road section operation is determined. The vehicle is controlled according to the instantaneous output power.

In some embodiments, the equivalent factor corresponding to the target road section is obtained by querying a table according to the category coefficient of the target road section and the target SOC.

In some embodiments, the instantaneous output power of the power battery when the vehicle travels on the target road section is calculated by a formula below:

$$arg H ( u , SOC ( t ) , t ) = arg {\dot{m}}_{eng} ( u , t ) + s ( t ) * S \dot{O} C ( t ) .$$

In some embodiments, the steps of controlling the vehicle according to the instantaneous output power is as follows. The power demand of the vehicle at moment t is acquired. According to the vehicle power demand, the instantaneous output power of the power battery at time t, and the NVH limited power of the engine, the instantaneous output power of the engine at moment t is determined. According to the instantaneous output power of the power battery at moment t and the instantaneous output power of the engine at moment t, the power battery and the engine.

In some embodiments, considering that some unexpected situations may occur when the vehicle travels on the preset travel route, in view of this, when the vehicle travels on the target road section, if the difference between the actual SOC of the power battery of the vehicle and the target SOC corresponding to the target road section is greater than a set threshold, the target SOC is determined again. When the location of the vehicle deviates from the preset travel route, the target SOC is determined again. When the vehicle travels on the target road section, if the road condition of the target road section changes, the target SOC is determined again.

In some embodiments, the preset travel route includes a start point and an end point. If the end point of the preset travel route has a charging condition, the end SOC when the vehicle travels to the end point is reduced.

In some embodiments, the reduced end SOC satisfies the minimum allowable SOC of the vehicle.

In some embodiments, the end point of the preset travel route having a charging condition includes the following situation. If a charging address is present at the end point and an idle charging pile is present at the charging address the end point is determined to have a charging condition.

In some embodiments, when the vehicle travels to the end point of any road section, the target SOC corresponding to a remaining road section is updated according to the target SOC of the power battery corresponding to any road section and the predicted road section-specific vehicle energy consumption corresponding to the remaining road section to achieve the minimum fuel consumption corresponding to the preset travel route.

In some embodiments, if the road condition information is updated, road section division is re-performed on the remaining travel route, to obtain at least one new road section. The remaining travel route is a route from a current location of the vehicle to the end point of the preset travel route in the preset travel route. The target SOC corresponding to each new road section is updated according to the initial SOC of the power battery and the road section-specific vehicle energy consumption corresponding to each new road section, to achieve the minimum fuel consumption corresponding to the preset travel route.

The steps in this embodiment can be made reference to the steps for the control device 50 to plan the target SOC corresponding to each road section according to the road section-specific vehicle energy consumption corresponding to each road section, to achieve the minimum fuel consumption corresponding to the preset travel route; and will not be repeated here.
S1304: According to the target SOC and the actual vehicle demand corresponding to each road section, the engine, the drive motor, the electric generator, and the power battery are controlled, to enable the engine to operate in an efficient operating interval during operation.

In some embodiments, according to the initial SOC, the target SOC, and the actual vehicle demand corresponding to each road section, the engine, the drive motor, the electric generator, and the power battery are controlled, to enable the engine to operate in an efficient operating interval during operation. This process is as follows. If the target SOC is greater than the initial SOC by a certain threshold, and the actual vehicle demand is less than a vehicle demand enabling the engine to operate in a high-efficiency and economic zone, the engine is controlled to drive the electric generator efficiently to generate electricity, and the excess electricity is stored in the power battery. If the target SOC is greater than the initial SOC by a certain threshold, and the actual vehicle demand is greater than or equal to a vehicle demand enabling the engine to operate in a high-efficiency and economic zone, the engine is controlled to operate in a high-efficiency operating interval and supply energy to the power battery, and the vehicle is driven by the drive motor, or the drive motor and the engine. If the target SOC is less than the initial SOC by a certain threshold, the engine is controlled to stop.

In some embodiments, the vehicle is controlled to travel on the preset travel route based on the target vehicle speed.

In some embodiments, prompt information is generated based on the target vehicle speed corresponding to the minimum vehicle energy consumption, where the prompt information is used to prompt the driver to control the vehicle to travel based on the target vehicle speed corresponding to the minimum vehicle energy consumption.

In some embodiments, the prompt information includes at least one of the target vehicle speed or pedal control information.

In some embodiments, according to the target SOC and the actual vehicle demand corresponding to each road section and the reduced end SOC when the vehicle travels to the end point, the engine, the drive motor, the electric generator, and the power battery are controlled, to enable the engine to operate in an efficient operating interval during operation.

In some embodiments, if the self-start function of the navigation system is disabled, the navigation system is off, and the preset travel route is a commuter route, the control device is further configured to: control, according to corresponding historical traveling data of the vehicle on the commuter route, the engine, the drive motor, the electric generator, and the power battery, to enable the engine to operate in an efficient operating interval during operation.

In some embodiments, the historical driving data includes a vehicle speed sequence when the vehicle travels through the commuter route in a historical time period.

In some embodiments, if the self-start function of the navigation system is disabled, the navigation system is off, and the preset travel route is not a commuter route, the control device 50 is further configured to: predict, when the vehicle travels on the preset travel route, the vehicle speed of the vehicle in a preset time period, to obtain a predicted vehicle speed of the vehicle in the preset time period; predict, according to the predicted vehicle speed in the preset time period, a component control sequence of the vehicle in the preset time period; and control, according to a first control instruction in the component control sequence, a corresponding component, where the component includes at least one of the throttle and the pedal.

In some embodiments, the component includes at least one of the throttle and the pedal. The component control sequence includes at least one control instruction on the component. Controlling the corresponding component refers to controlling the corresponding component to execute the first control instruction.

In some embodiments, the preset time period refers to a time period having a first preset duration that has elapsed since the last time the corresponding component is controlled according to the control instruction. For example, after traveling based on the predicted vehicle speed in 5 to 10 sec, the vehicle speed in the future 5 to 10 sec is further predicted. For example, the first preset duration may be future 5 to 10 sec.

In some embodiments, the vehicle speed of the vehicle in a preset time period is predicted, to obtain a predicted vehicle speed of the vehicle in the preset time period. This process as follows. When the intelligent driving function is disabled, the historical traveling data of the vehicle in a preset historical time period is acquired; and the vehicle speed of the vehicle in the preset time period is predicted according to the historical traveling data, to obtain the predicted vehicle speed of the vehicle in the preset time period.

In some embodiments, the historical traveling data includes a vehicle speed sequence. The vehicle speed of the vehicle in the preset time period is predicted according to the historical traveling data, to obtain a predicted vehicle speed of the vehicle in the preset time period. This process as follows. The vehicle speed sequence is divided, to obtain at least one vehicle speed interval. A vehicle speed state transition probability corresponding to a vehicle speed state transition from a vehicle speed state corresponding to a target vehicle speed interval in the at least one vehicle speed interval to a vehicle speed state corresponding to a vehicle speed interval next to the target vehicle speed interval is acquired, to construct a system state transition probability matrix. The target vehicle speed interval is any vehicle speed interval in the at least one vehicle speed interval, and the system state transition probability matrix includes at least one transition probability. According to the system state transition probability matrix and the vehicle speed of the vehicle at the current moment, the vehicle speed at each moment in the preset time period is predicted, to obtain the predicted vehicle speed of the vehicle in the preset time period.

In some embodiments, According to the system state transition probability matrix and the vehicle speed of the vehicle at the current moment, the vehicle speed at each moment in the preset time period is predicted, to obtain a predicted vehicle speed of the vehicle in the preset time period. The process is as follows. According to a speed change limit of the vehicle and a traffic flow speed limit, the system state transition probability matrix is corrected. According to the corrected system state transition probability matrix and the vehicle speed of the vehicle at the current moment, the vehicle speed at each moment in the preset time period is predicted, to obtain the predicted vehicle speed of the vehicle in the preset time period.

In some embodiments, a short-term predicted operating condition is obtained according to the predicted vehicle speed. This process as follows. According to the corrected system state transition probability matrix and the predicted vehicle speed in the preset time period, the operating condition of the vehicle in the preset time period is predicted, to obtain the short-term predicted operating condition. The short-term predicted operating condition includes the predicted vehicle speed of the vehicle in the preset time period.

In some embodiments, when a distance to a preceding vehicle or a speed relative to the preceding vehicle is determined not to meet a safe traveling condition, the vehicle is controlled to brake.

In some embodiments, if the intelligent driving function is enabled, the navigation-assisted driving function is disabled, the adaptive cruise control function is enabled, there is no preceding vehicle, and the vehicle speed planning is not activated, the control device is further configured to control the vehicle to travel based on the current vehicle speed.

In some embodiments, if the intelligent driving function is enabled, the navigation-assisted driving function is disabled, the adaptive cruise control function is enabled, there is a preceding vehicle, and the vehicle speed planning is not activated, the control device is further configured to acquire a current vehicle speed of the preceding vehicle ahead the vehicle; and control the vehicle to travel based on the current vehicle speed of the preceding vehicle.

In some embodiments, When the intelligent driving function is enabled the navigation-assisted driving function is disabled, the adaptive cruise control function is enabled, there is a preceding vehicle, and the vehicle speed planning is activated, an operation is triggered that generates a speed sequence according to the road traffic flow speed on the preset travel route and the current vehicle speed of the vehicle by taking the minimum route-specific vehicle energy consumption as an objective function, where the current vehicle speed is the vehicle speed of the vehicle at the start point of the preset travel route; corrects the speed sequence based on a restriction condition, to obtain a corrected speed sequence, where the restriction condition at least includes the driving style; a current vehicle speed of the preceding vehicle ahead the vehicle is triggered; according to the current vehicle speed of the preceding vehicle and the target vehicle speed of the vehicle, a control vehicle speed of the vehicle is determined; and the vehicle is controlled to travel based on the control vehicle speed.

In some embodiments, when the intelligent driving function is enabled the navigation-assisted driving function is disabled, and the adaptive cruise control function is disabled, a vehicle speed of the vehicle in a preset time period is predicted according to acquired intelligent driving sensing data, to obtain a predicted vehicle speed of the vehicle in the preset time period. The vehicle is controlled to travel based on the predicted vehicle speed.

In some embodiments, according to the target SOC and actual vehicle demand corresponding to each road section, traffic light information, and an energy management strategy based on navigation information fusion, the engine, the drive motor, the electric generator, and the power battery are controlled, to enable the engine to operate in an efficient operating interval during operation. This process as follows. According to the current vehicle speed of the vehicle and the traffic light information, it is determined whether the vehicle is able to pass through a signalized intersection where a traffic light corresponding to the traffic light information is located. If the vehicle is not able to pass through the signalized intersection where the traffic light corresponding to the traffic light information is located, an allowed traveling time of the vehicle is calculated, the engine is controlled to operate efficiently or stop, the vehicle is controlled to travel based on the current vehicle speed of the vehicle during the allowed traveling time, at the end of the allowed traveling time, mechanical braking is inactivated, and a preset energy recovery level is activated.

In some embodiments, the allowed traveling time of the vehicle is calculated. This process as follows. A distance by which the vehicle can coast is calculated; according to the distance by which the vehicle can coast and a distance between the vehicle and the traffic light, an allowed traveling distance of the vehicle is determined; and according to the allowed traveling distance and the current vehicle speed of the vehicle, the allowed traveling time of the vehicle is determined.

When none of the above strategies is satisfied, an electricity supply ensuring SOC is adjusted according to the driving style, the current vehicle speed of the vehicle, or current environmental information where the vehicle is located. According to a comparison result of an actual SOC and an adjusted electricity supply ensuring SOC of the vehicle, the engine, the drive motor, the electric generator, and the power battery are controlled, to enable the engine to operate in an efficient operating interval during operation.

In some embodiments, the temperature of the power battery is adjusted according to the state of charge, the preset travel route, and an appointed boarding time of the user.

In some embodiments, a target passenger compartment temperature is generated according to a current passenger compartment temperature and the appointed boarding time of the user, and the passenger compartment temperature in the vehicle is controlled through an air conditioner to reach the target passenger compartment temperature.

In some embodiments, when the target passenger compartment temperature is greater than the current passenger compartment temperature, cooling water of the engine is controlled to provide pre-heating.

In some embodiments, the temperature of the power battery is adjusted according to the state of charge, the preset travel route, and an appointed boarding time of the user.

In some embodiments, the target temperature deviation value is acquired during the traveling process of the vehicle the target passenger compartment temperature is corrected according to the target temperature deviation value, and the passenger compartment temperature of the vehicle is controlled to reach the corrected target passenger compartment temperature.

In some embodiments, the target temperature deviation value is acquired during the traveling process of the vehicle as follows.

During the traveling process of the vehicle, a temperature influencing factor is collected, where the temperature influencing factor includes at least one of vehicle information and environmental information. The vehicle information includes at least one of window opening information, engine water temperature, navigation time, and the target temperature deviation value. The environmental information includes at least one of weather information and the temperature outside the vehicle. The target temperature deviation value is determined according to the temperature deviation value corresponding to the temperature influencing factor.

In some embodiments, the temperature influencing factor corresponds to multiple temperature deviation values. The target temperature deviation value is determined according to the temperature deviation value corresponding to the temperature influencing factor as follows. A mileage of the preset travel route is acquired. If the mileage is greater than a third preset distance threshold, a first temperature deviation value in the multiple temperature deviation values is determined as the target temperature deviation value, where the first temperature deviation value is smaller than the other temperature deviation values in the multiple temperature deviation values than the first temperature deviation value.

In some embodiments, the temperature influencing factor corresponds to multiple temperature deviation values.

The target temperature deviation value is determined according to the temperature deviation value corresponding to the temperature influencing factor as follows. A mileage of the preset travel route is acquired. If the mileage is less than or equal to a third preset distance threshold and the target passenger compartment temperature is greater than the current passenger compartment temperature, a first temperature deviation value in the multiple temperature deviation values is determined as the target temperature deviation value, where the first temperature deviation value is smaller than the other temperature deviation values in the multiple temperature deviation values than the first temperature deviation value.

In some embodiments, the temperature influencing factor corresponds to multiple temperature deviation values. The target temperature deviation value is determined according to the temperature deviation value corresponding to the temperature influencing factor as follows. A mileage of the preset travel route is acquired. If the mileage is less than or equal to a third preset distance threshold and the target passenger compartment temperature is less than the current passenger compartment temperature, a second temperature deviation value in the multiple temperature deviation values is determined as the target temperature deviation value, where the second temperature deviation value is greater than the other temperature deviation values in the multiple temperature deviation values than the second temperature deviation value.

In some embodiments, an output duration of a to-be-outputted power of the engine is predicted, and the engine is started when the output duration is greater than a third preset duration.

In some embodiments, a traffic congestion time of the vehicle is predicted, and a water temperature of the engine is increased when an interval between a current time and the traffic congestion time is a fourth preset duration.

In some embodiments, the water temperature of the engine is increased by reducing a pump speed of the engine or reducing a fan speed of the engine.

In some embodiments, an end point of the preset travel route is predicted; the adjustment of the water temperature of the engine according to a target water temperature deviation of the engine is stopped when a distance between the current location of the vehicle and the end point is less than a preset distance; and the water temperature of the engine is increased, until the water temperature of the engine is higher than a preset temperature threshold before the vehicle reaches the end point.

In some embodiments, an end point of the preset travel route is predicted; the adjustment of the temperature of the power battery according to a target temperature deviation of the power battery is stopped when a distance between the current location of the vehicle and the end point is less than a preset distance; and the temperature of the power battery is adjusted, until the temperature of the power battery is in a preset temperature interval before the vehicle reaches the end point.

In some embodiments, an end point of the preset travel route is predicted; the control of the passenger compartment temperature of the vehicle to reach a target passenger compartment temperature is stopped when a distance between the current location of the vehicle and the end point is less than a preset distance; and the target passenger compartment temperature is corrected.

The steps in this embodiment can be made reference to the above-mentioned steps where the control device 50 controls, according to the target SOC and the actual vehicle demand corresponding to each road section, the engine 10, the drive motor 20, the electric generator 30, and the power battery 40, to enable the engine 10 to operate in an efficient operating interval during operation and the steps for pre-heating management, and will not be repeated here.

In some embodiments of the present disclosure, the target SOC corresponding to each road section is planned to achieve a minimum fuel consumption corresponding to the travel route, and the vehicle is controlled according to the target SOC and the actual vehicle demand corresponding to each road section, to realize the reasonable allocation of fuel and electricity in a hybrid electric vehicle, and reduce the fuel consumption and vehicle usage cost of the vehicle. The engine, the drive motor, the electric generator, and the power battery are controlled, to enable the engine to operate in an efficient operating interval during operation, improve the NVH performance of the engine, avoid the frequent start and stop of the engine, and improve the driving and riding comfort. The route-specific vehicle energy consumption corresponding to the preset travel route is predicted according to the multi-domain fusion information, that is, the route-specific vehicle energy consumption is predicted by fusing the cockpit domain and power domain information, to improve the accuracy of energy consumption prediction, and further improve the fuel saving performance. Pre-heating management is performed before and during traveling, and by optimizing the heating or cooling power according to the heating or cooling requirement, the passenger compartment is slowly pre-heated or pre-cooled in advance, so as to reduce the energy loss caused by high current, thereby reducing the power consumption of the air conditioner and accessories in a high-temperature or low-temperature environment, and reducing the fuel consumption.

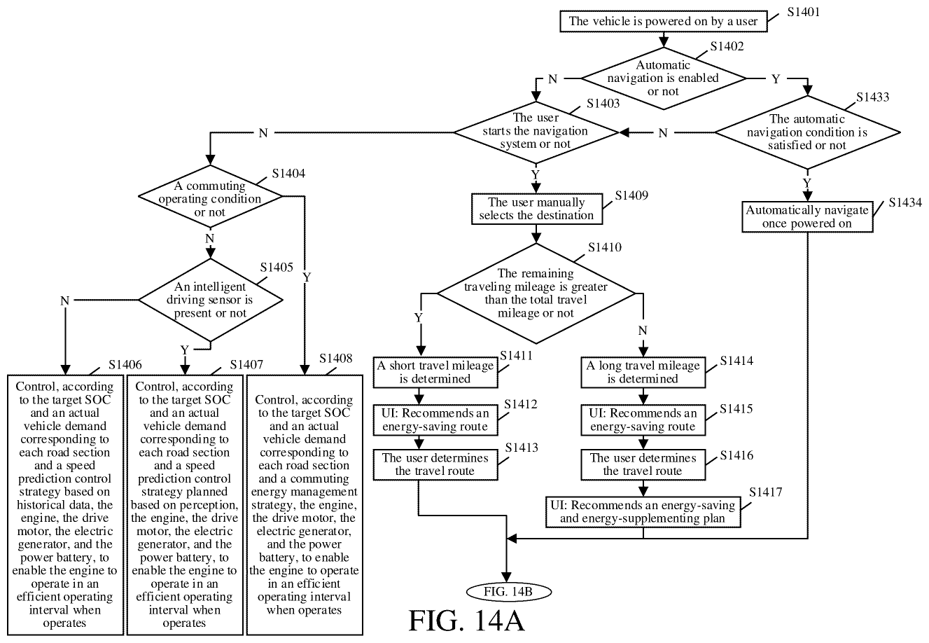

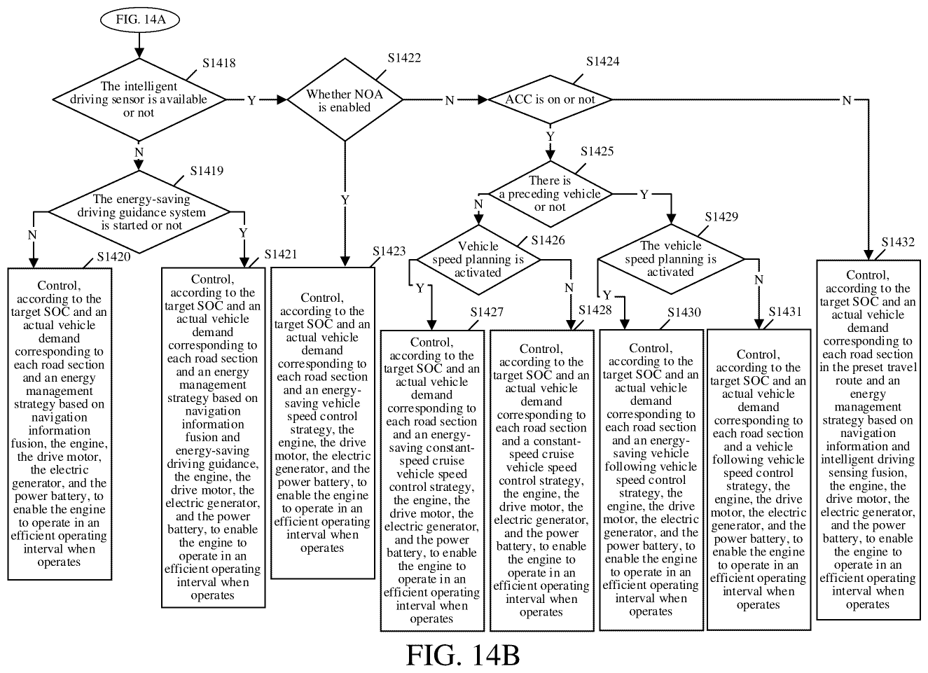

Based on the above description, referring to FIGS. 14A and 14B, FIG. 14A schematically shows a first flowchart of another control method for an intelligent energy management system for a new energy vehicle according to some embodiments of the present disclosure. FIG. 14B schematically shows a second flowchart of another control method for an intelligent energy management system for a new energy vehicle according to some embodiments of the present disclosure. The control method for an intelligent energy management system for a new energy vehicle shown in FIG. 14A and FIG. 14B includes, without limitation, Steps S1401-S1434.
S1401: The vehicle is powered on by a user.
S1402: Whether automatic navigation is on is determined.

In some embodiments, the vehicle has an automatic navigation switch. When automatic navigation is enabled, whether automatic navigation is on is determined after the vehicle is powered on. If automatic navigation is off, Step S1403 is performed; and if automatic navigation is on, S1433 is performed.
S1403: Whether the user starts the navigation system is determined.

In some embodiments, if automatic navigation is off, whether the user manually starts the navigation system is determined. If the user does not start the navigation system, Step S1404 is performed; and if the user manually starts the navigation system, Step S1409 is performed.
S1404: Whether the traveling operating condition is a commuting operating condition is determined.

In some embodiments, the traveling operating condition is identified by identifying the pattern of historical traveling data. When the traveling operating condition is a commuting operating condition, Step S1408 is performed; and when the traveling operating condition is not a commuting operating condition, Step S1405 is performed.
S1405: Whether the vehicle has an intelligent driving sensor is determined.

In some embodiments, if the vehicle has an intelligent driving sensor, Step S1407 is performed; and if the vehicle does not an intelligent driving sensor, Step S1406 is performed. For example, the intelligent driving sensor may be a laser radar, a millimeter wave radar, a camera, and other sensors.
S1406: According to a target SOC and an actual vehicle demand corresponding to each road section and a speed prediction and control strategy based on historical data, the engine, the drive motor, the electric generator, and the power battery are controlled, to enable the engine to operate in an efficient operating interval during operation.

In some embodiments, for a scenario where the navigation system and pathfinding are not started, the vehicle has no intelligent driving sensor, future traveling information cannot be identified, and the historical data is identified to be erratic, the engine, the drive motor, the electric generator, and the power battery are controlled according to a target SOC and an actual vehicle demand corresponding to each road section and a speed prediction and control strategy based on historical data, to enable the engine to operate in an efficient operating interval during operation.

In some embodiments, if the self-start function of the navigation system is disabled, the navigation system is off, and the preset travel route is not a commuter route, the vehicle speed of the vehicle in a preset time period is predicted when the vehicle travels on the preset travel route, to obtain a predicted vehicle speed of the vehicle in the preset time period. According to the predicted vehicle speed in the preset time period, a component control sequence of the vehicle in the preset time period is predicted. According to a first control instruction in the component control sequence, a corresponding component is controlled, where the component includes at least one of the throttle and the pedal.

In some embodiments, the component includes at least one of the throttle and the pedal. The component control sequence includes at least one control instruction on the component. Controlling the corresponding component refers to controlling the corresponding component to execute the first control instruction.

In some embodiments, for example, the preset time period is future 5 to 10 sec, and the vehicle speed in the future 5 to 10 sec is predicted by using historical data or an intelligent driving sensor. According to the predicted vehicle speed in the preset time period, a component control sequence of the vehicle in the preset time period is predicted according to the predicted vehicle speed in the preset time period, where the component includes at least one of the throttle and the pedal. According to a first control instruction in the component control sequence, a corresponding component is controlled. The other control instructions in the component control sequence are sequentially executed for optimization. Through the optimization in the preset time period, the fuel consumption of the user can be reduced.

In some embodiments, the preset time period refers to a time period having a first preset duration that has elapsed since the last time the corresponding component is controlled according to the control instruction. For example, after traveling based on the predicted vehicle speed in 5 to 10 sec, the vehicle speed in the future 5 to 10 sec is further predicted. For example, the first preset duration may be future 5 to 10 sec.

In some embodiments, the vehicle speed of the vehicle in a preset time period is predicted, to obtain a predicted vehicle speed of the vehicle in the preset time period. This process is as follows. When the intelligent driving function is disabled, historical traveling data of the vehicle in a preset historical time period is acquired. The vehicle speed of the vehicle in the preset time period is predicted according to the historical traveling data, to obtain a predicted vehicle speed of the vehicle in the preset time period.

In some embodiments, when the intelligent driving function is disabled the vehicle speed of the vehicle in future 5 to 10 sec is predicted according to the historical traveling data, to obtain a predicted vehicle speed of the vehicle in the future 5 to 10 sec. The preset time period may be future 5 to 10 sec.

In some embodiments, the historical traveling data includes a vehicle speed sequence. The vehicle speed of the vehicle in the preset time period is predicted according to the historical traveling data, to obtain a predicted vehicle speed of the vehicle in the preset time period. This process is as follows. The vehicle speed sequence is divided, to obtain at least one vehicle speed interval. A vehicle speed state transition probability corresponding to a vehicle speed state transition from a vehicle speed state corresponding to a target vehicle speed interval in the at least one vehicle speed interval to a vehicle speed state corresponding to a vehicle speed interval next to the target vehicle speed interval is acquired, to construct a system state transition probability matrix. The target vehicle speed interval is any vehicle speed interval in the at least one vehicle speed interval, and the system state transition probability matrix includes at least one transition probability. According to the system state transition probability matrix and a vehicle speed of the vehicle at a current moment, the vehicle speed at each moment in the preset time period is predicted, to obtain a predicted vehicle speed of the vehicle in the preset time period.

In some embodiments, the vehicle speed sequence is divided, to obtain at least one vehicle speed interval. A system state transition probability matrix is constructed, where the system state transition probability matrix represents a vehicle speed state transition probability corresponding to a vehicle speed state transition from a vehicle speed state corresponding to a target vehicle speed interval to a vehicle speed state corresponding to a vehicle speed interval next to the target vehicle speed interval. According to the system state transition probability matrix and a vehicle speed of the vehicle at a current moment, the vehicle speed at each moment in the preset time period is predicted, to obtain a predicted vehicle speed of the vehicle in the preset time period.

In some embodiments, according to the system state transition probability matrix and a vehicle speed of the vehicle at a current moment, the vehicle speed at each moment in the preset time period is predicted, to obtain a predicted vehicle speed of the vehicle in the preset time period. The process is as follows. According to a speed change limit of the vehicle and a traffic flow speed limit, the system state transition probability matrix is corrected. According to the corrected system state transition probability matrix and the vehicle speed of the vehicle at the current moment, the vehicle speed at each moment in the preset time period is predicted, to obtain a predicted vehicle speed of the vehicle in the preset time period.

In some embodiments, the vehicle speed sequence is divided, to obtain at least one vehicle speed interval. A system state transition probability matrix is constructed, where the system state transition probability matrix represents a vehicle speed state transition probability corresponding to a vehicle speed state transition from a vehicle speed state corresponding to a target vehicle speed interval to a vehicle speed state corresponding to a vehicle speed interval next to the target vehicle speed interval. According to a speed change limit of the vehicle and a traffic flow speed limit, the system state transition probability matrix is corrected. According to the corrected system state transition probability matrix and the vehicle speed of the vehicle at the current moment, the vehicle speed at each moment in the preset time period is predicted, to obtain a predicted vehicle speed of the vehicle in the preset time period. For example, a rolling time window mode is adopted for short-term recording of the vehicle speed, and the vehicle speed is recorded as Vt|p={vt-i: 1≤i≤p}, where to meet the accuracy of short-term prediction, the value of p may be 40. Vehicle speed intervals are divided according to the historical data of the vehicle, and a probability pmij of the vehicle speed changing from a current vehicle speed interval to another vehicle speed interval at a next moment is calculated, to construct a system state transition probability matrix Pm=(pmij)n×n. Considering the speed change limit of the vehicle and the traffic flow speed limit obtained above, the system state transition probability matrix Pm is corrected. For example, the traffic flow speed is an average speed to limit the maximum and minimum speeds of the vehicle in the future traveling process, and the speed change limit of the vehicle affects a corresponding maximum acceleration or maximum deceleration of the vehicle, limiting a speed change range between adjacent moments. According to the system state transition probability matrix and the current vehicle speed, the most probable vehicle speed interval at the next moment is predicted. For example, the current vehicle speed is 20 kilometers per hour, and the most probable vehicle speed interval at the next moment is predicted according to the transition probability matrix to be a vehicle speed interval of 20 kilometers per hour to 30 kilometers per hour. A predicted future speed at moment f is calculated based on Vt|f=vt|tΠPm(n), n=1, and 2, . . . f. A predicted future speed sequence, the acceleration and speed of the preceding vehicle, the relative distance to the preceding vehicle are obtained, For example, it is assumed by default that the acceleration of the preceding vehicle tends to remain unchanged in the future. The above data is substituted into a vehicle longitudinal dynamics model to calculate whether a safe driving condition is met. If the safe driving condition is met, the predicted vehicle speed in the preset time period is outputted. If the safe driving condition is not met, a safety warning is given.

In some embodiments, a short-term predicted operating condition is obtained according to the predicted vehicle speed. This process is as follows. According to the corrected system state transition probability matrix and the predicted vehicle speed in the preset time period, the operating condition of the vehicle in the preset time period is predicted, to obtain the short-term predicted operating condition. The short-term predicted operating condition includes the predicted vehicle speed of the vehicle in the preset time period.
S1407: According to the target SOC and the actual vehicle demand corresponding to each road section and a speed prediction and control strategy based on sensing planning, the engine, the drive motor, the electric generator, and the power battery are controlled, to enable the engine to operate in an efficient operating interval during operation.

In some embodiments, for a scenario where the navigation system and pathfinding are not started, the vehicle has an intelligent driving sensor, future traveling information cannot be identified, and the historical data is identified to be erratic, the engine, the drive motor, the electric generator, and the power battery are controlled according to the target SOC and the actual vehicle demand corresponding to each road section and a speed prediction and control strategy based on sensing planning, to enable the engine to operate in an efficient operating interval during operation.

In some embodiments, the vehicle speed of the vehicle in a preset time period is predicted, to obtain a predicted vehicle speed of the vehicle in the preset time period. This process is as follows.

When the intelligent driving function is enabled the vehicle speed of the vehicle in the preset time period is predicted according to intelligent driving sensor data, to obtain a predicted vehicle speed of the vehicle in the preset time period.

In some embodiments, for example, the preset time period is future 5 to 10 sec. Current vehicle information and ambient environment information is collected by an intelligent driving sensor such as a laser radar, a millimeter wave radar, and a camera, and a predicted vehicle speed in the future 5 to 10 sec is calculated.

In some embodiments, When the driver releases the throttle and there is no drive demand, before a back electromotive force of the vehicle motor is less than a withstand voltage of a high-voltage device, the motor control device preferentially shut off the wave, and the vehicle coasts without motor braking, to convert the kinetic energy of the vehicle into a traveling distance.

In some embodiments, when a distance to a preceding vehicle or a speed relative to the preceding vehicle is determined not to meet a safe traveling condition, the vehicle is controlled to brake.

In some embodiments, when the intelligent driving sensor identifies the distance to the preceding vehicle or the speed relative to the preceding vehicle does not meet the safe traveling condition mechanical braking is activated to intervene in the control, to ensure the safety of the user during traveling.
S1408: According to the target SOC and actual vehicle demand corresponding to each road section and a commuting energy management strategy, the engine, the drive motor, the electric generator, and the power battery are controlled, to enable the engine to operate in an efficient operating interval during operation.

In some embodiments, if the self-start function of the navigation system is disabled, the navigation system is off, and the preset travel route is a commuter route, the engine, the drive motor, the electric generator, and the power battery are controlled according to corresponding historical traveling data of the vehicle on the commuter route, to enable the engine to operate in an efficient operating interval during operation.

In some embodiments, prediction is performed by identifying the pattern of historical traveling data. For example, if the preset travel route is determined to be a commuter route by identifying the historical traveling data, the traveling operating condition of the vehicle is a commuting operating condition, which is regarded as the future traveling operating condition. If the identification is unsuccessful, the prediction is failed. For example, the traveling data used for storage and prediction are mainly data related to vehicle energy consumption, such as speed, slope, and power demand.

According to the target SOC and actual vehicle demand corresponding to each road section and the commuting energy management strategy, the engine the drive motor, the electric generator, and the power battery are controlled, to enable the engine to operate in an efficient operating interval during operation.

In some embodiments, the historical driving data includes a vehicle speed sequence when the vehicle travels through the commuter route in a historical time period.

In some embodiments, the historical driving data includes a vehicle speed sequence when the vehicle travels through the commuter route in a historical time period. The engine, the drive motor, the electric generator and the power battery are controlled through the vehicle speed sequence, according to the target SOC and the actual vehicle demand corresponding to each road section and the commuting energy management strategy, to enable the engine to operate in an efficient operating interval during operation.

In some embodiments, referring to FIG. 10, FIG. 10 schematically shows an energy management based on historical traveling data according to some embodiments of the present disclosure.

For example, during operating condition identification, the operating condition is identified according to the average slope and average vehicle speed information per kilometer, and the identification result and operating condition information are recorded. If the identified operating condition follows a certain pattern, the operating condition is predicted. Based on historical commuting data of the latest month, a future operating condition sequence is predicted, and an SOC trajectory is planned. Based on the predicted operating condition sequence and the vehicle state, usage of electricity along the whole commuter route is planned. Based on a determination made by an end point charging condition module, an ending target SOC value is adjusted. Provided that the traveling demand is met, the power distribution is adjusted, so that the actual SOC changes with the target SOC, finally realizing the improvement of the cost-effectiveness of the vehicle on the commuter route. If the identified operating condition does not follow a certain pattern, it is determined whether intelligent driving is on. When the intelligent driving is on, a future short-term operating condition is predicted based on sensing information. When the driver releases the throttle, the intelligent driving identifies a distance to the preceding vehicle, and a speed relative to the preceding vehicle, and the vehicle coasts without motor braking while ensuring a safety distance. When the intelligent driving is not on, the operating condition is predicted by constructing a statistical transition probability matrix based on historical data, or predicted by using a time-series prediction algorithm based on historical data.
S1409: The user manually selects an end point.

In some embodiments, if the user manually starts the navigation system, the user manually selects an end point.

In some embodiments, the preset travel route is determined as follows. If the self-start function of the navigation system is disabled, the preset travel route is determined in response to the end point inputted by the user.

In some embodiments, the preset travel route is determined in response to the end point inputted by the user as follows.

At least one candidate energy-saving route is determined according to the start point and the end point of the vehicle. A predicted route-specific vehicle energy consumption corresponding to the at least one candidate energy-saving route is less than predicted route-specific vehicle energy consumptions corresponding to other routes. The route-specific vehicle energy consumption is predicted according to multi-domain fusion information of each route.

The preset travel route is determined in response to the operation of selecting at least one candidate energy-saving route. The preset travel route refers to the selected candidate energy-saving route. The preset travel route includes multiple road sections, and the route-specific vehicle energy consumption includes road section-specific vehicle energy consumptions corresponding to the multiple road sections.

In some embodiments, according to the start point and the end point of the vehicle, at least one candidate energy-saving route is calculated, where which is the route corresponding to the lowest energy consumption in the whole traveling process. The user can select, for example, one candidate energy-saving route as the preset travel route. The preset travel route refers to the selected candidate energy-saving route. The preset travel route includes multiple road sections, and the route-specific vehicle energy consumption includes road section-specific vehicle energy consumptions corresponding to the multiple road sections.
S1410: Whether a remaining drivable mileage is greater than a total travel mileage is determined.

In some embodiments, when the remaining drivable mileage is greater than the total travel mileage of the preset travel route, Step S1411 is performed; and when the remaining drivable mileage is less than or equal to the total travel mileage, Step S1414 is performed.
S1411: A short travel mileage is determined.

In some embodiments, when the remaining drivable mileage is greater than the total travel mileage of the preset travel route, a short travel mileage is determined.
S1412: User interface (UI): recommends an energy-saving route.

In some embodiments, UI may be an instrument, a pad, or a head up display (HUD). UI recommends an energy-saving route to the user, where the energy-saving route is a route corresponding to a minimum route-specific vehicle energy consumption, or at least one route corresponding to a route-specific vehicle energy consumption that is less than a preset energy consumption threshold.
S1413: The user determines a travel route.

In some embodiments, the user determines a travel route, that is, the preset travel route, from the energy-saving route recommended by UI. For example, the steps of determining the preset travel route can be made reference to the above-mentioned steps where the control device 50 determines the preset travel route, and will not be repeated here.
S1414: A long travel mileage is determined.

In some embodiments, when the remaining drivable mileage is less than or equal to the total travel mileage, a long travel mileage is determined, and an energy-saving and energy-supplementing plan needs to be recommended.
S1415: UI: recommends an energy-saving route.

In some embodiments, UI recommends an energy-saving route to the user.
S1416: The user determines a travel route.

In some embodiments, the user determines a travel route, that is, the preset travel route, from the energy-saving route recommended by UI. For example, the steps of determining the preset travel route can be made reference to the above-mentioned steps where the control device 50 determines the preset travel route, and will not be repeated here.
S1417: UI: recommends an energy-saving and energy-supplementing plan.

In some embodiments, when the remaining drivable mileage is less than or equal to the total travel mileage, UI recommends an energy-saving and energy-supplementing plan to the user. For example, the steps of determining the energy-saving and energy-supplementing plan can be made reference to the above-mentioned steps where the control device 50 determines an energy supplementing strategy during traveling on the preset travel route, and will not be repeated here.
S1418: Whether an intelligent driving sensor is available is determined.

In some embodiments, if an intelligent driving sensor is available, Step S1422 is performed; and if no intelligent driving sensor is available, Step S1419 is performed.
S1419: Whether an energy-saving driving guidance system is started is determined.

In some embodiments, if the energy-saving driving guidance system is not started, Step S1420 is performed; and if the energy-saving driving guidance system is started, Step S1421 is performed. For example, the energy-saving driving guidance refers to the controlling and guiding of the vehicle to travel at a target vehicle speed corresponding to the minimum route-specific vehicle energy consumption. When the vehicle is driven by the user manually, the energy-saving driving guidance is mainly indicated in the form of a reference vehicle speed, which can be interacted with the user through a display interface such as an instrument or a Pad. For example, a target vehicle speed is displayed on an instrument, and the user is guided to control the vehicle to travel at the target vehicle speed corresponding to the minimum route-specific vehicle energy consumption.
S1420: According to a target SOC and an actual vehicle demand corresponding to each road section and an energy management strategy based on navigation information fusion, the engine, the drive motor, the electric generator, and the power battery are controlled, to enable the engine to operate in an efficient operating interval during operation.

In some embodiments, the energy management strategy based on navigation information fusion can be made reference to the above-mentioned steps where the control device 50 predicts the route-specific vehicle energy consumptions 1, 2, and 3 corresponding to the preset travel route, will not be repeated here.

In some embodiments, according to a current vehicle speed of the vehicle and traffic light information, it is determined whether the vehicle is able to pass through a signalized intersection where a traffic light corresponding to the traffic light information is located. If the vehicle is not able to pass through the signalized intersection where the traffic light corresponding to the traffic light information is located, an allowed traveling time of the vehicle is calculated, the engine is controlled to operate efficiently or stop, the vehicle is controlled to travel based on the current vehicle speed of the vehicle during the allowed traveling time, at the end of the allowed traveling time, mechanical braking is inactivated, and a preset energy recovery level is activated.

In some embodiments, the allowed traveling time of the vehicle is calculated as follows. A distance by which the vehicle can coast is calculated; according to the distance by which the vehicle can coast and a distance between the vehicle and the traffic light, an allowed traveling distance of the vehicle is determined; and according to the allowed traveling distance and the current vehicle speed of the vehicle, the allowed traveling time of the vehicle is determined.

In some embodiments, the energy management strategy based on navigation information fusion further includes partial correction based on traffic light information fusion. The step in this embodiment can be made reference to the above-mentioned step implemented by the control device 50 according to the navigation information fusion-based energy management strategy further including traffic light information fusion for partial correction, and will not be repeated here.

In some embodiments, the energy management strategy based on navigation information fusion further includes an automatic navigation method for commuting, when automatic navigation is enabled and the preset travel route is a commuter route. The step in this embodiment can be made reference to the step implemented by the control device 50 according to the navigation information fusion-based energy management strategy further including an automatic navigation method for commuting, and will not be repeated here.
S1421: According to a target SOC and an actual vehicle demand corresponding to each road section and an energy management strategy based on navigation information fusion and energy-saving driving guidance, the engine, the drive motor, the electric generator, and the power battery are controlled, to enable the engine to operate in an efficient operating interval during operation.

In some embodiments, the energy management strategy based on navigation information fusion can be made reference to the above-mentioned steps where the control device 50 predicts the route-specific vehicle energy consumptions 1, 2, and 3 corresponding to the preset travel route, and will not be repeated here. The energy-saving driving guidance refers to the controlling and guiding of the vehicle to travel at a target vehicle speed corresponding to the minimum route-specific vehicle energy consumption. For example, the target vehicle speed is displayed on an instrument, and the user is guided to control the vehicle to travel at the target vehicle speed corresponding to the minimum route-specific vehicle energy consumption. For example, the determination of the target vehicle speed can be made reference to the step of determining the target vehicle speed by the control device 50, and will not be repeated here.
S1422: Whether navigate on autopilot is on (NOA) is determined.

In some embodiments, If NOA is on, Step S1423 is performed; and if NOA is off, Step S1424 is performed.
S1423: According to the target SOC and the actual vehicle demand corresponding to each road section and an energy-saving vehicle speed control strategy, the engine, the drive motor, the electric generator, and the power battery are controlled, to enable the engine to operate in an efficient operating interval during operation.

In some embodiments, if NOA is on, the engine, the drive motor, the electric generator, and the power battery are controlled according to the target SOC of the power battery and the actual vehicle demand corresponding to each road section and an energy-saving vehicle speed control strategy, to enable the engine to operate in an efficient operating interval during operation, so as to achieve the minimum fuel consumption corresponding to the preset travel route. For example, the determination of the energy-saving vehicle speed, that is, the target vehicle speed, can be made reference to the step of determining the target vehicle speed by the control device 50, and will not be repeated here. After the target vehicle speed is determined, the vehicle is controlled to travel at the target vehicle speed.
S1424: Whether adaptive cruise control (ACC) is on is determined.

In some embodiments, If ACC is on, Step S1425 is performed; and if ACC is off, Step S1432 is performed.
S1425: Whether there is a preceding vehicle is determined.

In some embodiments, if there is a preceding vehicle, Step S1429 is performed; and if there is no preceding vehicle, Step S1426 is performed.
S1426: Whether vehicle speed planning is activated is determined.

In some embodiments, if vehicle speed planning is activated, Step S1427 is performed; and if vehicle speed planning is not activated, Step S1428 is performed.
S1427: According to the target SOC and the actual vehicle demand corresponding to each road section and an energy-saving constant-speed cruise vehicle speed control strategy, the engine, the drive motor, the electric generator, and the power battery are controlled, to enable the engine to operate in an efficient operating interval during operation.

In some embodiments, the energy-saving constant-speed cruise vehicle speed control strategy is to control the vehicle to travel based on a target vehicle speed. For example, the determination of the target vehicle speed can be made reference to the step of determining the target vehicle speed by the control device 50, and will not be repeated here.
S1428: According to the target SOC and the actual vehicle demand corresponding to each road section and a constant speed cruise vehicle speed control strategy, the engine, the drive motor, the electric generator, and the power battery are controlled, to enable the engine to operate in an efficient operating interval during operation.

In some embodiments, if the intelligent driving function is enabled, the navigation-assisted driving function is disabled, the adaptive cruise control function is enabled, there is no preceding vehicle, and the vehicle speed planning is not activated, the vehicle is controlled to travel based on the current vehicle speed.
S1429: Whether vehicle speed planning is activated is determined.

In some embodiments, if vehicle speed planning is activated, Step S1430 is performed; and if vehicle speed planning is not activated, Step S1431 is performed.
S1430: According to the target SOC and the actual vehicle demand corresponding to each road section and an energy-saving vehicle following vehicle speed control strategy, the engine, the drive motor, the electric generator, and the power battery are controlled, to enable the engine to operate in an efficient operating interval during operation.

In some embodiments, when the intelligent driving function is enabled the navigation-assisted driving function is disabled, the adaptive cruise control function is enabled, there is a preceding vehicle, and the vehicle speed planning is activated, an operation of determining, based on a road traffic flow speed and a current vehicle speed, a target vehicle speed corresponding to the minimum vehicle energy consumption corresponding to each road section is triggered.

A current vehicle speed of the preceding vehicle ahead the vehicle is acquired.

According to the current vehicle speed of the preceding vehicle and the energy-saving vehicle speed of the vehicle, a control vehicle speed of the vehicle is determined; and the vehicle is controlled to travel based on the control vehicle speed.

In some embodiments, when the current vehicle speed of the preceding vehicle is greater than or equal to the energy-saving vehicle speed of the vehicle, the control vehicle speed of the vehicle is the energy-saving vehicle speed. When the current vehicle speed of the preceding vehicle is less than the energy-saving vehicle speed of the vehicle, the control vehicle speed of the vehicle is the current vehicle speed of the preceding vehicle. For example, the determination of the energy-saving vehicle speed, that is, the target vehicle speed, can be made reference to the step of determining the target vehicle speed by the control device 50, and will not be repeated here.
S1431: According to the target SOC and the actual vehicle demand corresponding to each road section and a vehicle following vehicle speed control strategy, the engine, the drive motor, the electric generator, and the power battery are controlled, to enable the engine to operate in an efficient operating interval during operation.

In some embodiments, if the intelligent driving function is enabled, the navigation-assisted driving function is disabled, the adaptive cruise control function is enabled, there is a preceding vehicle, and the vehicle speed planning is not activated, the vehicle following vehicle speed control strategy is to acquire a current vehicle speed of the preceding vehicle ahead the vehicle; and the vehicle is controlled to travel based on the current vehicle speed of the preceding vehicle.
S1432: According to the target SOC, and the actual vehicle demand corresponding to each road section and an energy management strategy based on navigation information and intelligent driving sensing fusion, the engine, the drive motor, the electric generator, and the power battery are controlled, to enable the engine to operate in an efficient operating interval during operation.

In some embodiments, the energy management strategy based on navigation information can be made reference to the above-mentioned steps where the control device 50 predicts the route-specific vehicle energy consumptions 1, 2, and 3 corresponding to the preset travel route, will not be repeated here. The energy management strategy based on intelligent driving sensing is to collect current vehicle information and ambient environment information by intelligent driving sensors such as a laser radar, a millimeter wave radar, and a camera, and calculate a predicted vehicle speed in future 5 to 10 sec.

In some embodiments, when the intelligent driving function is enabled the navigation-assisted driving function is disabled, and the adaptive cruise control function is disabled, a vehicle speed of the vehicle in a preset time period is predicted according to acquired intelligent driving sensing data, to obtain a predicted vehicle speed of the vehicle in the preset time period. The vehicle is controlled to travel based on the predicted vehicle speed.

In some embodiments, the preset time period is, for example, future 5 to 10 sec. Current vehicle information and ambient environment information is collected by intelligent driving sensors such as a laser radar, a millimeter wave radar, and a camera, and a predicted vehicle speed in the future 5 to 10 sec is calculated. The vehicle is controlled to travel based on the predicted vehicle speed.

In some embodiments, when none of the above strategies is satisfied, the method further includes the following steps. An electricity supply ensuring SOC is adjusted according to the driving style, the current vehicle speed of the vehicle, or current environmental information where the vehicle is located. The operating state of the engine is controlled according to a comparison result of an actual SOC of the vehicle and an adjusted electricity supply ensuring SOC.

In some embodiments, according to information such as driving style, vehicle speed, plateau, and low temperature, electricity supply ensuring SOCs under different historical operating conditions are dynamically adjusted to meet the vehicle demand. The operating mode, engine start-stop, and power distribution are dynamically adjusted by comparing the actual SOC with the electricity supply ensuring SOC. The electricity supply ensuring SOC may be the target SOC.
S1433: Whether an automatic navigation condition is satisfied is determined.

In some embodiments, if automatic navigation is on, whether an automatic navigation condition is satisfied is determined. For example, the automatic navigation condition include a time condition and an address condition. When the vehicle usage moment and the vehicle usage address are satisfied, Step S1434 is performed; and when the vehicle usage moment and the vehicle usage address are not satisfied, Step S1403 is performed.
S1434: Automatic navigation is started once powered on.

In some embodiments, when the automatic navigation condition is satisfied, that is, the vehicle usage moment and the vehicle usage address are both satisfied, automatic navigation is started after the vehicle is powered on.

In some embodiments of the present disclosure, a corresponding energy management strategy is determined according to the navigation information, the information about the traveling operating condition, the information from an intelligent driving sensor, the information from an energy-saving guidance system, and the information about the preceding vehicle. According to an initial SOC of the power battery, the road section-specific vehicle energy consumption, and the actual vehicle demand corresponding to each road section, and the corresponding energy management strategy, the operating state of the engine is controlled. By fusion with the traffic flow information, traffic light information, charging pile information, driving style information, and others, the start-stop timing and operating point of the engine are optimized, the operating efficiency of the system is improved, and the fuel consumption of the user is reduced. The fusion control further reduces the start and stop of the engine, and the pure-electric mode is adopted when traveling at a low speed, which increases the proportion of pure-electric mode and makes the driving experience closer to that in the pure-electric mode.

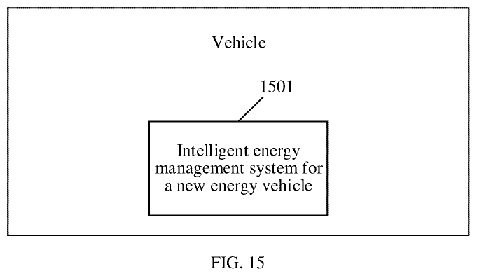

Some embodiments of the present disclosure further provides a vehicle. Referring to FIG. 15, FIG. 15 is a block diagram of a vehicle according to some embodiments of the present disclosure. As shown in FIG. 15, the vehicle includes an intelligent energy management system 1501 for a new energy vehicle.

For example, the intelligent energy management system 1501 for a new energy vehicle can perform the operations performed by the control device in the control method for an intelligent energy management system for a new energy vehicle. For example, the intelligent energy management system 1501 for a new energy vehicle is configured to
acquire multi-domain fusion information, where the multi-domain fusion information at least includes cockpit domain information and power domain information, for example, the cockpit domain information at least includes user behavior information and road condition information of a preset travel route, and the power domain information at least includes vehicle state information;
predict a route-specific vehicle energy consumption corresponding to the preset travel route according to the multi-domain fusion information, where the preset travel route includes multiple road sections, and the route-specific vehicle energy consumption includes road section-specific vehicle energy consumptions corresponding to the multiple road sections;
plan, according to the road section-specific vehicle energy consumption corresponding to each road section, a target SOC corresponding to each road section, to achieve a minimum fuel consumption corresponding to the preset travel route; and
control, according to the target SOC and an actual vehicle demand corresponding to each road section, the engine, the drive motor, the electric generator, and the power battery, to enable the engine to operate in an efficient operating interval during operation.

In a practical implementation process, the intelligent energy management system 1501 for a new energy vehicle described in some embodiments of the present disclosure can perform the implementations performed by the control device in the control method for an intelligent energy management system for a new energy vehicle provided in some embodiments of the present disclosure, which will not be further described here.

In some embodiments, the power domain control module mentioned below is the control device involved in the above embodiments. The power domain control module may be a multi-function multi-core chip highly integrated control device. For example, a seven-in-one control device can be adopted. That is, 7 functions, including an electric generator control device, a drive motor control device, a DC/DC boost converter unit, a vehicle Control Unit (VCU), a power distribution unit (PDU), a DC/DC buck converter unit, and an on board charger (OBC) are integrated into a power domain control module having a light weight, where the whole weight is reduced by 22.5% compared with the traditional discrete products.

In some examples, the vehicle disclosed in the present disclosure further includes an execution and auxiliary device of intelligent energy management based on the coordination of human, vehicles, and roads, which is configured to receive an execution instruction sent from the power domain control module and then perform vehicle energy management, and further achieves energy saving and improves the driving experience by using a high-efficiency, integrated, and light-weight design. These devices include an integrated heat pump, a double flow-layer box, a driver shaft decoupled rear shaft, a rear three-in-one system, a cell to body (CTB) battery, a dedicated engine for hybrid electric vehicles, and an electric hybrid system (EHS), etc.

The integrated heat pump is a heat pump system that performs cooling and heating management after receiving an execution instruction from the power domain control module, and integrates the pipeline and refrigerant valves to solve the problem of difficult control and layout in the front cabin in hybrid electric vehicle, by which the pipes are reduced by 27%, thus reducing the weight of the vehicle and realizing energy saving.

The double flow-layer box means that the air-conditioning box in the vehicle adopts a double-layer design, which separates the internal and external circulation in the upper space and the lower space in the vehicle passenger compartment after receiving an execution instruction from the power domain control module, so as to meet the different needs of the passengers and reduce the energy consumption. The upper airflow in the double flow-layer box comes from the external circulation, that is, the air outside the driving cab, so that the driver can breathe fresh air while fogging is avoided. The lower airflow is completely circulated internally, that is, the air inside the driving cab is circulated internally, which can ensure a comfortable temperature at the passenger's feet, and save energy.

The driver shaft decoupled rear shaft decouples the wheel from a differential mechanism after receiving an execution instruction from the power domain control module, to achieve zero drag loss upon rear wheel drive, whereby the electricity consumption is reduced by 6%, and the fuel consumption is reduced by 0.5 L/100 km.

The rear three-in-one system integrates the electronic control, the motor, and a reducer housing, and performs rear wheel drive energy allocation after receiving an execution instruction from the power domain control module, where the overall efficiency of the assembly is improved by 1.6%.

The CTB battery receives an execution instruction from the power domain control module and performs energy allocation by pulsed self-heating at a heating rate of 2-4° C./min. The CTB battery supports ultra-fast charging at 3 C and 6 C, where the charging duration is less than 15 min. In addition, the CTB battery can further reduce the energy consumption of the vehicle by improving the energy density and the energy efficiency and by a lightweight design.

The dedicated engine for hybrid electric vehicles is a high-efficiency engine that outputs a torque after receiving an execution instruction from the power domain control module, has a low NVH, and has a heat efficiency of 43% or higher. In some embodiments, the dedicated engine for hybrid electric vehicles is an engine having a heat efficiency of 46% and having a light-weight design, thus further improving the fuel saving performance.

The electric hybrid system (EHS) is a highly integrated hybrid-power electric hybrid system including a drive and electricity-generating dual motor, a dual electronic control for the drive and electricity-generating dual motor, a transmission mechanism (direct-drive clutch plus gear transmission) and a hydraulic system, by which the overall efficiency is improved by 2%. By using a high power density motor, the EHS system can reduce the weight by 4 kg and achieve a maximum rotational speed of 18000 rpm or higher, thus effectively improving the vehicle power and further reducing the fuel consumption.

Compared with related art, the present disclosure has the following beneficial effects.

The present disclosure provides an intelligent energy management system and device based on the coordination of human, vehicles, and roads. The energy management strategy for vehicles provided in the present disclosure is different from the traditional energy management strategy where the optimization is performed only on one operating condition. In the present disclosure, various typical operating conditions are optimized at the same time in the energy management strategy, and a corresponding energy management strategy can be selected in a different driving scenario and in a different driving state. According to the energy management strategy and device disclosed in the present disclosure, the electricity-deficient fuel consumption of the vehicle under NEDC standard operating conditions can be less than 3 L/100 km. For an operating condition used by the user, when the energy management system disclosed in the present disclosure is on, the actual fuel consumption of the user can be reduced, with a fuel saving rate of 10% or higher.

In some embodiments of the present disclosure, at least the cockpit domain information and the power domain information are deeply coupled, multimodal information from the cockpit is empowered into the power domain, and the travel scenario is comprehensively dug by combining with the AI energy consumption management technology. Multi-source information of human, vehicles, and road network are fused. Following the steps of learning-prediction-planning-control, through energy saving by planning the energy consumption and speed corresponding to the travel route, energy saving by improving the efficiency of the hybrid electric system, and energy saving by planning the energy supplementing mode, the fuel consumption of the user and the cost of driving are reduced in multiple dimensions, and the driving and riding experience are improved.

Learning: The driving style, vehicle usage habit, and electricity consumption habit are learned.

Prediction: The navigation information, historical data, and vehicle parameters are fused, the travel route is predicted, and the energy consumption curve is predicted according to the travel route.

Planning: Optimum SOC in the whole traveling process is dynamically planned according to the energy consumption curve, and the energy scheduling is optimized.

Control: The fuel and electricity scheduling are controlled according to the plan, to reduce the energy consumption and improve the driving and riding experience during traveling.

The application scenario of the present disclosure includes the following.

1: According to different navigation information, an AI model learns from the navigation information, where the navigation information includes on and off information of the navigation system. When the navigation system is started, the AI model automatically determines a preset travel route or UI recommends a preset travel route, that is, an energy-saving route, to the user.

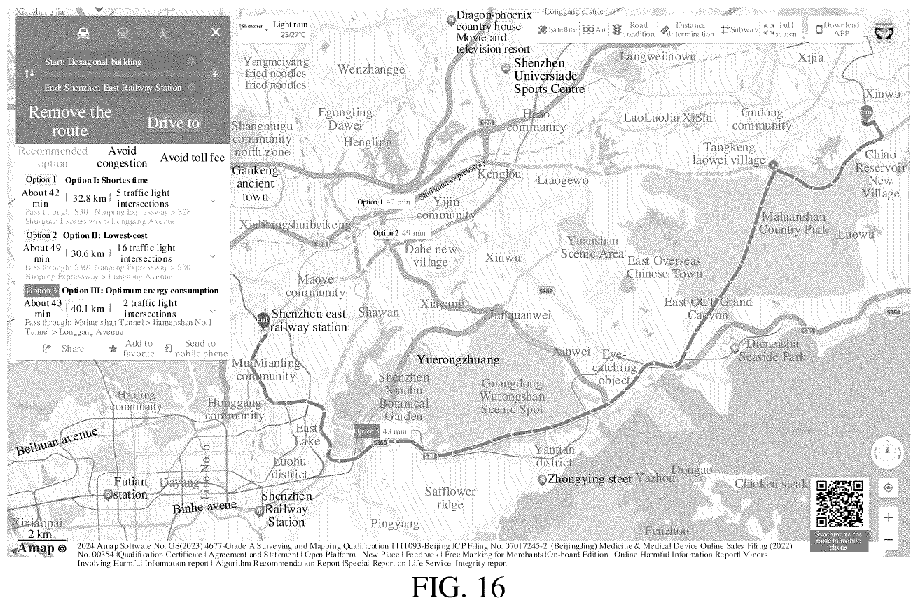

For example, referring to FIG. 16, FIG. 16 schematically shows an energy-saving route according to some embodiments of the present disclosure. UI recommends three candidate travel route options to the user. Option 1: Shortest-time option. Option 2: Lowest-cost option. Option 3: Optimum-energy-consumption option.

Different travel routes are determined by the navigation system according to a destination and a current location of the vehicle. Road section information and traffic information of different travel routes, and vehicle parameter states are extracted and inputted into an energy consumption prediction model to obtain a prediction feedback corresponding to future energy consumption. If the route includes a highway, a toll fee corresponding to the route is calculated, converted into the fuel consumption by using the fuel price at that moment, and added to the energy consumption cost. A travel route corresponding to the minimum energy consumption is outputted and shown to the user. The user selects, for example, one route as the preset travel route.

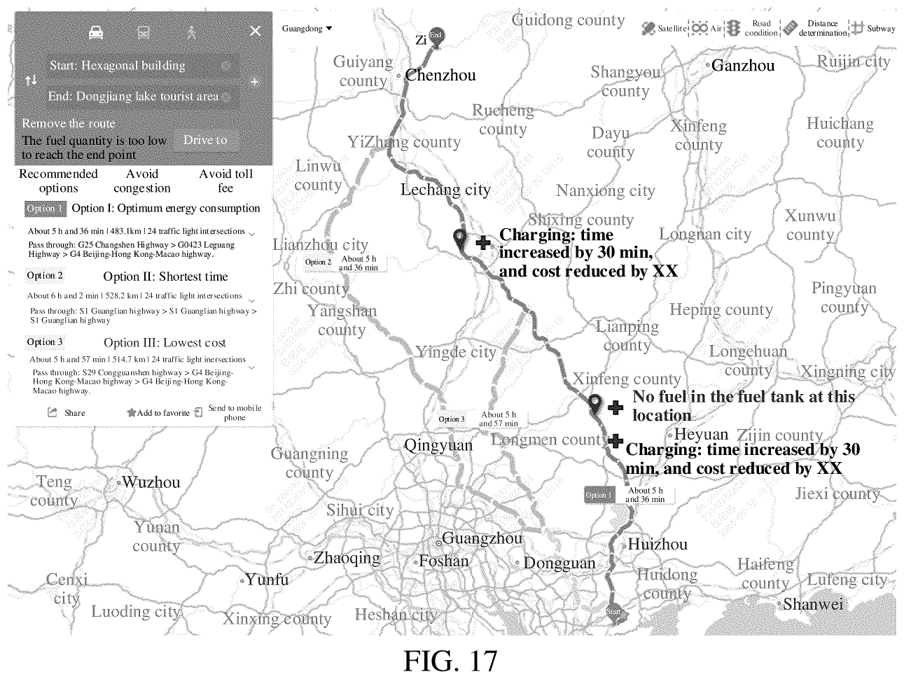

When a travel distance shown on the navigation system is greater than a remaining fuel-electricity combined mileage Lremaining of the vehicle based on a predicted energy consumption, an energy-supplementing plan is needed. Referring to FIG. 17, FIG. 17 schematically shows an energy-supplementing plan according to some embodiments of the present disclosure. For example, three energy supplementing options are recommended. Option 1: Optimum-energy-consumption option. Option 2: Shortest-time option. Option 3: Lowest-cost option. Different charging addresses and refueling address will be shown on the map. For example, charging at a first charging address will increase the time by 30 min and reduce the cost by 5 yuan. Charging at a second charging address will increase the time by 30 min and reduce the cost by 10 yuan. For example, the map will also show that when the vehicle travels to a certain location, there will be no oil in the fuel tank at that location.

When the preset travel route is determined, a target SOC corresponding to each road section is planned according to a road section-specific vehicle energy consumption corresponding to each road section. For example, if the end point satisfies a charging condition, the target SOC at the end point can be reduced. According to the target SOC and an actual vehicle demand corresponding to each road section, the engine, the drive motor, the electric generator, and the power battery are controlled, to enable the engine to operate in an efficient operating interval during operation.

2: According to different navigation information, an AI model learns from the navigation information, where the navigation information includes on and off information of the navigation system. When the navigation system is started, and a commuting operating condition is identified by the AI model, an automatic navigation method for commuting is employed. A destination is identified according to a preset commuting periodicity, a moment of going to work, a moment of leaving work, a residential address, and a home address preset by a user, and a commuting operating condition is further identified.

The commuting operating condition includes a go-to-work operating condition and leave-work operating condition. When the vehicle is started, an on-board server first determines whether an initial location is met according to GPS, then forms a go-to-work time period and a leave-work time period according to the moment of going to work, the moment of leaving work, and a time offset, and determines whether the current operating condition is a commuting operating condition by determining whether the current moment is in the commuting periodicity and the commuting time period, thereby automatically starting the navigation system.

3: According to different navigation information, an AI model learns from the navigation information is performed, where the navigation information includes on and off information of the navigation system. When the navigation system is not started, the AI model adopts the prediction of travel data based on historical data, and is enabled when the navigation system is not started, for prediction mainly through the storage and identification of historical traveling data of the vehicle, by identifying the pattern of historical traveling data. When it is identified as a historical operating condition, the operating condition is regarded as the future traveling operating condition. If the identification is unsuccessful, the prediction is failed.

For example, the traveling data used for storage and prediction are mainly data related to vehicle energy consumption, such as speed, slope, and power demand. When the navigation system and pathfinding are not started, the identification of a historical operating condition is successful in the prediction based on the historical traveling data, including, but not limited to, the identification of a commuting operating condition, a commuting energy management strategy based on operating condition identification is adopted. According to the commuting energy management strategy based on operating condition identification, and a target SOC section and an actual vehicle demand corresponding to each road section, the engine, the drive motor, the electric generator, and the power battery, to enable the engine to operate in an efficient operating interval during operation.

4. According to different road types and weather types, an AI model obtains and learns weather data and road types. The weather data can be different climatic conditions for learning, including sunny days, cloudy days, rainy days, snowy days and foggy days. The road type includes urban roads, highways, mountain roads and rural roads.

After learning, the energy consumption is predicted according to the road type corresponding to the preset travel route and the weather type, and the route-specific vehicle energy consumption is calculated by combining the theoretical calculation with the target energy consumption. A target SOC corresponding to each road section is planed according to a road section-specific vehicle energy consumption corresponding to each road section, to achieve a minimum fuel consumption corresponding to the preset travel route. According to the target SOC and an actual vehicle demand corresponding to each road section, the engine, the drive motor, the electric generator, and the power battery are controlled, to enable the engine to operate in an efficient operating interval during operation.

5: According to different user behavior information, an AI model learns the user behavior information, including learning the driving style, vehicle usage habit and electricity consumption habit of the user. The driving style includes aggressive, ordinary, and mild. The vehicle usage habit is the habit of the user in driving, such as the time interval at which the user takes a rest when driving over a long distance, and the habit of the user to choose a navigation route (for example, some users choose a route corresponding to the shortest time instead of a route corresponding to the lowest fuel consumption). The electricity consumption habit can include information such as charging conditions at the user's destination.

For example, when the driving style of the user is aggressive, a route-specific vehicle energy consumption corresponding to a preset travel route is predicted according to user behavior information of a target user, in combination with road condition information and vehicle state information. A target SOC corresponding to each road section is planned according to the road section-specific vehicle energy consumption corresponding to each road section, to achieve a minimum fuel consumption corresponding to the preset travel route. According to the target SOC and the actual vehicle demand corresponding to each road section, the engine, the drive motor, the electric generator, and the power battery are controlled, to enable the engine to operate in an efficient operating interval during operation. For example, when the time interval at which the user takes a rest when driving over a long distance is learned, the user is recommended to charge the vehicle and take a rest according to this time, so as to consume more electricity, and reduce the fuel consumption.

The AI model can learn the user behavior information through statistical and AI clustering analysis. For example, it is statistically found that the vehicle is charged by the user 3 times out of 10 times when he arrives home, and the vehicle is charged when the amount of electricity is low at each time. It can be learned that the electricity consumption habit is: the user will charge the vehicle when he arrive home when the amount of electricity is low. For example, the driving style can be identified by AI clustering analysis. Multiple change rates of an opening of an accelerator pedal and change rates of the acceleration of the vehicle driven by the user are acquired, and clustering analysis is performed, to classify the user's driving style into aggressive, ordinary or mild.

6: According to different restriction condition information corresponding to the preset travel route, an AI model learns different restriction condition information, such as road speed limit and traffic light restriction, etc. After a preset travel route is determined, it predicts, according to the different restriction condition information, a target speed, for example, at a traffic light intersection, and in a long-term vehicle-following traveling process, and performs local optimization and correction. In a long-term vehicle-following traveling process: when the intelligent driving function is enabled, a short-term vehicle speed prediction is needed.

On the one hand, a vehicle speed in future 5 to 10 s is predicted based on the historical data. On the other hand, current vehicle information and ambient environment information is collected by sensors such as a laser radar, a millimeter wave radar, and a camera, to calculate a predicted vehicle speed in the future 5 to 10 s. A route-specific vehicle energy consumption corresponding to a target speed is calculated. A target SOC corresponding to each road section is planned according to road section-specific vehicle energy consumption corresponding to each road section, to achieve a minimum fuel consumption corresponding to the preset travel route. According to the target SOC and an actual vehicle demand corresponding to each road section, the engine, the drive motor, the electric generator, and the power battery are controlled, to enable the engine to operate in an efficient operating interval during operation.

Some embodiments of the present disclosure are applicable to all scenarios, including scenarios with or without navigation, scenarios with or without intelligent driving function, and scenarios under different commuting operating conditions. The intelligent energy management system for a new energy vehicle according to the present disclosure is applicable in a full temperature range, and achieves energy saving under different climatic conditions, including sunny days, cloudy days, rainy days, snowy days and foggy days, to reduce the fuel consumption during the traveling of the user. The intelligent energy management system for a new energy vehicle according to the present disclosure is not limited by geographical locations, and is applicable in various regions, including different terrain and road conditions, and can reduce the fuel consumption during the traveling in different regions such as cities, highways, mountainous areas, and villages.

Some embodiments of the present disclosure also provide a computer storage medium, in which a program instruction is stored. The program instruction, when executed, implements the corresponding method described in the above embodiment.

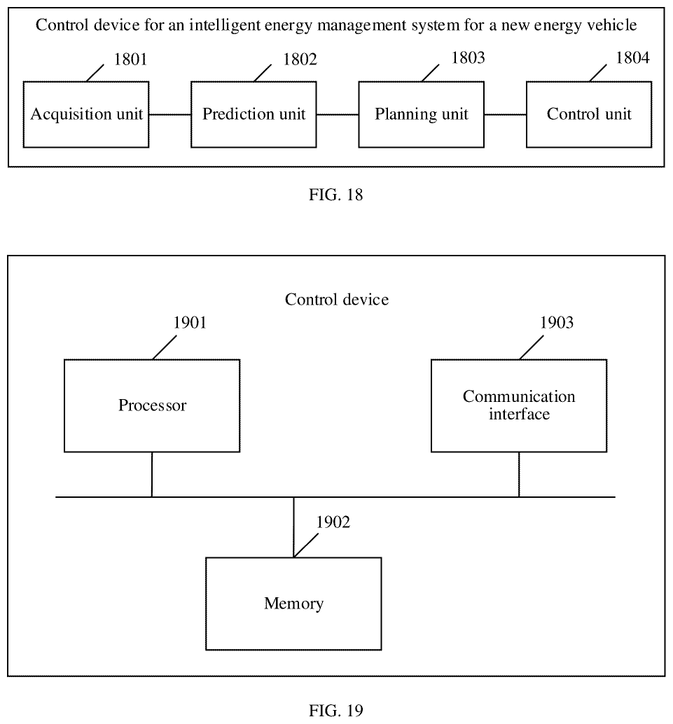

Referring to FIG. 18, FIG. 18 is a block diagram of a control device for an intelligent energy management system for a new energy vehicle according to some embodiments of the present disclosure.

In an implementation of the control device for an intelligent energy management system for a new energy vehicle according to some embodiments of the present disclosure, the control device for an intelligent energy management system for a new energy vehicle includes:
an acquisition unit 1801, configured to acquire multi-domain fusion information, where the multi-domain fusion information at least includes cockpit domain information and power domain information, for example, the cockpit domain information at least includes user behavior information and road condition information of a preset travel route, and the power domain information at least includes vehicle state information;
a prediction unit 1802, configured to predict, according to the multi-domain fusion information, a route-specific vehicle energy consumption corresponding to the preset travel route, where the preset travel route includes multiple road sections, and the route-specific vehicle energy consumption includes road section-specific vehicle energy consumptions corresponding to the multiple road sections;
a planning unit 1803, configured to plan, according to the road section-specific vehicle energy consumption corresponding to each road section, a target SOC corresponding to each road section, to achieve a minimum fuel consumption corresponding to the preset travel route; and
a control unit 1804, configured to control, according to the target SOC and an actual vehicle demand corresponding to each road section, the engine, the drive motor, the electric generator, and the power battery, to enable the engine to operate in an efficient operating interval during operation.

In some embodiments of the present disclosure, the acquisition unit 1801 acquires multi-domain fusion information, where the multi-domain fusion information at least includes cockpit domain information and power domain information, for example, the cockpit domain information at least includes user behavior information and road condition information of a preset travel route, and the power domain information at least includes vehicle state information; the prediction unit 1802 predicts, according to the multi-domain fusion information, a route-specific vehicle energy consumption corresponding to the preset travel route, where the preset travel route includes multiple road sections, and the route-specific vehicle energy consumption includes road section-specific vehicle energy consumptions corresponding to the multiple road sections; the planning unit 1803 plans, according to the road section-specific vehicle energy consumption corresponding to each road section, a target SOC corresponding to each road section, to achieve a minimum fuel consumption corresponding to the preset travel route; and the control unit 1804 controls, according to the target SOC and an actual vehicle demand corresponding to each road section, the engine, the drive motor, the electric generator, and the power battery, to enable the engine to operate in an efficient operating interval during operation.

The target SOC corresponding to each road section is planned to achieve a minimum fuel consumption corresponding to the travel route, and the vehicle is controlled according to the target SOC and the actual vehicle demand corresponding to each road section, to realize the reasonable allocation of fuel and electricity in a hybrid electric vehicle, and reduce the fuel consumption and vehicle usage cost of the vehicle. The engine, the drive motor, the electric generator, and the power battery are controlled, to enable the engine to operate in an efficient operating interval during operation, improve the NVH performance of the engine, avoid the frequent start and stop of the engine, and improve the driving and riding comfort. The route-specific vehicle energy consumption corresponding to the preset travel route is predicted according to the multi-domain fusion information, that is, the route-specific vehicle energy consumption is predicted by fusing the cockpit domain and power domain information, to improve the accuracy of energy consumption prediction, and further improve the fuel saving performance.

Referring to FIG. 19, FIG. 19 is a block diagram of a control device according to some embodiments of the present disclosure. The control device according to some embodiments of the present disclosure includes an electricity supply module and other structures. The control device runs on a cloud server or a local server, and includes a processor 1901, a memory 1902, and a communication interface 1903. The processor 1901, the memory 1902, and the communication interface 1903 can perform data interaction with one another, and the processor 1901 implements the corresponding control method for an intelligent energy management system for a new energy vehicle.

The memory 1902 may include a volatile memory, for example, a random access memory (RAM). The memory 1902 may also include a non-volatile memory, for example, a flash memory, and a solid-state drive (SSD) etc. The memory 1902 may also include a combination of the various types of memory above.

The processor 1901 may be a central processing unit (CPU). The processor 1901 may also be a combination of CPU and GPU. In the control device, multiple CPUs and GPUs can be included as needed to control a corresponding intelligent energy management system for a new energy vehicle. In an embodiment, the memory 1902 is configured to store a program instruction. The processor 1901 calls the program instruction to implement various methods involved in some embodiments of the present disclosure.

In a first possible implementation, the processor 1901 in the control device calls the program instruction stored in the memory 1902, to acquire multi-domain fusion information, where the multi-domain fusion information at least includes cockpit domain information and power domain information, for example, the cockpit domain information at least includes user behavior information and road condition information of a preset travel route, and the power domain information at least includes vehicle state information; predicts, according to the multi-domain fusion information, a route-specific vehicle energy consumption corresponding to the preset travel route, where the preset travel route includes multiple road sections, and the route-specific vehicle energy consumption includes road section-specific vehicle energy consumptions corresponding to the multiple road sections; plans, according to the road section-specific vehicle energy consumption corresponding to each road section, a target SOC corresponding to each road section, to achieve a minimum fuel consumption corresponding to the preset travel route; and controls, according to the target SOC and an actual vehicle demand corresponding to each road section, the engine, the drive motor, the electric generator, and the power battery, to enable the engine to operate in an efficient operating interval during operation.

In some embodiments of the present disclosure, the processor 1901 acquires multi-domain fusion information, where the multi-domain fusion information at least includes cockpit domain information and power domain information, for example, the cockpit domain information at least includes user behavior information and road condition information of a preset travel route, and the power domain information at least includes vehicle state information; predicts, according to the multi-domain fusion information, a route-specific vehicle energy consumption corresponding to the preset travel route, where the preset travel route includes multiple road sections, and the route-specific vehicle energy consumption includes road section-specific vehicle energy consumptions corresponding to the multiple road sections; plans, according to the road section-specific vehicle energy consumption corresponding to each road section, a target SOC corresponding to each road section, to achieve a minimum fuel consumption corresponding to the preset travel route; and controls, according to the target SOC and an actual vehicle demand in each road section, the engine, the drive motor, the electric generator, and the power battery, to enable the engine to operate in an efficient operating interval during operation.

The target SOC corresponding to each road section is planned to achieve a minimum fuel consumption corresponding to the travel route, and the vehicle is controlled according to the target SOC and the actual vehicle demand in each road section, to realize the reasonable allocation of fuel and electricity in a hybrid electric vehicle, and reduce the fuel consumption and vehicle usage cost of the vehicle. The engine, the drive motor, the electric generator, and the power battery are controlled, to enable the engine to operate in an efficient operating interval during operation, improve the NVH performance of the engine, avoid the frequent start and stop of the engine, and improve the driving and riding comfort. The route-specific vehicle energy consumption corresponding to the preset travel route is predicted according to the multi-domain fusion information, that is, the route-specific vehicle energy consumption is predicted by fusing the cockpit domain and power domain information, to improve the accuracy of energy consumption prediction, and further improve the fuel saving performance.

Those of ordinary skill in the art can understand that all or part of the processes implementing the above-described methods in the embodiments can be implemented by a computer program instructing related hardware. The program may be stored in a computer readable storage medium. When the program is executed, the processes of the methods in above-mentioned embodiments are implemented. The foregoing storage medium includes ROM, random access memory (RAM), a magnetic disk, an optical disc and other media that can store program codes.

Some embodiments of the present disclosure are disclosed above, which are not to limit the scope of the present disclosure. Those of ordinary skill in the art can understand that all or part of the processes implementing the above-described embodiments and equivalent changes made according to the claims of the present disclosure are all contemplated in the scope of the present disclosure.

What is claimed is:

1. An intelligent energy management system for a vehicle, comprising:
a drive device, comprising an engine configured to output power to a wheel of the vehicle, a drive motor configured to output power to the wheel, and an electric generator connected to the engine and driven by the engine to generate electricity;
a power battery configured to supply electricity to the drive motor and be charged with an alternating current outputted from one of the electric generator or the drive motor; and
a control device, configured to:
acquire multi-domain data fusion information, wherein the multi-domain data fusion information at least comprises cockpit domain information and power domain information, the cockpit domain information at least comprises user behavior information and road condition information of a preset travel route, and the power domain information at least comprises vehicle state information;
predict, according to the multi-domain data fusion information, a route-specific vehicle energy consumption corresponding to the preset travel route, wherein the preset travel route comprises a plurality of road sections, and the route-specific vehicle energy consumption comprises road section-specific vehicle energy consumptions respectively corresponding to the road sections;
plan, according to the road section-specific vehicle energy consumptions respectively corresponding to the road sections, a target state of charge (SOC) corresponding to each of the road sections, to obtain a minimum fuel consumption corresponding to the preset travel route; and
control, according to the target SOC and an actual vehicle demand corresponding to each of the road sections, the drive device and the power battery, to enable the engine to operate in an efficient operating interval during operation.

2. The system according to claim 1, wherein:
the vehicle state information at least comprises static parameters of the vehicle, and the road condition information at least comprises a road traffic flow speed; and
the predicting, according to the multi-domain data fusion information, a route-specific vehicle energy consumption corresponding to the preset travel route comprises:
predicting the route-specific vehicle energy consumption corresponding to the preset travel route by using an automobile theoretical energy consumption prediction algorithm and according to the road traffic flow speed and the static parameters of the vehicle; and
adjusting the route-specific vehicle energy consumption according to the user behavior information, to obtain an adjusted route-specific vehicle energy consumption that is a theoretical energy consumption demand.

3. The system according to claim 2, wherein the static parameters of the vehicle at least comprise: air resistance, rolling resistance, acceleration resistance, and slope resistance to the vehicle.

4. The system according to claim 1, wherein:
the vehicle state information at least comprises vehicle type information, the user behavior information at least comprises a driving style of a user, and the road condition information at least comprises a road type; and
the predicting, according to the multi-domain data fusion information, a route-specific vehicle energy consumption corresponding to the preset travel route comprises:
inputting the road type, the driving style, and the vehicle type information into a target energy consumption prediction model, and outputting, by the target energy consumption prediction model, a predicted route-specific vehicle energy consumption corresponding to the preset travel route, the route-specific vehicle energy consumption being a reference energy consumption demand, wherein the target energy consumption prediction model is determined from a plurality of preset energy consumption prediction models according to at least one of the road type of the preset travel route or driving style information of the user.

5. The system according to claim 1, wherein the predicting, according to the multi-domain data fusion information, a route-specific vehicle energy consumption corresponding to the preset travel route comprises:
predicting the route-specific vehicle energy consumption corresponding to the preset travel route according to a theoretical energy consumption demand and a reference energy consumption demand of the vehicle corresponding to the preset travel route.

6. The system according to claim 5, wherein the predicting the route-specific vehicle energy consumption corresponding to the preset travel route according to the theoretical energy consumption demand and the reference energy consumption demand of the vehicle corresponding to the preset travel route comprises:
acquiring a first weight of the theoretical energy consumption demand and a second weight of the reference energy consumption demand of the vehicle; and
weighting the theoretical energy consumption demand and the reference energy consumption demand of the vehicle according to the first weight and the second weight, to predict the route-specific vehicle energy consumption of the vehicle.

7. The system according to claim 6, wherein:
the control device is further configured to control a sum of the first weight of the theoretical energy consumption demand and the second weight of the reference energy consumption demand to 1, and update the first weight of the theoretical energy consumption demand and the second weight of the reference energy consumption demand with a constraint condition that an actual road section-specific vehicle energy consumption is in a preset range, to obtain an updated first weight of the theoretical energy consumption demand and an updated second weight of the reference energy consumption demand; and
the acquiring a first weight of the theoretical energy consumption demand and a second weight of the reference energy consumption demand of the vehicle comprises:
acquiring the updated first weight of the theoretical energy consumption demand and the updated second weight of the reference energy consumption demand of the vehicle.

8. The system according to claim 5, wherein:
the vehicle state information at least comprises static parameters of the vehicle and vehicle type information of the vehicle, the user behavior information at least comprises a driving style of a user, and the road condition information at least comprises a road traffic flow speed and a road type;
the theoretical energy consumption demand is obtained by:
predicting the route-specific vehicle energy consumption corresponding to the preset travel route by using an automobile theoretical energy consumption prediction algorithm and according to the road traffic flow speed and the static parameters of the vehicle; and
adjusting the route-specific vehicle energy consumption according to the user behavior information, to obtain the adjusted route-specific vehicle energy consumption that is the theoretical energy consumption demand; and
the reference energy consumption demand is obtained by:
inputting the road type, the driving style, and the vehicle type information into a target energy consumption prediction model, and outputting, by the target energy consumption prediction model, the predicted route-specific vehicle energy consumption corresponding to the preset travel route, the route-specific vehicle energy consumption being the reference energy consumption demand, wherein the target energy consumption prediction model is determined from a plurality of preset energy consumption prediction models according to at least one of the road type of the preset travel route or driving style information of the user.

9. The system according to claim 1, wherein:
the vehicle state information at least comprises static parameters of the vehicle and a target vehicle speed corresponding to a minimum route-specific vehicle energy consumption, the road condition information at least comprises a road traffic flow speed, and the user behavior information at least comprises a driving style of a user; and
the predicting, according to the multi-domain data fusion information, a route-specific vehicle energy consumption corresponding to the preset travel route comprises:
predicting the route-specific vehicle energy consumption corresponding to the preset travel route by using an automobile theoretical energy consumption prediction algorithm and according to the driving style, the road traffic flow speed, the static parameters of the vehicle, and the target vehicle speed corresponding to the minimum route-specific vehicle energy consumption.

10. The system according to claim 9, wherein the control device is further configured to control the vehicle to travel on the preset travel route at the target vehicle speed.

11. The system according to claim 9, wherein the control device is further configured to generate prompt information based on the target vehicle speed corresponding to a minimum vehicle energy consumption, and the prompt information is used to prompt a driver to control the vehicle to travel at the target vehicle speed corresponding to the minimum vehicle energy consumption.

12. The system according to claim 11, wherein the prompt information comprises at least one of the target vehicle speed or pedal control information.

13. The system according to claim 9, wherein the control device is further configured to:
trigger, when an intelligent driving function is enabled and vehicle speed planning is activated, an operation of predicting the route-specific vehicle energy consumption corresponding to the preset travel route by using the automobile theoretical energy consumption prediction algorithm and according to the user behavior information, the road traffic flow speed, the static parameters of the vehicle, and the target vehicle speed corresponding to a minimum vehicle energy consumption; or
trigger, when the intelligent driving function is enabled and a navigation-assisted driving function is enabled, an operation of predicting the route-specific vehicle energy consumption corresponding to the preset travel route by using the automobile theoretical energy consumption prediction algorithm and according to the user behavior information, the road traffic flow speed, the static parameters of the vehicle, and the target vehicle speed corresponding to the minimum vehicle energy consumption; or
trigger, when the intelligent driving function is enabled the navigation-assisted driving function is disabled, an adaptive cruise control function is enabled, there is no preceding vehicle, and an energy-saving driving guidance function is enabled, an operation of predicting the route-specific vehicle energy consumption corresponding to the preset travel route by using the automobile theoretical energy consumption prediction algorithm and according to the user behavior information, the road traffic flow speed, the static parameters of the vehicle, and the target vehicle speed corresponding to the minimum vehicle energy consumption.

14. The system according to claim 9, wherein the control device is further configured to:
trigger, when an intelligent driving function is disabled and an energy-saving driving guidance function is enabled, an operation of predicting the route-specific vehicle energy consumption corresponding to the preset travel route by using the automobile theoretical energy consumption prediction algorithm and according to the user behavior information, the road traffic flow speed, the static parameters of the vehicle, and the target vehicle speed corresponding to a minimum vehicle energy consumption.

15. The system according to claim 1, wherein:
the road condition information comprises: at least one of road type, road name, road traffic sign, road speed limit, congestion level, road length, required traveling time, average vehicle speed, slope, traffic light information, or weather information;
energy consumption affecting information comprises the vehicle state information; or the energy consumption affecting information comprises: at least one of driving style information of a user or the traffic light information, and the vehicle state information; and
the actual vehicle demand of the vehicle corresponding to each road section comprises: a vehicle power required for the vehicle to travel through each road section.

16. The system according to claim 1, wherein the control device is further configured to:
update, when the vehicle travels to an end point of any road section, a target SOC corresponding to a remaining road section according to a target SOC of the power battery corresponding to the any road section and a predicted road section-specific vehicle energy consumption corresponding to the remaining road section, to achieve the minimum fuel consumption corresponding to the preset travel route.

17. The system according to claim 1, wherein the control device is further configured to:
re-perform road section division on a remaining travel route, if the road condition information is updated, to obtain at least one new road section, the remaining travel route is a route from a current location of the vehicle to an end point of the preset travel route in the preset travel route; and
update a target SOC corresponding to each new road section according to an initial SOC of the power battery and a road section-specific vehicle energy consumption corresponding to each new road section in the at least one new road section, to achieve the minimum fuel consumption corresponding to the preset travel route.

18. The system according to claim 1, wherein if a self-start function of a navigation system is disabled, the navigation system is off, and the preset travel route is a commuter route, the control device is further configured to: control, according to historical traveling data of the vehicle corresponding to the commuter route, the engine, the drive motor, the electric generator, and the power battery, to enable the engine to operate in the efficient operating interval during operation.

19. The system according to claim 1, wherein when a self-start function of a navigation system is disabled, the navigation system is off, and the preset travel route is not a commuter route, the control device is further configured to:
predict, when the vehicle travels on the preset travel route, a vehicle speed of the vehicle in a preset time period, to obtain a predicted vehicle speed of the vehicle in the preset time period;
predict, according to the predicted vehicle speed in the preset time period, a component control sequence of the vehicle in the preset time period; and
control, according to a first control instruction in the component control sequence, a corresponding component, wherein the corresponding component comprises at least one of a throttle and a pedal.

20. The system according to claim 19, wherein the predicting the vehicle speed of the vehicle in the preset time period, to obtain the predicted vehicle speed of the vehicle in the preset time period comprises:
acquiring, when an intelligent driving function is disabled, historical traveling data of the vehicle in a preset historical time period; and
predicting the vehicle speed of the vehicle in the preset time period according to the historical traveling data, to obtain the predicted vehicle speed of the vehicle in the preset time period.

21. The system according to claim 19, wherein the control device is further configured to: control the vehicle to brake, when a distance to a preceding vehicle ahead of the vehicle or a speed with respect to the preceding vehicle is determined not to meet a safe traveling condition.

22. The system according to claim 1, wherein the control device is further configured to:
control the vehicle to travel based on a current vehicle speed, when an intelligent driving function is enabled, a navigation-assisted driving function is disabled, an adaptive cruise control function is enabled, no preceding vehicle is ahead of the vehicle, and the vehicle speed planning is not activated; or
acquire a current vehicle speed of a preceding vehicle ahead of the vehicle, and control the vehicle to travel based on the current vehicle speed of the preceding vehicle, when the intelligent driving function is enabled, the navigation-assisted driving function is disabled, the adaptive cruise control function is enabled, and the vehicle speed planning is not activated.

23. The system according to claim 1, wherein the control device is further configured to:
when an intelligent driving function is enabled, a navigation-assisted driving function is disabled, an adaptive cruise control function is enabled, a preceding vehicle is ahead of the vehicle, and vehicle speed planning is activated, generate a speed sequence according to a road traffic flow speed on the preset travel route and a current vehicle speed of the vehicle with a minimum route-specific vehicle energy consumption as an objective function, and using a first speed in the speed sequence as a target vehicle speed, acquire the current vehicle speed of the preceding vehicle ahead the vehicle, determine, according to the current vehicle speed of the preceding vehicle and the target vehicle speed of the vehicle, a control vehicle speed of the vehicle, and control the vehicle to travel based on the control vehicle speed;
or
when the intelligent driving function is enabled, the navigation-assisted driving function is disabled, and the adaptive cruise control function is disabled, predict a vehicle speed of the vehicle in a preset time period according to acquired intelligent driving sensing data, to obtain a predicted vehicle speed of the vehicle in the preset time period and control the vehicle to travel based on the predicted vehicle speed.

24. The system according to claim 1, wherein the control device is further configured to: adjust, according to a driving style, a current vehicle speed of the vehicle, or current environmental information where the vehicle is located, an electricity supply ensuring SOC; and control, according to a comparison result of an actual SOC of the vehicle and an adjusted electricity supply ensuring SOC, the engine, the drive motor, the electric generator, and the power battery, to enable the engine to operate in the efficient operating interval during operation.

25. The system according to claim 1, wherein the control device is further configured to:
adjust, according to a state of charge, the preset travel route, and an appointed boarding time of a user, a temperature of the power battery; or
predict an output duration of a to-be-outputted power of the engine, and start the engine when the output duration is greater than a third preset duration; or
predict a traffic congestion time of the vehicle, and increase a water temperature of the engine when an interval between a current time and the traffic congestion time is a fourth preset duration.

26. The system according to claim 1, wherein the control device is further configured to: predict an end point of the preset travel route; stop adjusting a water temperature of the engine according to a target water temperature deviation of the engine when a distance between a current location of the vehicle and the end point is less than a preset distance; and increase a water temperature of the engine to be higher than a preset temperature threshold, until the vehicle reaches the end point.

27. The system according to claim 1, wherein the control device is further configured to: predict an end point of the preset travel route; stop adjusting a temperature of the power battery according to a target temperature deviation of the power battery when a distance between a current location of the vehicle and the end point is less than a preset distance; and adjust the temperature of the power battery to be in a preset temperature interval, until the vehicle reaches the end point.

28. The system according to claim 27, wherein the control device is further configured to: predict an end point of the preset travel route; stop the control of a passenger compartment temperature of the vehicle to reach a target passenger compartment temperature when a distance between a current location of the vehicle and the end point is less than a preset distance; and adjust the target passenger compartment temperature.

29. An intelligent energy management system for a vehicle, comprises:
an engine configured to output power to a wheel of the vehicle;
a drive motor configured to output power to the wheel;
an electric generator connected to the engine and driven by the engine to generate electricity;
a power battery configured to supply electricity to the drive motor and be charged with an alternating current outputted from one of the electric generator or the drive motor; and
a control device comprising:
a multi-source data fusion module configured to acquire multi-domain data fusion information, wherein the multi-domain data fusion information at least comprises cockpit domain information and power domain information, the cockpit domain information at least comprises user behavior information and road condition information of a preset travel route, and the power domain information at least comprises vehicle state information;
an energy consumption prediction module configured to predict, according to the multi-domain data fusion information, a route-specific vehicle energy consumption corresponding to the preset travel route, wherein the preset travel route comprises a plurality of road sections, and the route-specific vehicle energy consumption comprises road section-specific vehicle energy consumptions respectively corresponding to the road sections;
a dynamic planning module configured to plan, according to the road section-specific vehicle energy consumptions respectively corresponding to the road sections, a target state of charge (SOC) corresponding to each road section, to achieve a minimum fuel consumption corresponding to the preset travel route; and
an intelligent control module configured to control, according to the target SOC and an actual vehicle demand according to each of the road sections, the engine, the drive motor, the electric generator, and the power battery, to operate.

30. A vehicle, comprising an intelligent energy management system for a vehicle, and the intelligent energy management system comprising:
a drive device, comprising an engine configured to output power to a wheel of the vehicle, a drive motor configured to output power to the wheel, and an electric generator connected to the engine and driven by the engine to generate electricity;
a power battery configured to supply electricity to the drive motor and be charged with an alternating current outputted from one of the electric generator or the drive motor; and
a control device, configured to:
acquire multi-domain data fusion information, wherein the multi-domain data fusion information at least comprises cockpit domain information and power domain information, the cockpit domain information at least comprises user behavior information and road condition information of a preset travel route, and the power domain information at least comprises vehicle state information;
predict, according to the multi-domain data fusion information, a route-specific vehicle energy consumption corresponding to the preset travel route, wherein the preset travel route comprises a plurality of road sections, and the route-specific vehicle energy consumption comprises road section-specific vehicle energy consumptions respectively corresponding to the road sections;
plan, according to the road section-specific vehicle energy consumptions respectively corresponding to the road sections, a target state of charge (SOC) corresponding to each of the road sections, to obtain a minimum fuel consumption corresponding to the preset travel route; and
control, according to the target SOC and an actual vehicle demand corresponding to each of the road sections, the drive device and the power battery, to enable the engine to operate in an efficient operating interval during operation.
